(19) United States
(12) Patent Application Publication
(10) Pub. No.: US 2007/0136093 A1
(43) Pub. Date: Jun. 14, 2007

(54) METHODS, SYSTEMS, AND PROGRAMS FOR HEALTH AND WELLNESS MANAGEMENT

(75) Inventors: Shawn Rankin, Woodbury, MN (US); Mike Whittington, Orono, MN (US); Jay Belschner, Edina, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: RANKIN INNOVATIONS, INC., Woodbury, MN (US)

(21) Appl. No.: 11/548,226

(22) Filed: Oct. 10, 2006

Related U.S. Application Data
(60) Provisional application No. 60/726,761, filed on Oct. 11, 2005.
(60) Provisional application No. 60/800,868, filed on May 16, 2006.

(51) Int. Cl. G06Q 10/00; G06Q 50/00

(52) U.S. Cl. 705/2

(57) ABSTRACT

Methods and systems for health and wellness management, including computer programs for implementing such methods and systems, are disclosed. An illustrative system for managing the health and wellness of plan members within a health plan can include a plan sponsor, a behavior modification program targeted to one or more plan members within the health plan, and a plan administrator adapted to monitor the progress of each plan member participating in the behavior modification program. A customizable computer exercise program can be provided as a part of the behavior modification program to promote weight loss, increase activity level, as well as other health related objectives. The computer exercise program can include a compliance module adapted to monitor the plan member's usage of the program, and a communications module for transferring data back and forth between the exercise program and administrator.

### CROSS REFERENCE TO RELATED APPLICATIONS

This application claims the benefit of U.S. Provisional Application No. 60/726,761, filed on Oct. 11, 2005, and U.S. Provisional Application No. 60/800,868, filed on May 16, 2006.

### FIELD

The present invention relates generally to methods and systems for health and wellness management, including computer programs for implementing such methods and systems.

### BACKGROUND

Obesity attributable to a sedentary lifestyle is growing at an alarming rate, affecting millions of individuals worldwide. The obesity level in adults, for example, has soared to nearly one in every three individuals, resulting in an increase in obesity-related healthcare expenses incurred by businesses and governmental agencies. Childhood obesity resulting from inadequate exercise and poor diet is particularly acute, and is expected to rise as school districts are faced with budgetary cuts and the downsizing or elimination of many physical education and health programs. Overweight individuals are at a significantly higher risk of acquiring debilitative diseases such as insulin resistance, diabetes, hypertension, hyperlipidemia, degenerative arthritis, and atherosclerotic heart disease. Certain types of chronic diseases such as cancer, gallstones, thromboembolism and hernias are also more prevalent among overweight individuals. The benefits of physical activity in reducing morbidity and improving quality of life are well understood. Increased physical activity, for example, has been shown to reduce employee absenteeism, short term disability claims and workers' compensation expenses, and has been shown to increase employee productivity and retention rates.

The costs associated with insuring individuals with obesity-related health problems are expected to soar as the obesity levels in adults and children continue to rise. In the United States alone, the total annual healthcare cost is expected to rise from its current level of 1.9 trillion to about 3.6 trillion by the year 2014. As a result of this trend, businesses faced with rising healthcare costs are becoming more proactive in managing healthcare and workers' compensation expenses, in some cases restructuring and reducing the benefits offered to employees and their families. Some healthcare providers are also seeking alternative ways to increase activity levels among certain at-risk members in order to reduce the long-term healthcare costs associated with a sedentary lifestyle. For instance, some healthcare providers now provide discounts for those plan members who attend a fitness club on a regular basis or who enroll in a qualified exercise program provided by the healthcare provider. In some cases, other healthcare initiatives such as smoking cessation programs may also be offered to plan members in order to reduce healthcare costs associated with other unhealthy lifestyle choices.

Strategies employed by healthcare providers to promote exercise and reduce healthcare expenses are typically focused on behavior modification programs of certain at-risk members. The efficacy of such behavior modification programs is often dependent on the level of intervention or feedback provided to each plan member, as adherence rates tend to diminish as intervention ceases. The ability to provide constant intervention to plan members and their healthcare professionals is thus vital to the long-term success of many health and wellness programs. Despite this understanding, many health and wellness programs lack the ability to adequately monitor compliance with the program's directives.

Traditional health and wellness programs are also not always effective in promoting exercise tailored to the individual's specific needs. In many cases, the exercise instruction may be difficult to understand and follow, and are not effective at conveying clinically proper exercise technique. With respect to some rehabilitation programs, for example, the exercise instruction may be provided as take-home exercise handouts that may not be suited to the individual's specific needs or which do not adequately demonstrate proper technique. More recent trends have focused on a new generation of video games that encourage physical exercise, typically in conjunction with specialized exercise equipment that monitors the user's movements to control and interact with several preprogrammed exercise routines. While such games may be used as a tool to promote exercise, the ability to customize and adapt such programs to the individual's specific needs is often lacking. In addition, such games do not always completely demonstrate the full range of motion of the exercise, and thus are ineffectual at conveying proper technique.

### BRIEF SUMMARY

Methods and systems for health and wellness management, including computer programs for implementing such methods and systems, are disclosed. An illustrative method for promoting health and wellness of individuals within a population can include the steps of targeting one or more individuals within the population based at least in part on a risk assessment factor associated with each individual, formulating a behavior modification program for each targeted individual based at least in part on the risk assessment factor, providing one or more targeted individuals with a customizable exercise program for achieving one or more health related objects pertaining to the behavior modification program, and monitoring the progress of individuals participating in the behavior modification program in achieving the health related objectives.

An illustrative system for managing the health and wellness of members within a health plan can include a plan sponsor such as an insurance company or healthcare provider, a behavior modification program targeted to one or more members within the health plan, and a plan administrator adapted to monitor the progress of each member participating in the behavior modification program. A computer-based exercise program can be used as part of the behavior modification program to promote proper exercise and to increase the activity levels of participating members. The exercise program can include a graphical user interface displayable on a display screen, an exercise object database allowing for the creation of a number of customizable exercise routines, and a gaming engine adapted to render a 3-D animation of one or more of the exercise routines developed with or contained within the database. A compliance module can be provided in some embodiments to monitor usage of the exercise program. A communications module can also be utilized in some embodiments to transmit data back and forth between the end user and a plan administrator tasked to oversee monitoring and compliance with the behavior modification program.

### BRIEF DESCRIPTION OF THE DRAWINGS

FIG. 1 is a diagrammatic view showing an illustrative health and wellness management system;

FIG. 2 is a diagrammatic view showing several illustrative categories for use in targeting plan members for enrollment within a behavior modification program;

FIG. 3 is a diagrammatic view showing the targeting of plan members based on activity level and health status;

FIG. 4 is a flow diagram showing an illustrative method of promoting health and wellness of plan members within the health and wellness management system of FIG. 1;

FIG. 5 is a diagrammatic view showing an illustrative computer exercise program for use with the health and wellness management system of FIG. 1;

FIG. 6 is a user-flow diagram showing an illustrative implementation of the exercise program of FIG. 5;

FIGS. 7A-7D are several screen shots showing an illustrative check-in interface of the exercise program;

FIGS. 8A-8F are several screen shots showing a main menu interface of the exercise program;

FIGS. 9A-9D are several screen shots showing an auto design interface of the exercise program;

FIGS. 10A-10C are several screen shots showing a customization interface of the exercise program;

FIGS. 11A-11J are several screen shots showing the selection of exercise routines using the exercise object database;

FIGS. 12A-12B are several screen shots showing several illustrative steps of selecting an exercise for review;

FIGS. 13A-13C are several screen shots showing several illustrative steps of finding exercises within the exercise object database by exercise category;

FIGS. 14A-14B are several screen shots showing several illustrative steps of viewing an exercise in a full-screen mode;

FIGS. 15A-15E are several screen shots showing several illustrative steps of performing a workout using the exercise program;

FIGS. 16A-16C are several screen shots showing several illustrative steps of viewing a workout;

FIGS. 17A-17F are several screen shots showing several illustrative steps of viewing a workout log;

FIGS. 18A-18D are several screen shots showing an illustrative interface for use in creating an exercise prescription by a healthcare or fitness professional;

FIGS. 19A-19B contain an illustrative list of workout topics and subtopics that can be selected for use in creating an auto-design workout with the auto-design interface;

FIGS. 20A-20E contain an illustrative list of exercise routine durations based on exercise level and workout focus;

FIGS. 21A-21B contain an illustrative list of exercise categories and subcategories that can be selected for use in creating a customized workout with the customization interface;

FIGS. 22A-22D contain an illustrative list of exercise equipment that can be selected from each exercise category;

FIGS. 23A-23C contain an illustrative list of exercise parameters that can be associated with each exercise category;

FIG. 24 is an illustrative list showing several viewable exercise topics;

FIGS. 25A-25B contain an illustrative list of target muscles and body positions that can be used in exercise searching;

FIG. 26 is an illustrative list of exercise category parameters that can be displayed on a workout log;

FIGS. 27A-27B contain an illustrative list of target muscles that can be selected by a healthcare or fitness professional for creating an exercise prescription; and

FIGS. 28A-28R contain an illustrative list of exercise animations contained within the exercise object database.

### DETAILED DESCRIPTION

The following description should be read with reference to the drawings, in which like elements in different drawings are numbered in like fashion. The drawings, which are not necessarily to scale, depict illustrative embodiments and are not intended to limit the scope of the invention. While the methods and systems are described herein with respect to health plans and healthcare providers, it should be understood that the methods and systems could be applied to any number of different organizations for the promotion of health and wellness in individuals. Examples of other organizations that may benefit from the methods and systems described herein can include, but are not limited to, state and federal governmental agencies, military agencies, corporations, workers' compensation managers, human resources administrators, rehabilitation professionals, case managers, fitness professionals, coaches and sports teams, physical education teachers and assistants, school districts, health club owners and managers, mobile/hand-held technology companies, on-line content providers, athletes, and general exercise enthusiasts.

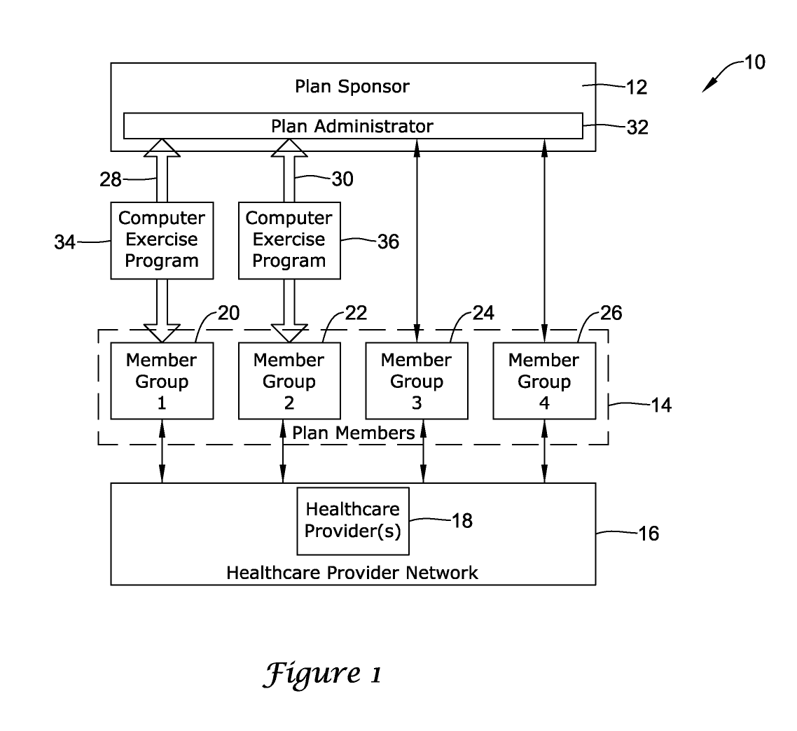

Referring now to FIG. 1, an illustrative health and wellness management system for reducing healthcare expenditures for plan members within a health insurance network will now be described. The system, depicted generally by reference number 10 in FIG. 1, may include a plan sponsor 12 such as a health insurance company or self-insured employer having a number of plan members 14 in which the reduction of healthcare expenditures through behavior modification is sought. The plan sponsor 12 may include, for example, a business or governmental agency having a number of employee plan members 14 that are a part of an existing healthcare provider network 16 tasked to provide health and wellness care to enrolled plan participants. Alternatively, or in addition, the plan sponsor 12 may include an insurance company having a number of insureds 14 that are part of an existing healthcare network 16 that provides healthcare on behalf of a business or governmental agency. While the term “plan sponsor” is sometimes used herein to indicate a health plan, it should be understood that the term may also be used to denote an employer, governmental agency, or other such entity tasked to provide health and wellness care to plan members 14.

The health and wellness management system 10 can be integrated with other existing health risk assessment and wellness programs, either across the entire spectrum of plan members 14 or with respect to certain targeted plan members 14 having a particular health status and/or level of activity. For example, the system 10 can be integrated as part of a comprehensive plan for encouraging physical exercise and/or injury reduction for all plan members 14 covered by the plan sponsor 12. Alternatively, the system 10 can be integrated as part of a health and wellness program to target particular plan members 14 who, based on a determination by the plan sponsor 12 and/or healthcare provider 18, are qualified for enrollment in the system 10.

The plan members 14 can be categorized based on their health status and/or activity level, allowing the plan sponsor 12 to target particular individuals based on their specific needs or, who through a cost benefit (CB) analysis, would benefit the plan sponsor 12 by enrolling in a health and wellness program. In certain embodiments, for example, the plan members 14 can be segmented into a first group 20 of plan members 14 who, based on their assessed health risk and/or prior claims experience, pose a risk to the plan sponsor 12; a second group 22 of plan members 14 currently seen by a chiropractor or disability case manager; and a third group 24 of plan members 14 not deemed at risk and having no known health conditions. The first group 20 of plan members 14 may represent, for example, individuals whose exercise activity levels are determined to be inadequate or who have a particular debilitative and/or chronic condition (e.g., hypertension, heart disease, etc.) treatable in part by exercise. The second group of plan members 14, in turn, may represent individuals currently covered under a disability case management program and who would benefit from clinically-directed exercise. In some cases, an additional group 26 of plan members 14 can be further segmented from the pool of plan members 14 who are at risk from obesity-related health conditions but where increased exercise would not be effective or is contraindicated. It should be understood that while the groups 20,22,24,26 are shown in FIG. 1 as distinct subsets, there may be overlap between one or more of the groups 20,22,24,26 for those plan members 14 falling within more than one category.

The categorization of plan members 14 into each of the groups 20,22,24,26 can be conducted by self-assessment questionnaires provided directly to the plan members 14, a claims data analysis of each plan member's prior claims history, and/or based on clinical evaluations provided by a physician, physical therapist, chiropractor, nurse or other healthcare professional. In addition, demographic factors such as age, gender, occupation, and/or location can also be utilized in targeting plan members 14 for enrollment in the system 10.

As further shown in FIG. 1, a behavior modification program can be provided to one or more of the plan member groups 20,22,24,26 for achieving one or more health related objectives. As indicated generally by arrows 28 and 30 in FIG. 1, for example, an incentive-based behavior modification program can be provided to members within plan member groups 20 and 22 to encourage proper exercise and reduce healthcare costs associated with those groups 20,22. The behavior modification program 28,30 prescribed for the plan member groups 20,22 may be differentiated based on the health status, claims history, activity level, and/or demographics of those plan members 14 falling within each group 20,22, allowing the program 28,30 to be customized to the specific needs of those individuals within each group 20,22. In some cases, the behavior modification programs 28,30 can be further customized within each group 20,22 based on individual plan members' needs, if desired.

Administration of the behavior modification programs 28,30 can be accomplished under the directive of a health plan administrator 32 that oversees monitoring and compliance with the various directives of the programs 28,30. The plan administrator 32 may represent, for example, an administrator of the plan sponsor 12 tasked to oversee monitoring and compliance with the prescribed exercise plan for those plan members enrolled in the behavior modification programs 28,30. While the plan sponsor 12 may provide administration over the behavior modification programs 28,30, as shown in FIG. 1, it should be understood that administration of the behavior modification programs 28,30 can be accomplished by a healthcare provider, an employer, a governmental agency, or other such entity, if desired. In self-insured companies, for example, administration of the behavior modification programs 28,30 can be accomplished by one or more healthcare providers 18 within the network 16.

A computer exercise program 34,36 can be provided to plan members 14 within each targeted group 20,22 as part of their prescribed behavior modification program 28,30. The computer exercise program 34,36 can be customized to achieve a particular healthcare-related goal pertaining to those plan members 14 within each group 20,22, which can then be monitored by the plan administrator 32 to ensure compliance with the behavior modification program directives. The computer exercise programs 34,36 can be integrated with existing outreach campaigns with interventions triggered, for example, by health risk assessments, claims data analysis, and/or provider referrals. Participation in the behavior modification programs 28,30 can be encouraged, for example, by mail campaigns, telephone outreach and nurse coaching campaigns, and wellness clinics and primary care provider intervention.

The provision of the computer exercise program 34,36 to participating plan members 14 can be made in conjunction with one or more incentives for compliance with the prescribed behavior modification program 28,30. Such incentives can include, for example, a discount on the cost of the computer exercise program 34,36, a reduction in out-of-pocket expenses normally paid to the plan sponsor 12, and/or a monthly credit received from the plan sponsor 12. In some embodiments, an automated incentive point tracking system can be utilized to reward consistent exercise behavior by the participating plan members 14.

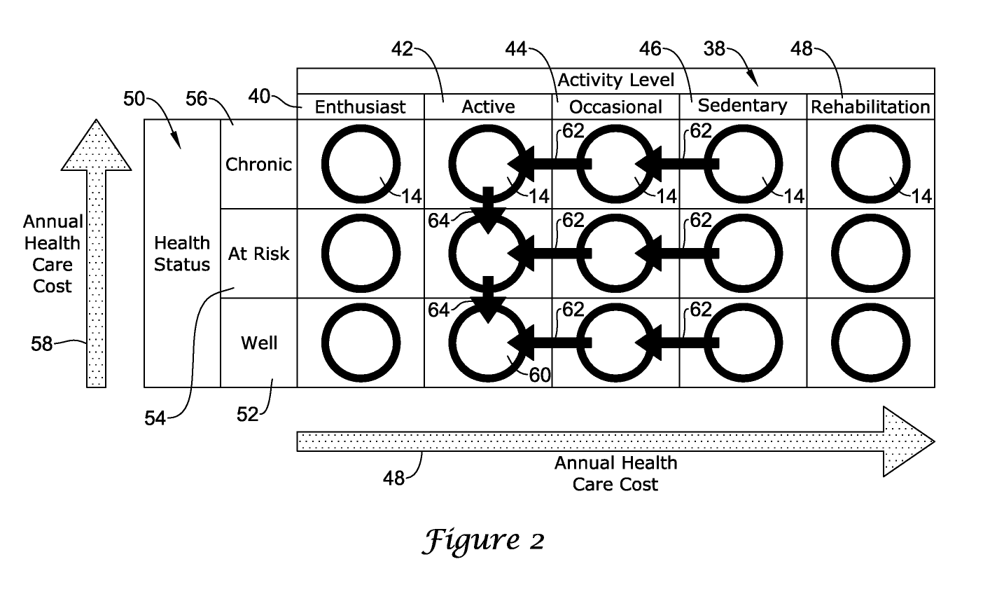

FIG. 2 is a diagrammatic view showing several illustrative categories for use in targeting plan members 14 for enrollment within a behavior modification program. As shown in FIG. 2, the categorization of plan members 14 can be based on five generalized activity categories 38, including an exercise enthusiast category 40, an active lifestyle category 42, an occasional activity category 44, a sedentary activity category 46, and a rehabilitation category 48, which together can be used to segment the pool of plan members 14 on a sliding scale from most active to least active. As indicated generally by arrow 48, as the activity level of plan members 14 decreases from left to right in the diagram of FIG. 2, the annual healthcare costs for covering the plan members 14 will tend to increase, representing a greater risk to the healthcare provider.

The exercise enthusiast category 40 may represent those plan members 14 who have already adopted an integrated fitness program, often combining heavy regular aerobic exercise on a routine basis with moderate to significant weight training. Members within the exercise enthusiast category 40 typically pose the least amount of healthcare risk to the healthcare provider.

The active lifestyle category 42, in turn, may represent those plan members 14 who incorporate active exercise into their regular routine, with some aerobic activity and with light to moderate weight training. Members within the active lifestyle category 42 are typically not overweight, but may benefit from an increase in activity level.

The occasional activity category 44 may represent those plan members 14 who incorporate occasional exercise into their regular routine, representing a significant percentage of the plan members 14 within the pool. Although many plan members 14 within the occasional activity category 44 do not currently exhibit symptoms indicating declining health and costly medical conditions, such members 14 are often at a long-term risk for developing debilitating or chronic conditions.

The sedentary activity category 46 may represent those plan members 14 who have incorporated limited or no exercise into their regular routine. Members within the sedentary activity category 46 are typically at the greatest risk for developing debilitative or chronic conditions due to their inactive lifestyle, and as such, often pose a significant healthcare risk to the healthcare provider.

The rehabilitation category 48 may represent those plan members 14 that, through the occurrence of a single injury event or the onset of a chronic illness, require provider-supervised rehabilitation. Members within the rehabilitation category 48 may have a diverse range of activity levels and due to their current condition and need for rehabilitation, often pose a significant healthcare risk to the healthcare provider.

While several illustrative activity categories 38 are provided for purposes of segmenting plan members 14 based on activity level, it should be understood that other activity categories are possible. Moreover, while five activity categories 40,42,44,46,48 are depicted in FIG. 2, it should be understood that a greater or lesser number of activity categories could be utilized to differentiate plan members 14.

Several health status categories 50 can be further used for segmenting the pool of plan members 14 based on health status. The health status categories 50 can include, for example, a well category 52 indicating those plan members 14 that are currently healthy and have no known debilitative or chronic conditions, an at risk category 54 indicating those plan members 14 that are at risk for health complications, and a chronic category 56 indicating those plan members 14 that currently suffer from a debilitative or chronic condition. As indicated generally by arrow 58, as the health of the plan members 14 decreases from bottom to top in the diagram of FIG. 2, the annual healthcare costs for covering the plan members 14 will tend to increase, representing a greater risk to the healthcare provider.

The behavior modification programs 28,30 can be customized to encourage plan members 14 within one or more of the activity level categories 38 to reach a target health status 60 for reducing the annual healthcare costs associated with insuring those plan members 14. In certain embodiments, for example, plan members 14 within the occasional and sedentary activity categories 44,46 can be targeted for enrollment in a behavior modification program, which, when successfully implemented, results in a general increase in activity level. As the targeted plan members' 14 activity levels increase, as indicated generally by the horizontal arrows 62 in FIG. 2, the annual healthcare costs associated with those members will tend to decrease. In addition, and as indicated generally by the vertical arrows 64 in FIG. 2, once the targeted plan members 14 have migrated towards the active lifestyle category 44 through participation in the behavior modification program, the plan members' health status will also tend to improve, resulting in a reduction in annual healthcare expenditures.

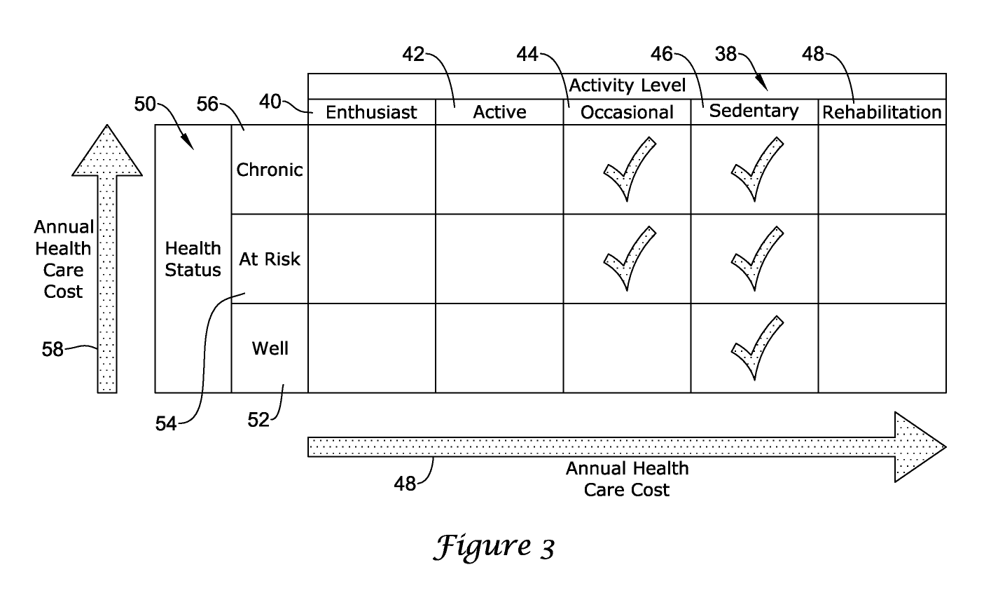

The plan sponsor 12 may target plan members 14 who, as a result of low activity levels and/or poor health, present the greatest health risk to the plan sponsor 12. As shown in FIG. 3, for example, the plan sponsor 12 may target all plan members 14 who are categorized in the sedentary activity category 46, and those plan members 14 whose health status is categorized as at-risk 54 or chronic 56 and who are categorized in the occasional activity category 44, as shown. It should be understood, however, that the targeting of plan members 14 for enrollment in a behavior modification program can occur across different activity levels and/or health status categories than that depicted in FIG. 3. In addition, the targeting of plan members 14 can also be based on other factors in addition to or in lieu of health status and activity level.

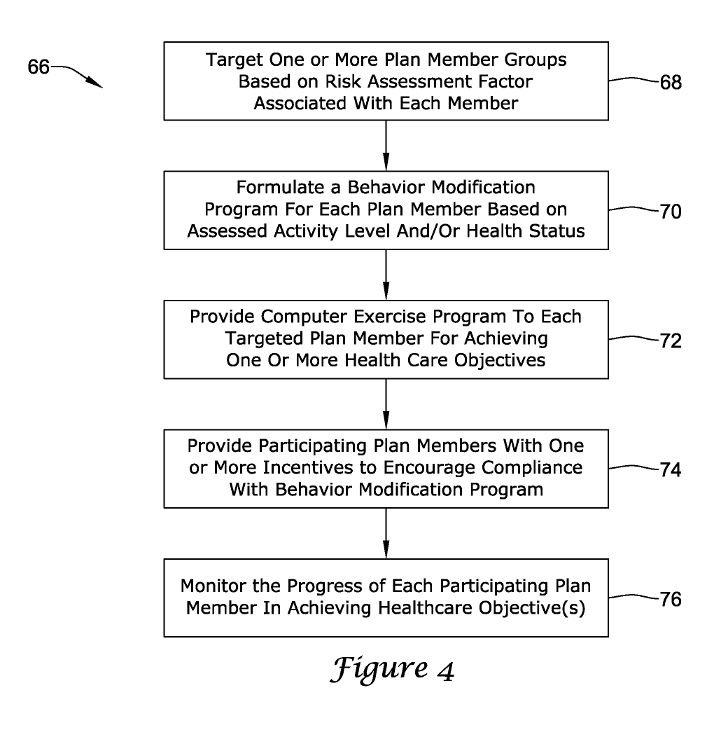

FIG. 4 is a flow diagram showing an illustrative method 66 of promoting health and wellness of plan members within the health and wellness management system 10 of FIG. 1. As shown in FIG. 4, the method 66 may begin generally at block 68 with the step of targeting one or more groups of plan members within a health plan based at least in part on a risk assessment factor associated with each member. In certain embodiments, for example, the targeting of one or more groups of plan members can be accomplished by categorizing the plan members into the general activity level categories and health status categories discussed above with respect to FIG. 2, and then targeting those plan members who present the greatest health risk to the plan sponsor, as further discussed with respect to FIG. 3.

Once one or more groups of plan members are targeted within the population at block 68, the plan sponsor may then formulate a behavior modification program for each plan member based on the assessed activity level and/or health status of the plan member, as indicated generally at block 70. The formulation of a behavior modification program for each plan member can be accomplished, for example, by clinical assessment from a healthcare professional, by questionnaires provided to each plan member, or by other suitable means for assessing the plan members' healthcare needs.

A computer exercise program can be provided to each targeted plan member as a part of the behavior modification program for achieving one or more objectives, as indicated generally by block 72. The exercise program can be customized to achieve a particular healthcare-related goal for each plan member, which can then be monitored via the plan administrator to ensure proper compliance with the behavior modification program directives. With respect to at-risk plan members having an occasional or sedentary activity level, for example, the exercise program can be customized to provide a workout specifically tailored to individuals not having significant exercise experience. In some embodiments, monitoring and compliance with the behavior modification program can be conducted under the control of a healthcare or fitness professional such as a physician, physical therapist, nurse, chiropractor, or physical trainer.

In certain embodiments, the exercise program can be configured to operate over a video cellular telephone, Palm-Pilot®, Bluetooth®, or other hand-held device, allowing the plan member to perform prescribed exercise routines remotely while away from home. The hand-held device can be configured to display exercise animations demonstrating the exercises to be performed as a part of the prescribed behavior modification program. In some embodiments, the hand-held device can include a means for monitoring the performance of exercises prescribed as part of the behavior modification program. For example, the hand-held device can include a video camera and/or inertial measurement unit (IMU) that can be used to monitor the member's motion while performing the prescribed exercises.

To encourage compliance with the behavior modification program, the plan sponsor may provide participating plan members with one or more incentives for enrollment and/or continued participation in the program, as indicated generally by block 74. The incentives can include, for example, a discount on the cost of the exercise program, a reduction in out-of-pocket expenses normally paid to the plan sponsor, and/or a monthly credit received from the plan sponsor. In some embodiments, incentives can be provided for those members that enroll in the program and who successfully achieve one or more exercise goals relating to their prescribed program.

Once the plan member is actively involved in the behavior modification program, the plan administrator may monitor the progress of the member in achieving the one or more health related objectives, as indicated generally by block 76. Monitoring of the successful completion of the health related objectives can be accomplished, for example, by a compliance module of the exercise program configured to monitor the member's usage of the program. Monitoring of each participating plan member's progress can also occur by feedback provided by the member's physician, a risk assessment professional, or other such individual. In those embodiments where the exercise program is used on a hand-held device such as a video cellular telephone, for example, usage data collected by the hand-held device can be transmitted back to the plan administrator to determine the member's compliance with the prescribed exercises routines.

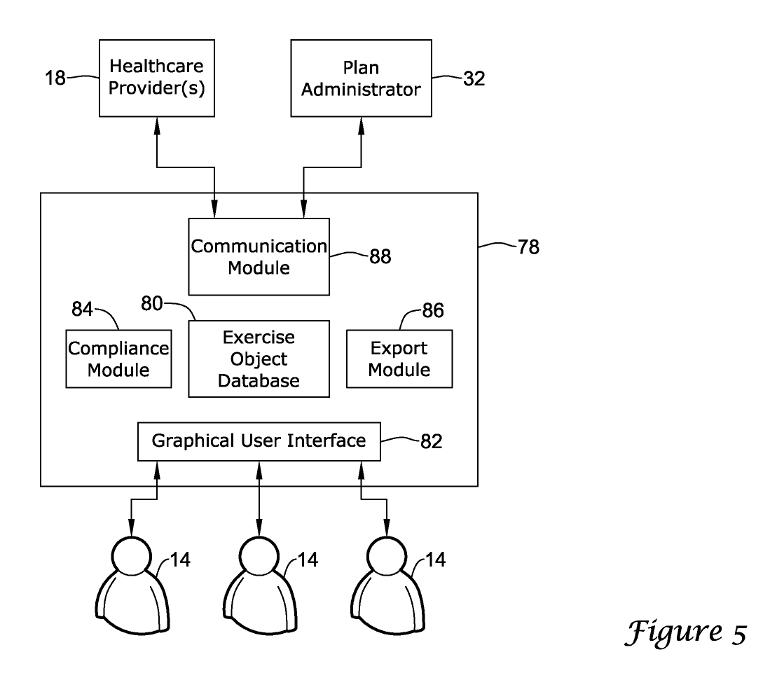

FIG. 5 is a diagrammatic view showing an illustrative computer exercise program 78 for use with the health and wellness management system 10 of FIG. 1. The exercise program 78 can be implemented as software and/or hardware executable on a stand-alone computer or on a network. The exercise program 78 may comprise, for example, a DVD, CD-ROM, game cartridge, or other suitable format capable of operating on a personal computer, a hand-held device such as a Palm Pilot®, Bluetooth® or ipod®, a gaming console such as an xBox or PS2®, a video cellular telephone, a monitor or television, or other such device capable of displaying graphics. In some cases, the exercise program 78 may be provided as a printout or disk at the gym, physician's office, or other remote location using an exercise kiosk. In some embodiments, the exercise program 78 can be implemented as a web-based program, allowing multiple users and/or healthcare professionals to access to the exercise program 78 via an Internet connection. For example, the exercise program 78 can be configured to operate as a Structured Query Language (SQL) database management system over a web-based server such as Apache Web Server.

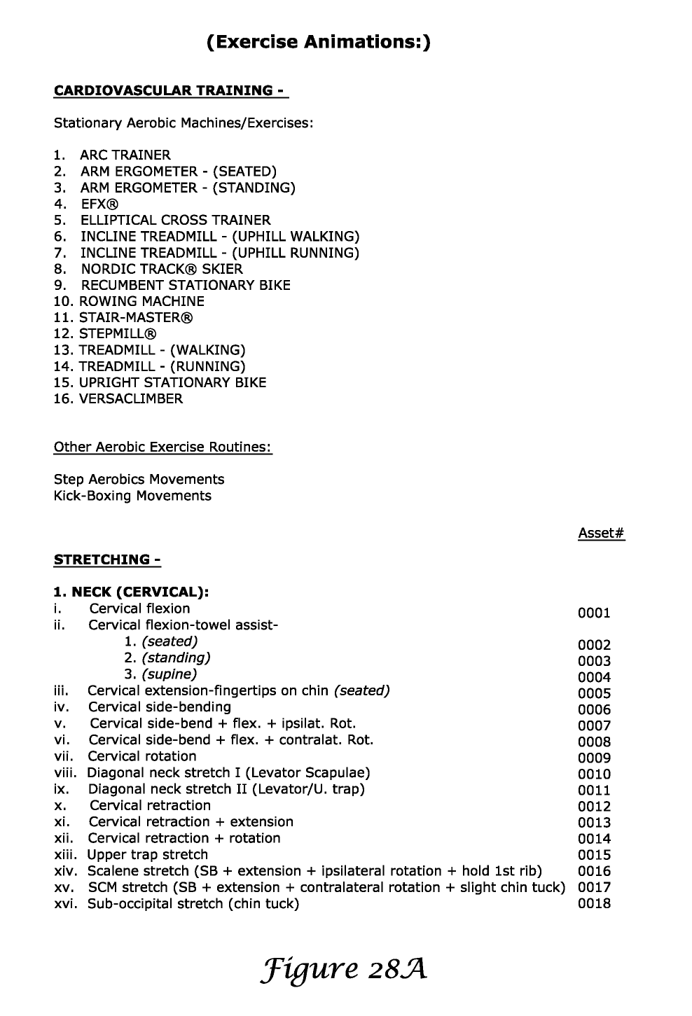

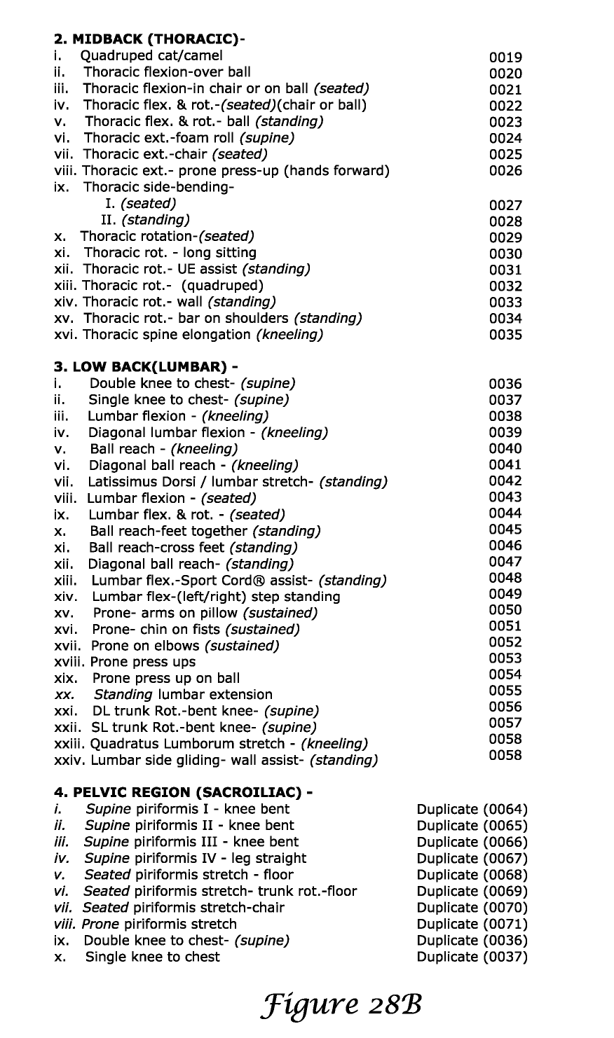

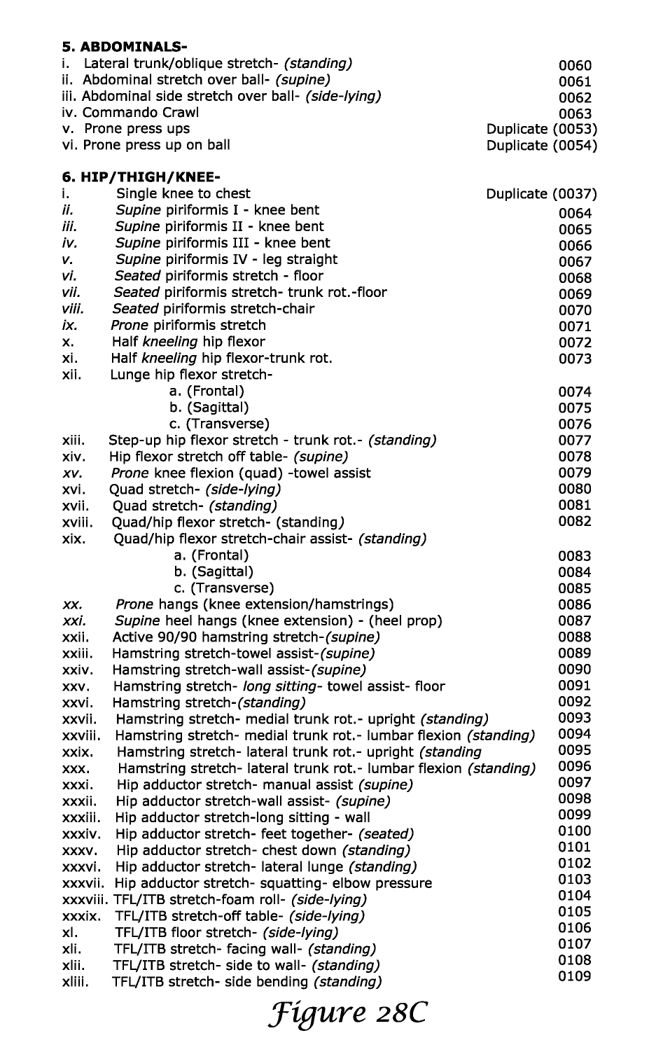

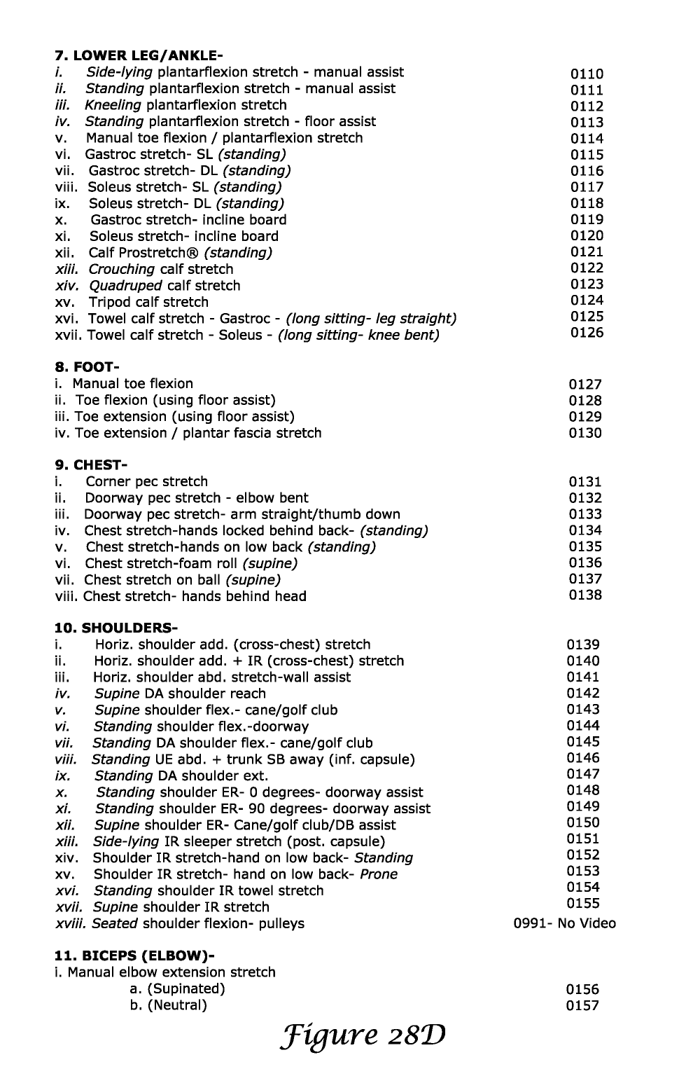

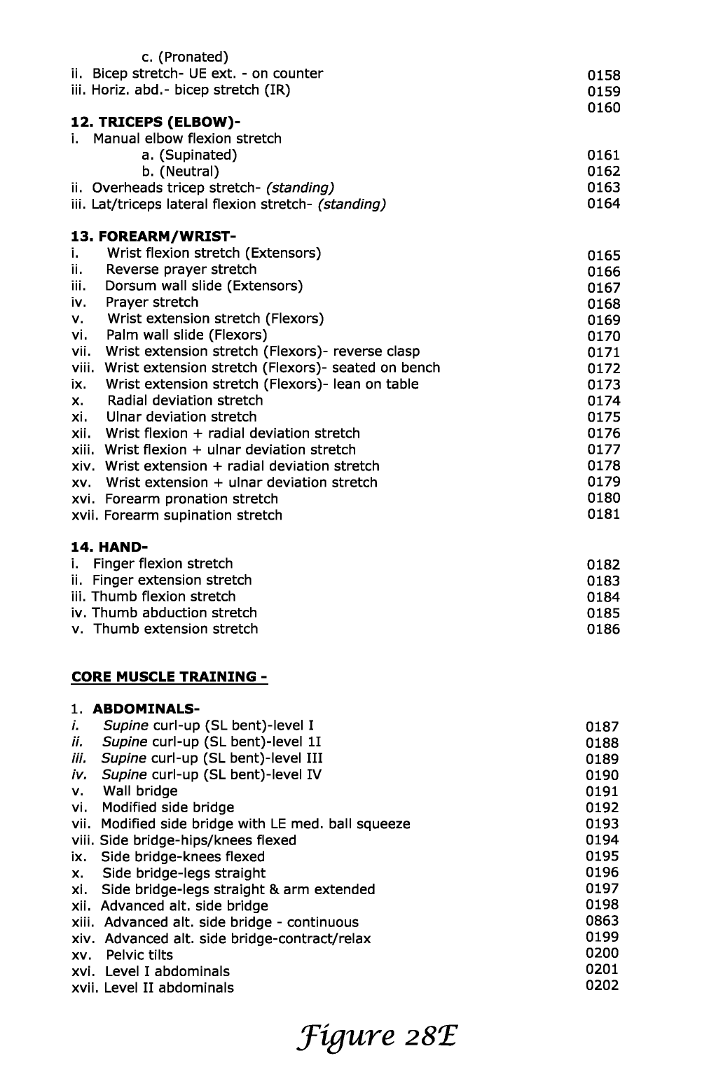

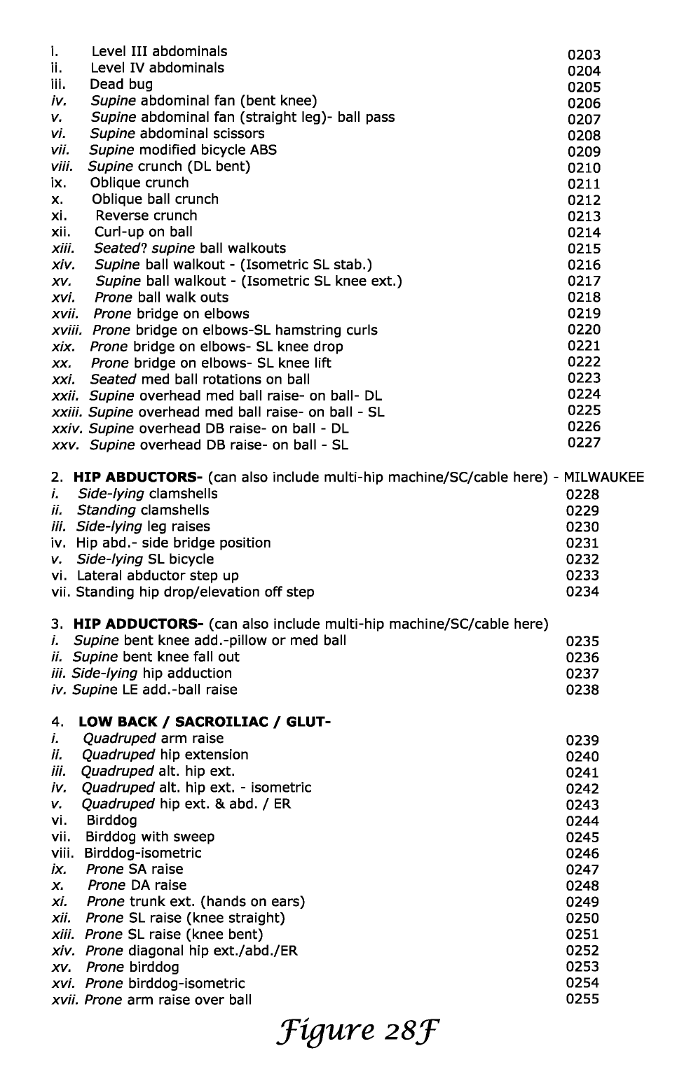

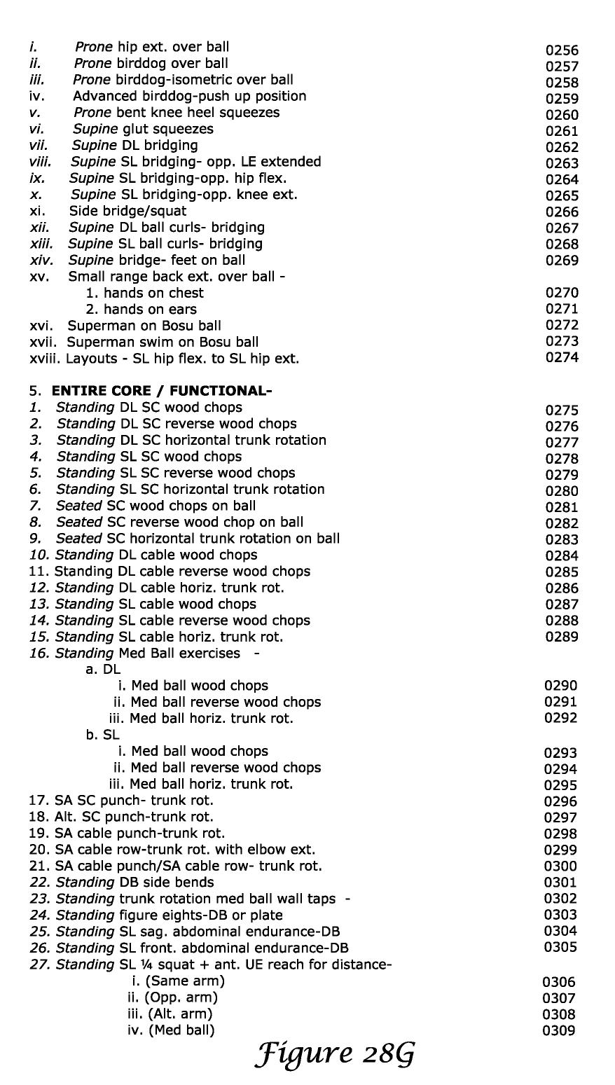

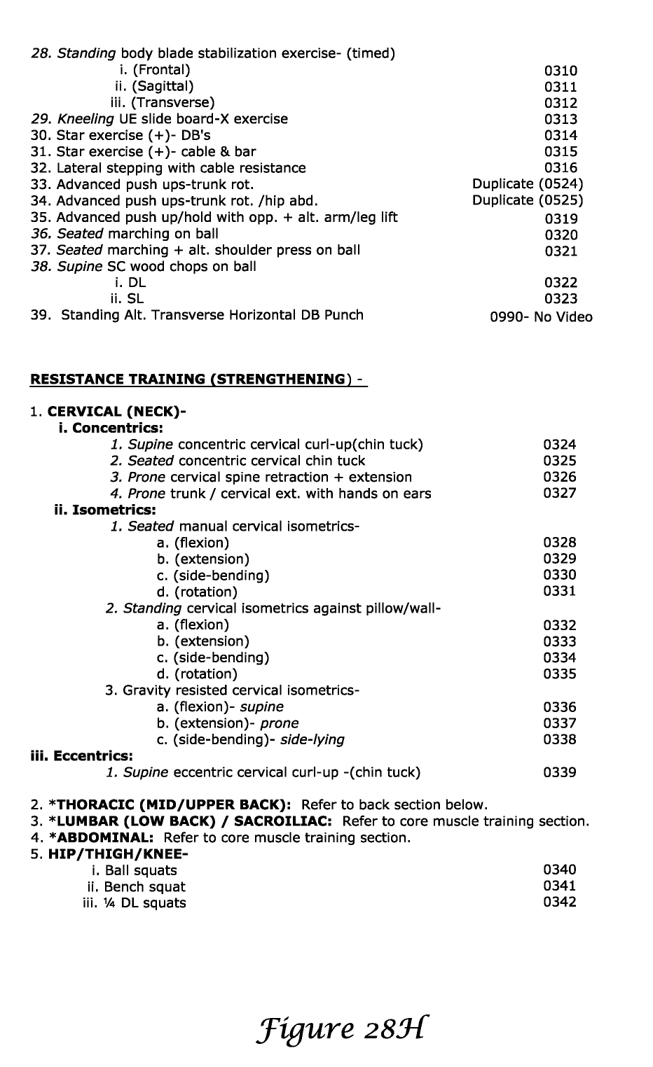

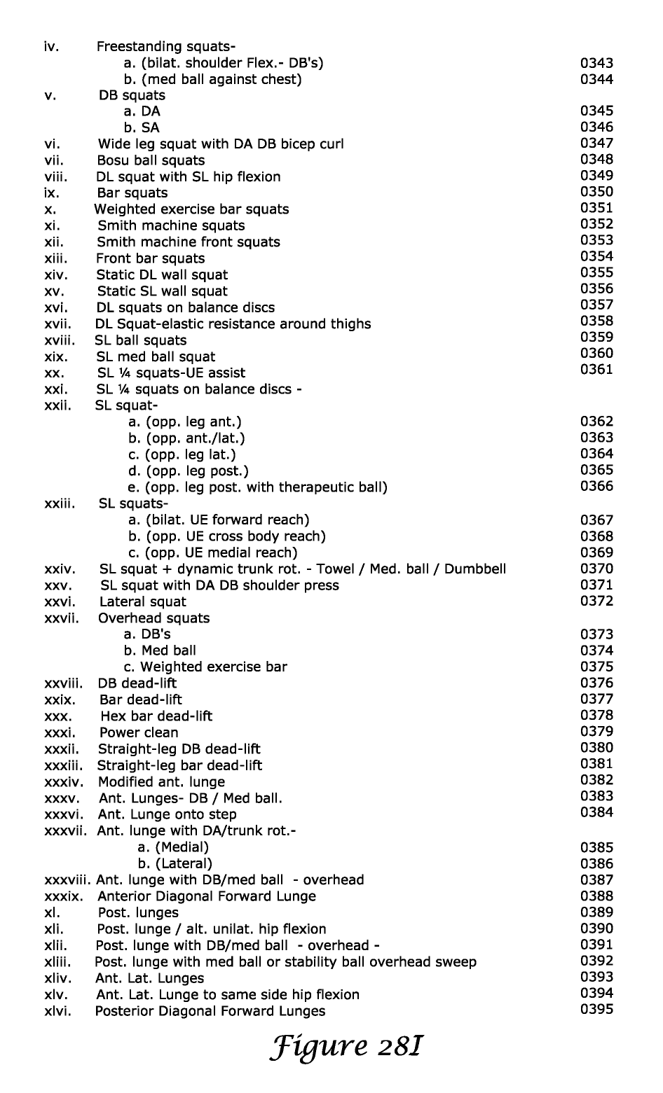

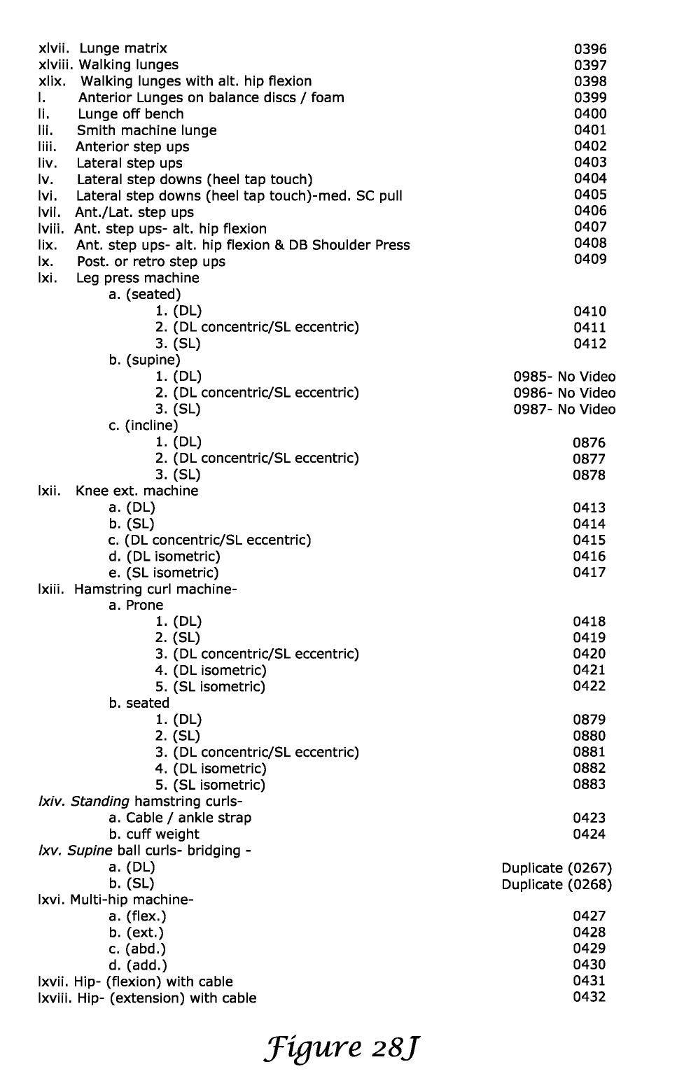

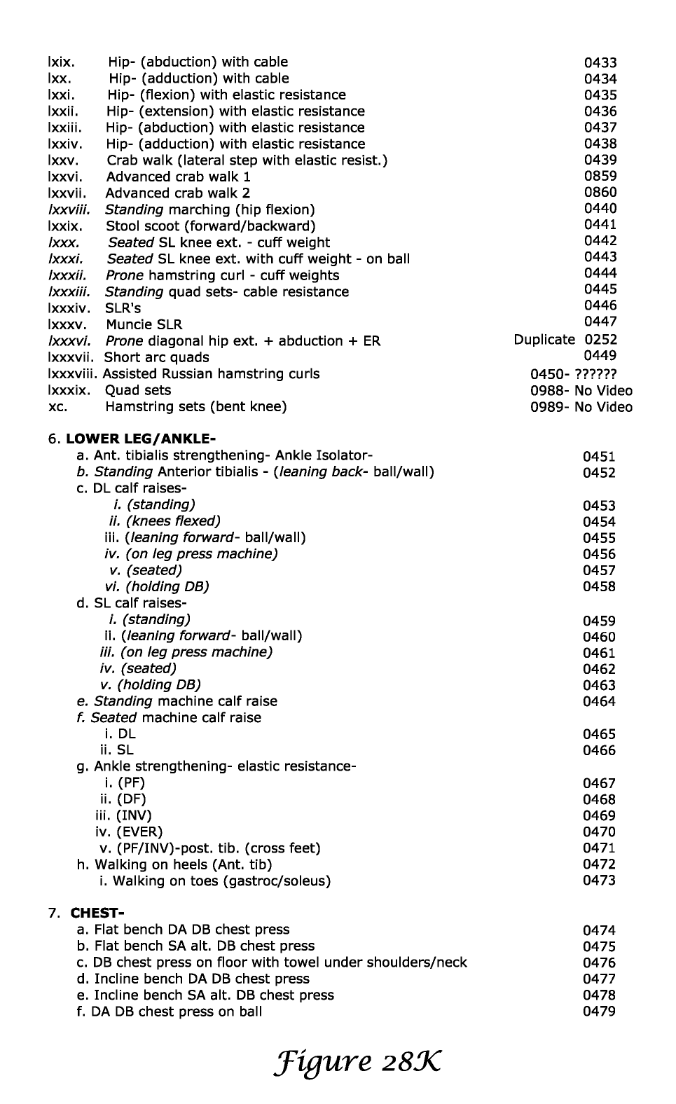

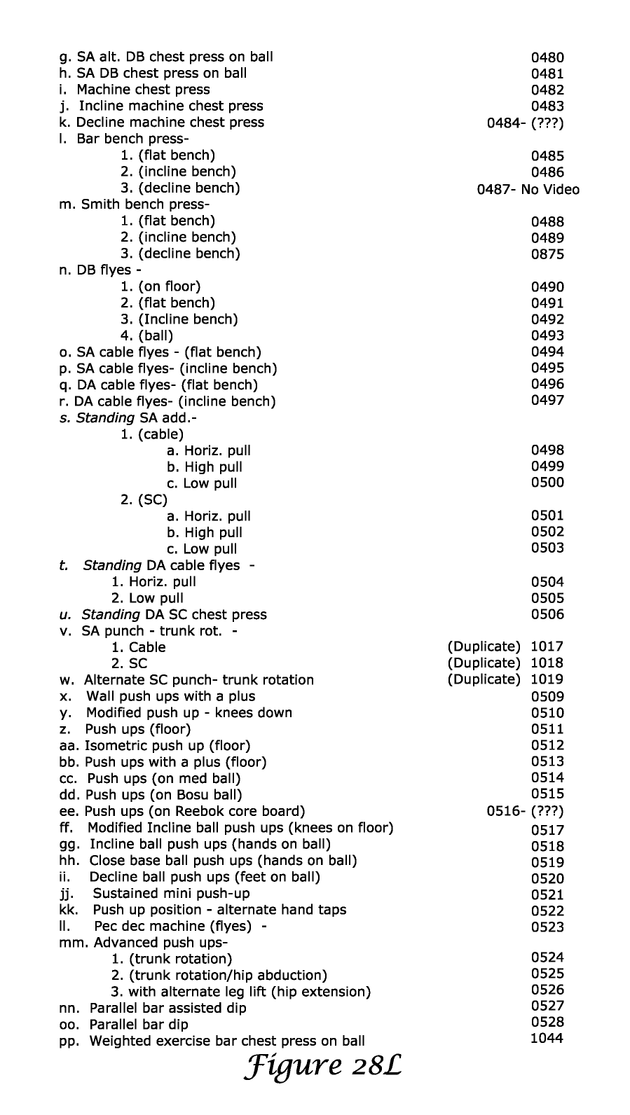

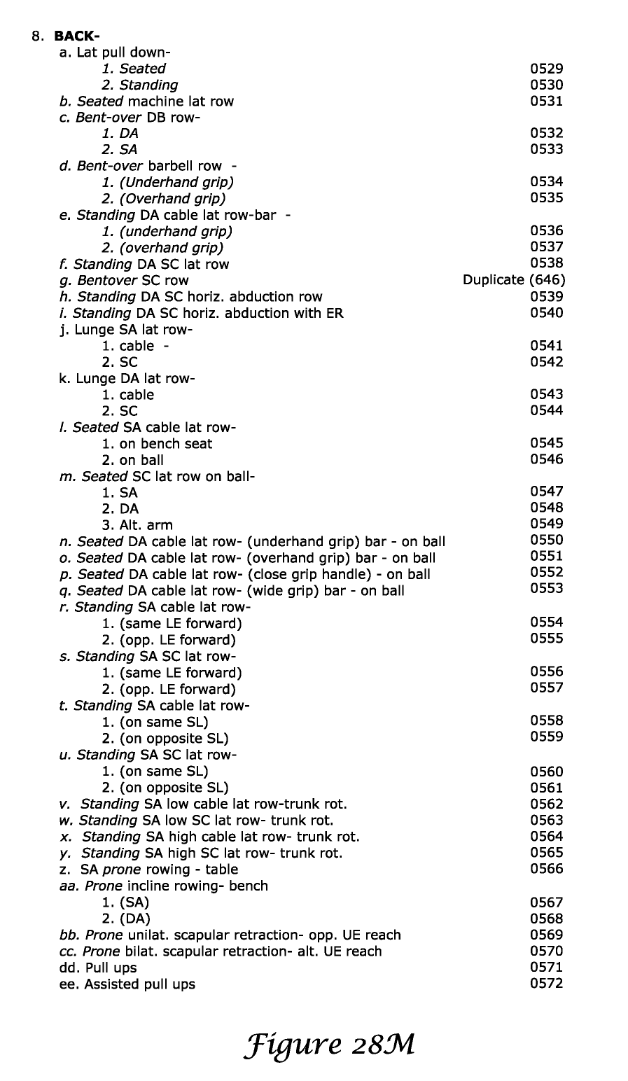

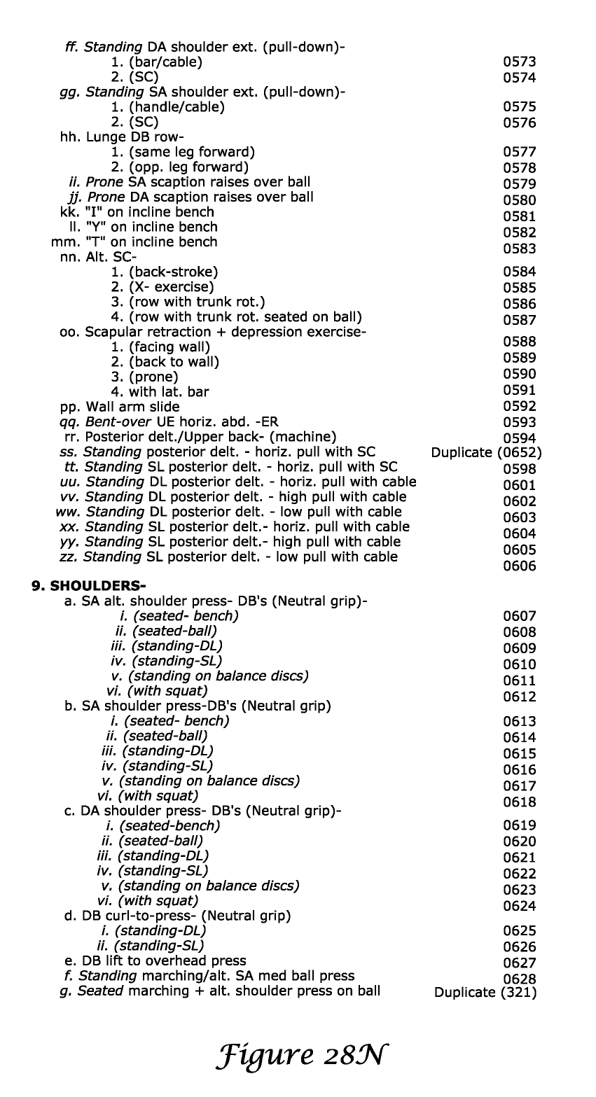

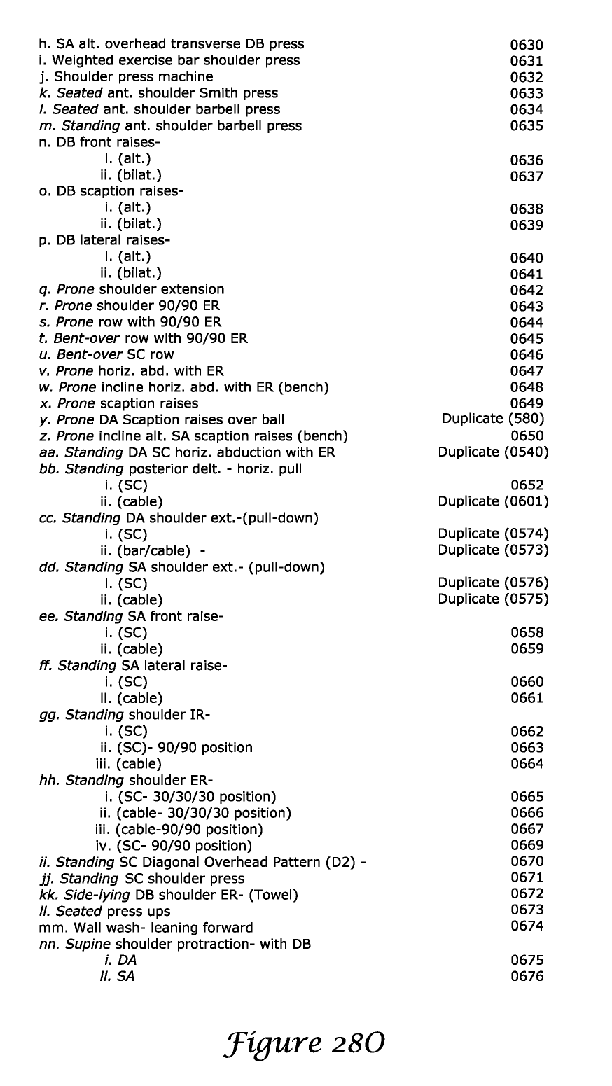

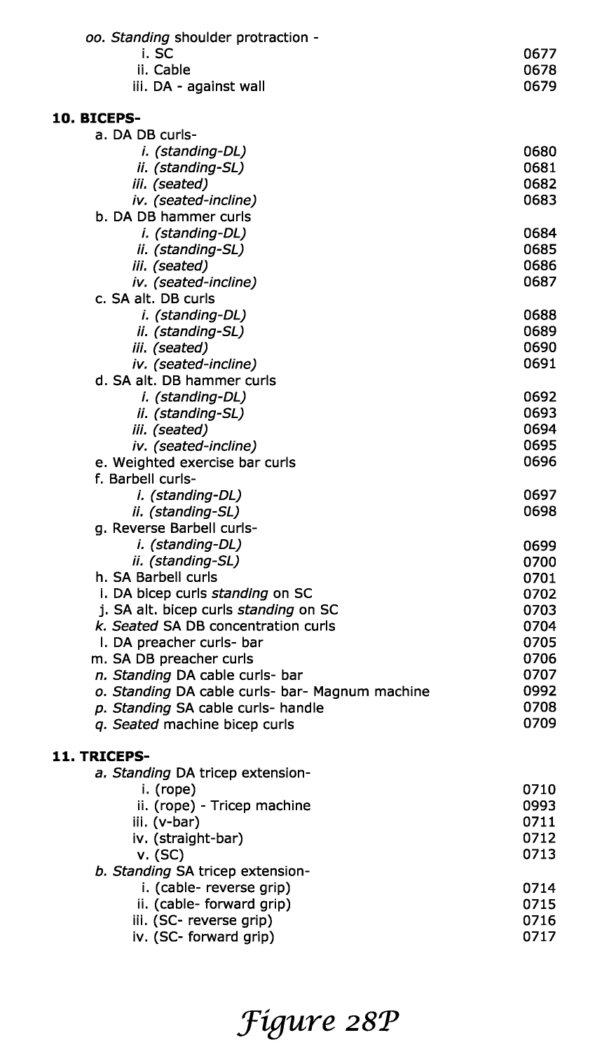

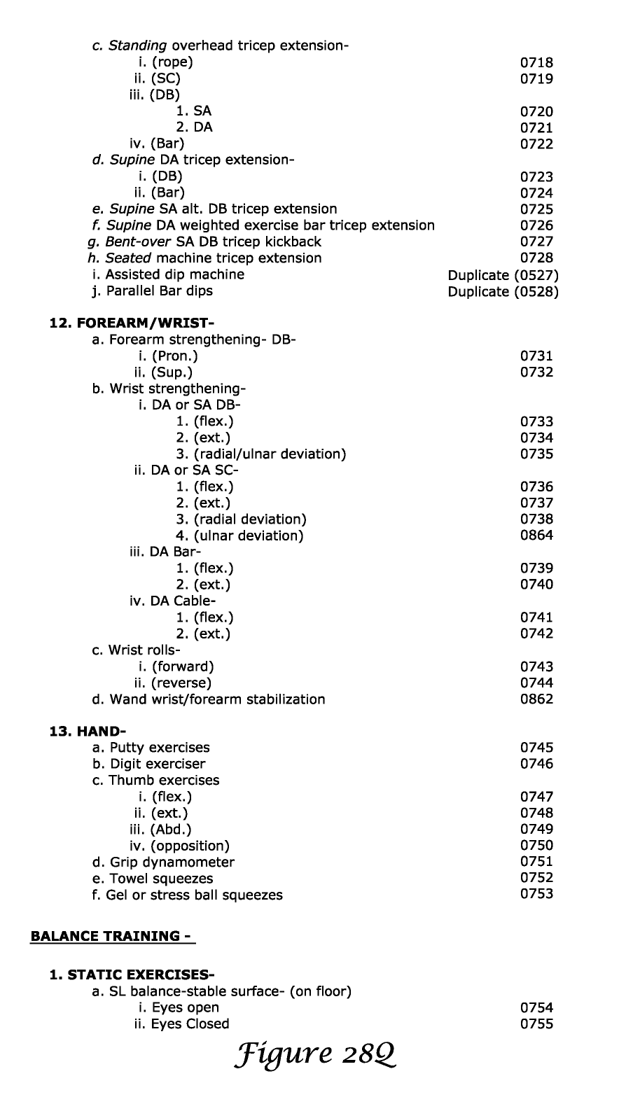

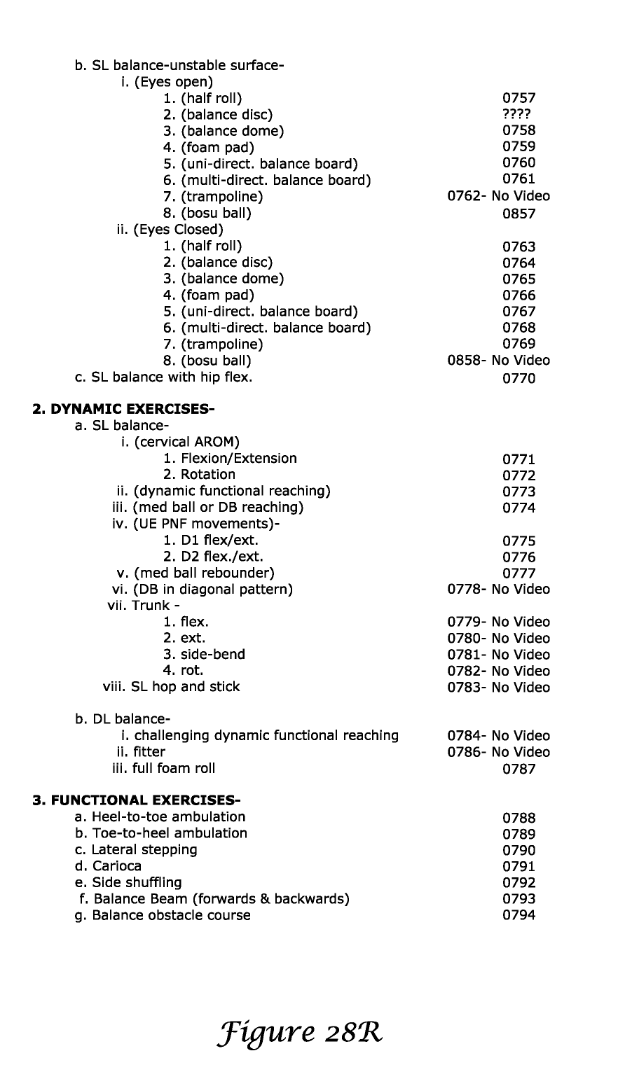

The exercise program 78 can include an exercise object database 80 containing a number of exercise routines that can be used to create a customized workout for one or more end users 14 (e.g., plan members, clients, etc). The exercise object database 80 can be accessed by one or more users 14 via a graphical user interface (GUI) 82, allowing the users 14 to design a customized exercise workout that can then be viewed as a 3-D animation on a display screen. In certain embodiments, the exercise object database 80 can be used to develop a customized workout that can be performed with the assistance of a 3-D animated virtual trainer on the GUI 82 that demonstrates the clinically proper method in which to perform each exercise routine within the workout. For example, and as discussed in greater detail herein with respect to several exemplary screen shots, the exercise object database 80 may permit the user to design a customized workout by inputting various exercise parameters into the exercise program 78 based on exercise category, exercise name, target muscle, body position and/or an asset number associated with each exercise. An illustrative list of exercise animations contained within the exercise object database 80 can be seen, for example, in FIGS. 28A-28R.

Once configured, the workout can then be performed under the guidance of a 3-D virtual trainer who graphically and aurally demonstrates the proper method in which to perform the various exercise routines either in a virtual health club environment, a plain background 3-D environment, or other 3-D environments/levels that may be interesting to the user.

A compliance module 84 of the exercise program 78 can be configured to monitor usage of the program 78, including the types of exercises performed and the dates and/or times that the exercises are performed. Other information such as the user's weight and blood pressure can also be tracked using the compliance module 84.

An export module 86 can be provided to permit workouts to be exported into a format suitable for playback on another device. In certain embodiments, for example, the export module 86 can be utilized to convert workouts to an MPEG, WAV, MOV or other such format for later playback on a DVD player, video MP3 player, hand-held computer, game console, video cellular telephone, or other such device. In some applications, the export module 86 may facilitate the creation of a portable workout for use while away from home.

A communications module 88 can be provided to permit data to be transmitted back and forth between the user 14 and user's healthcare provider 18 and/or plan administrator 32. The communications module 88, for example, can be utilized to send monitoring data back and forth between the user 14 and a healthcare professional such as a physician, physical therapist, nurse, or chiropractor, providing feedback on the usage of the exercise program 78. The communications module 88 can also be used by healthcare professionals to facilitate the transmittal of customized exercise protocols to their patients. In some embodiments, the exercise program 78 can include a built-in messaging system to facilitate the sending and/or receiving of messages and product updates, if desired.

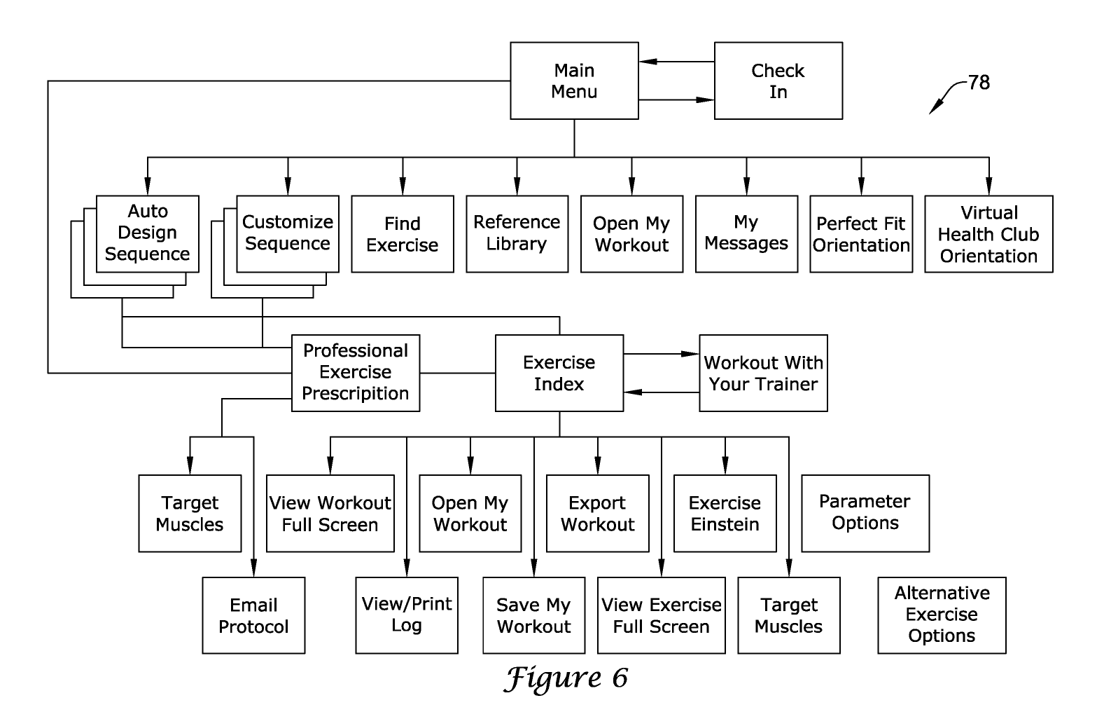

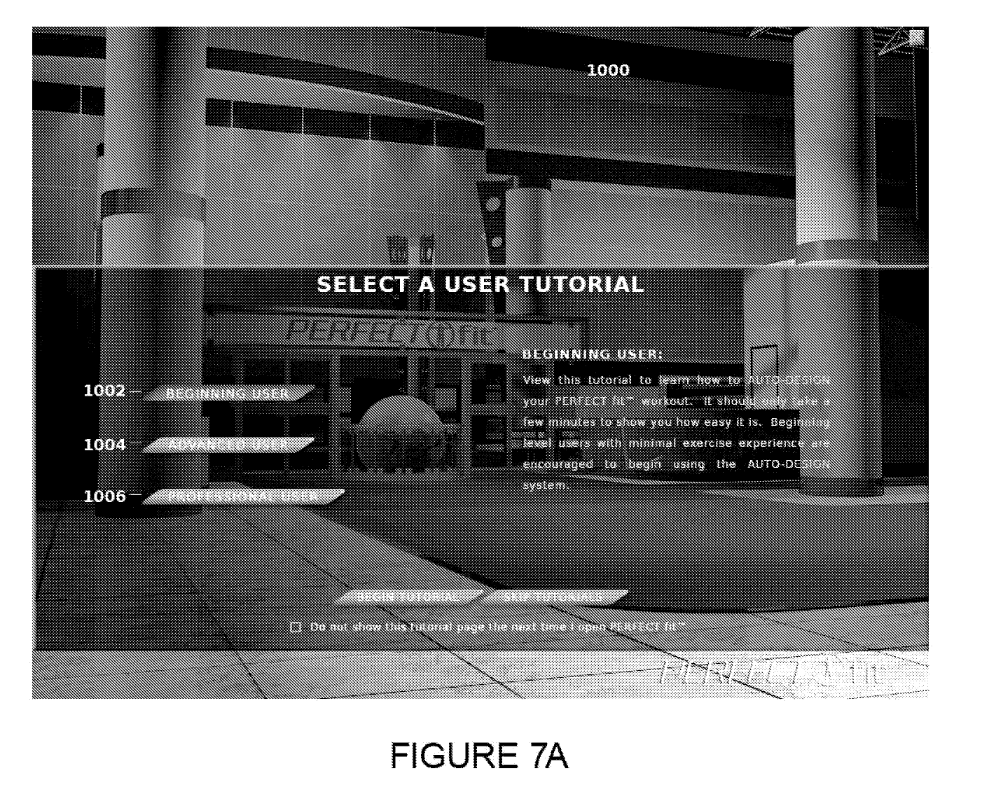

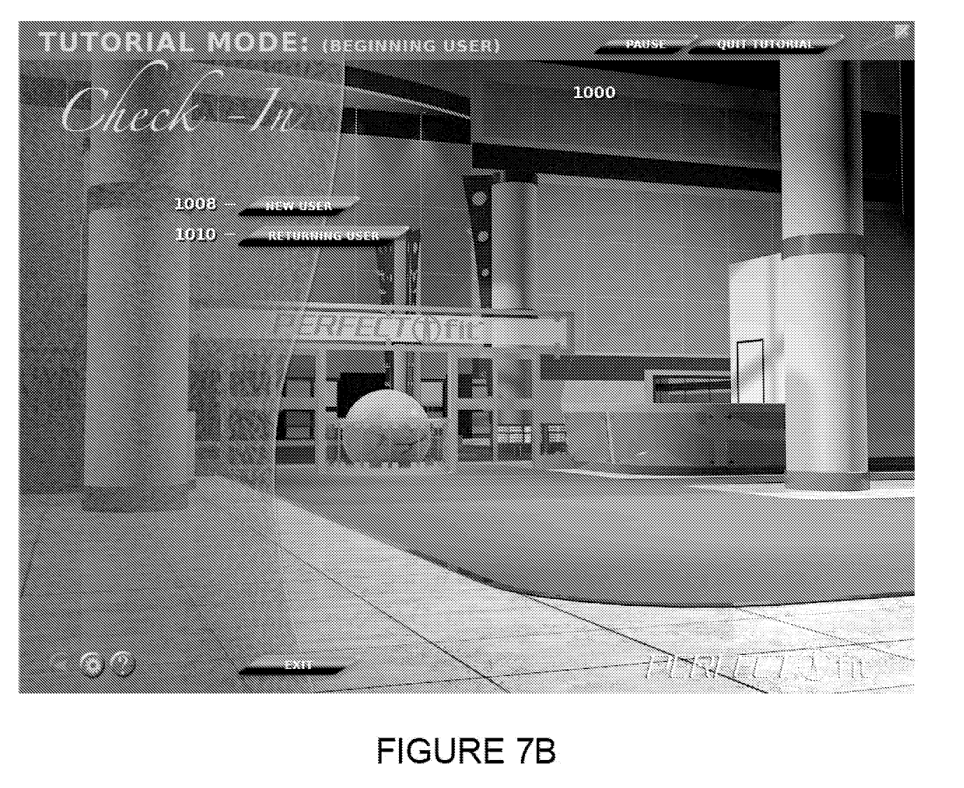

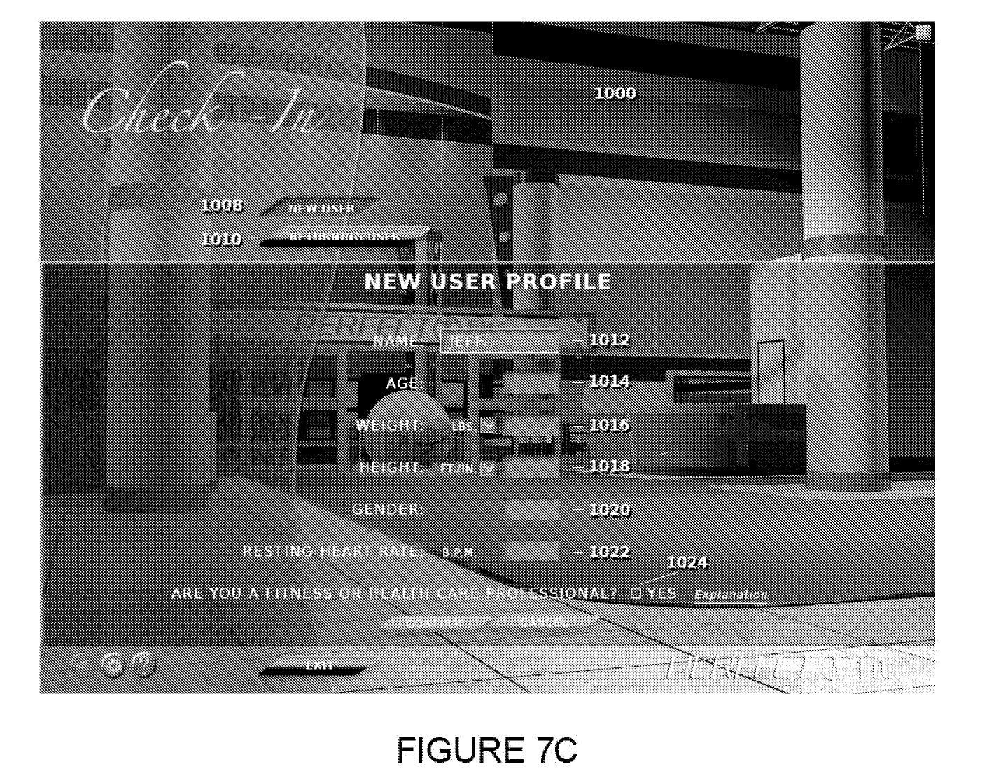

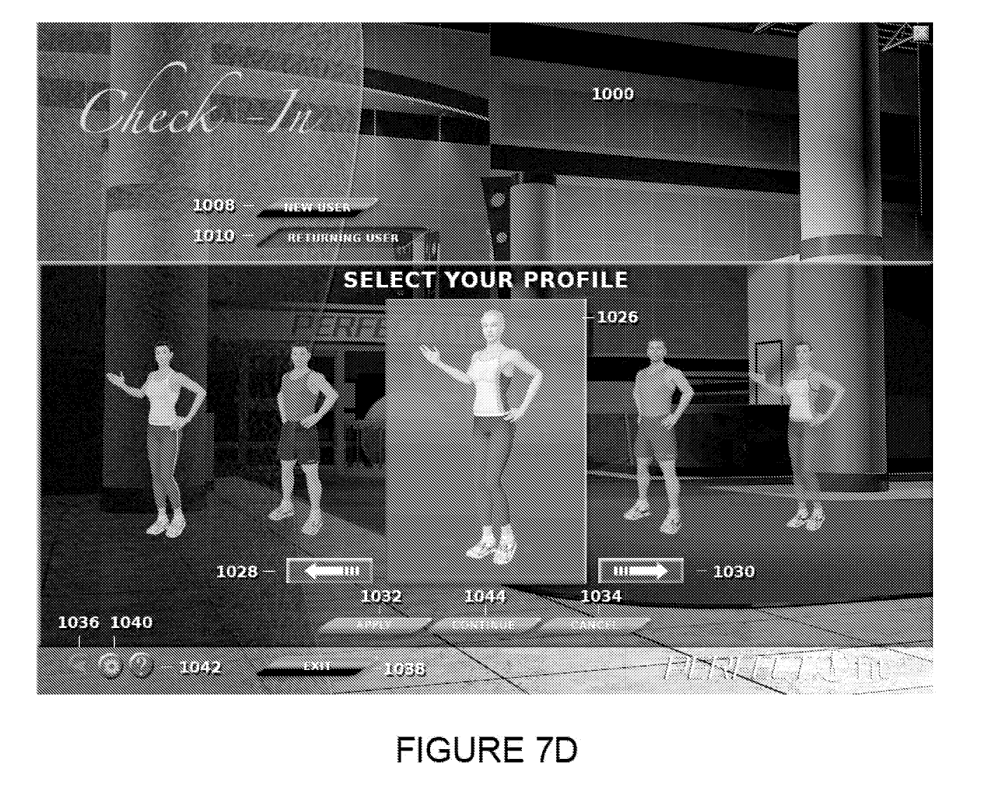

FIG. 6 is a user-flow diagram showing an illustrative implementation of the exercise program 78 of FIG. 5. FIG. 6 may represent, for example, several interface screens, which as discussed below in greater detail with respect to FIGS. 7-18, can be utilized to create a customized workout that can be performed in conjunction with a 3-D virtual trainer.

FIGS. 7A-7D are screen shots showing a check-in interface that can be provided upon program startup to permit the user to enter basic identifying information and to indicate their general understanding level of the exercise program 78. As can be seen in a first screen shot in FIG. 7A, for example, the exercise program 78 can be configured upon startup to present a display screen 1000 to the user with a beginning user icon button 1002, an advanced user icon button 1004, and a professional user icon button 1006, allowing the user to indicate their general understanding level of the exercise program 78. Selection of the beginning user icon button 1002, for example, can cause the exercise program 78 to initiate a tutorial mode that can be used to educate the user of the various features and capabilities of the exercise program 78 that are most appropriate for a beginning level user prior to initial use. Selection of the advanced user icon button 1004, on the other hand, can cause the program to initiate a tutorial mode that can be used to educate the user of various features and capabilities of the exercise program 78 appropriate for a user with more exercise experience prior to initial use. Selection of the professional user icon button 1006, in turn, can cause the program to initiate a tutorial mode that can be used to educate healthcare or fitness professionals about various features and capabilities of the exercise program 78 that are available to create a particular exercise prescription for their clients.

FIG. 7B is a screen shot showing the display screen 1000 once the user has viewed one or more tutorials in the tutorial mode. As shown in FIG. 7B, the exercise program 78 can be configured to display a new user icon button 1008 and a returning user icon button 1010, prompting the user to select whether they are a new user or an existing user. Selection of the new user icon button 1008 can prompt the exercise program 78 to present a number of text boxes that can be used to enter various identifying and health information about the user. For example, and as shown in another screen shot in FIG. 7C, the exercise program 78 can be configured to display a name text box 1012, an age text box 1014, a weight text box 1016, a height text box 1018, a gender text box 1020 and a resting hear rate text box 1022, prompting the user to enter their name, age, weight, height, gender, and resting heart rate. An icon selection box 1024 can be further provided on the display screen 1000, prompting the user to select whether they are a healthcare or fitness professional. Selection of box 1024, for example, may enable a healthcare or fitness professional to send exercise protocol updates to clients and to save exercise protocols for future use. In some embodiments, these features and functions may not be available to general users who are not healthcare or fitness professionals.

FIG. 7D is a screen shot showing the display screen 1000 once the user has established a new user profile from the screen in FIG. 7C, or once the user selects the returning user icon button 1010 from the screen in FIG. 7B. As shown in FIG. 7D, the exercise program 78 can be configured to prompt the user to select between a number of virtual trainers 1026 that can be used to demonstrate the various exercises routines programmed within the exercise object database 80. Once the user selects the desired trainer 1026 via a number of arrow icon buttons 1028,1030, the user may then select an apply icon button 1032 on the display screen 1000, causing the exercise program 78 to apply the currently selected trainer 1026 to future workouts. Otherwise, the user may select a cancel icon button 1034 on the display screen 1000, causing the exercise program 78 to cancel the currently selected trainer.

A set of navigational buttons can be further provided on the display screen 1000 to permit the user to navigate between the various interface screens. A back icon button 1036 and exit icon button 1038, for example, can be provided to permit the user to go back to the previous screen or to exit the exercise program 78. A system options icon button 1040 can be provided to permit the user to adjust various settings (e.g., audio, video, etc.) of the exercise program 78, if desired. A help icon button 1042, in turn, can be selected on the display screen 1000 to provide the user with additional information about the selection choices, if desired, or to activate a comprehensive help reference system.

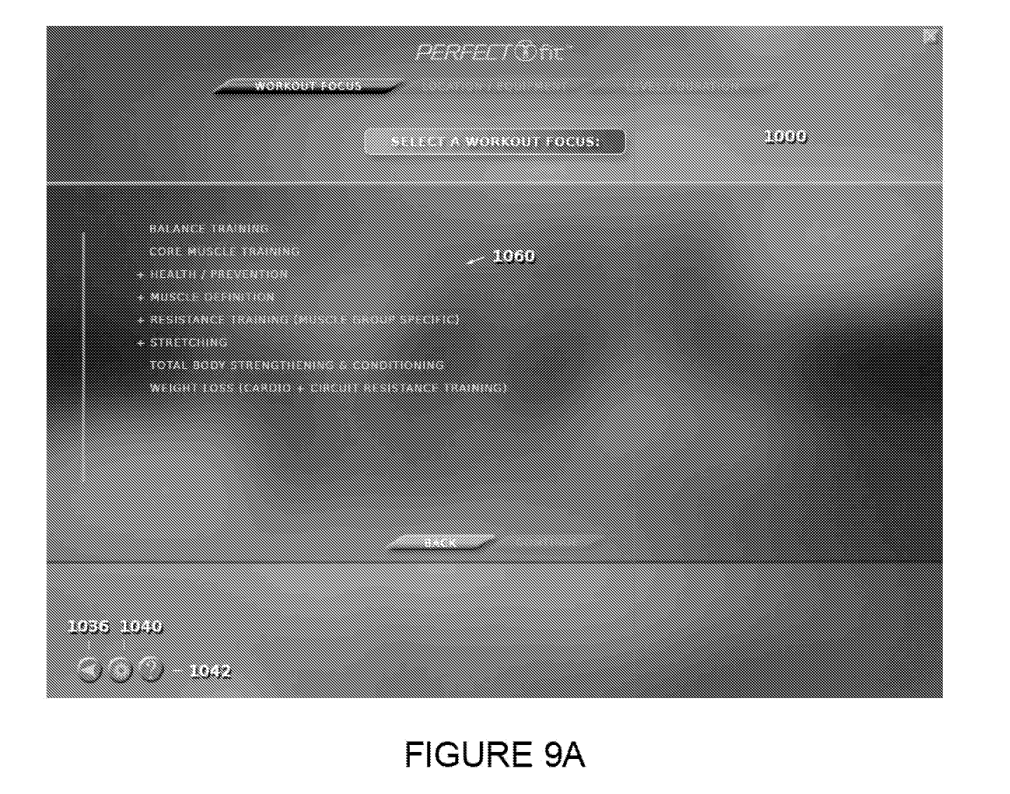

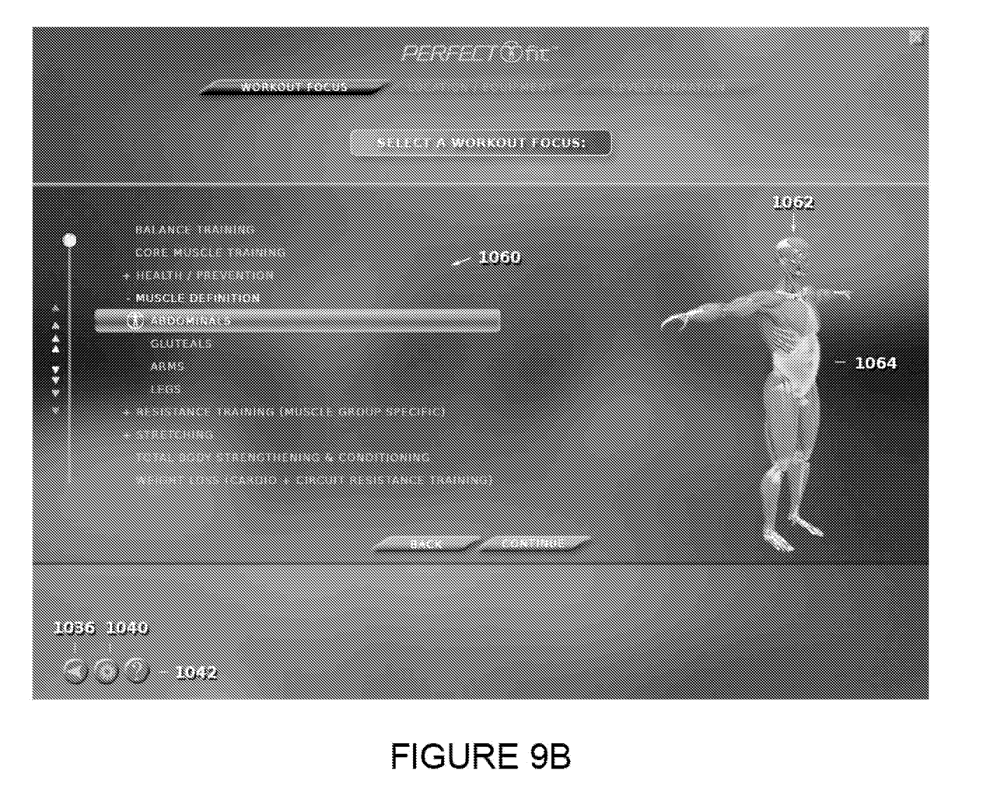

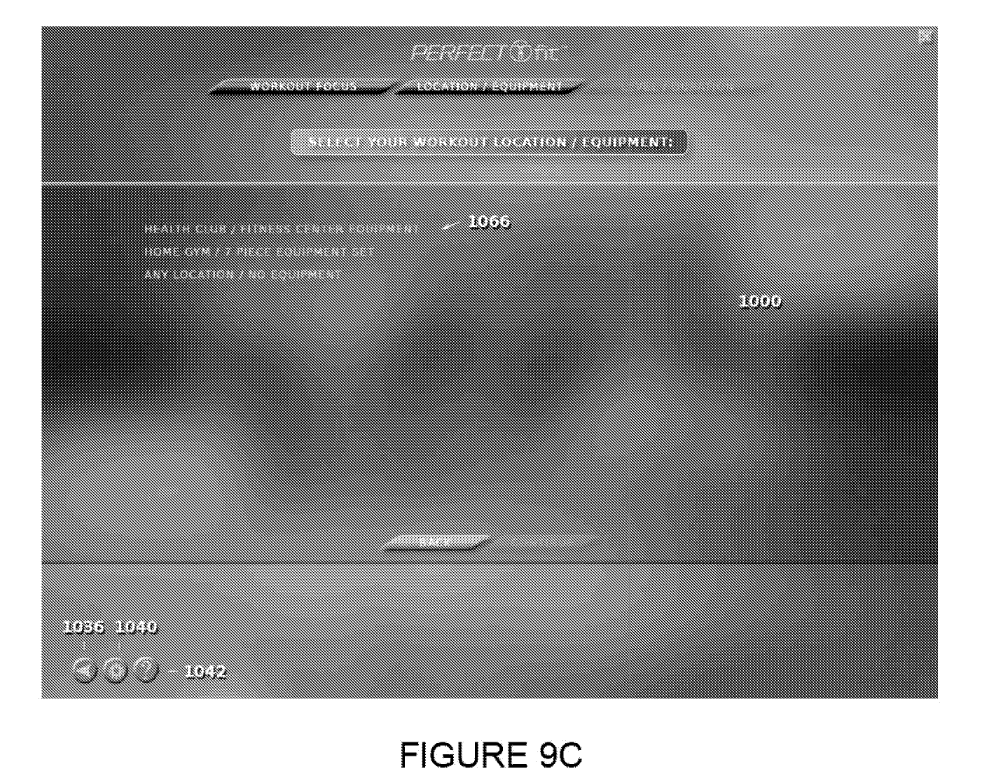

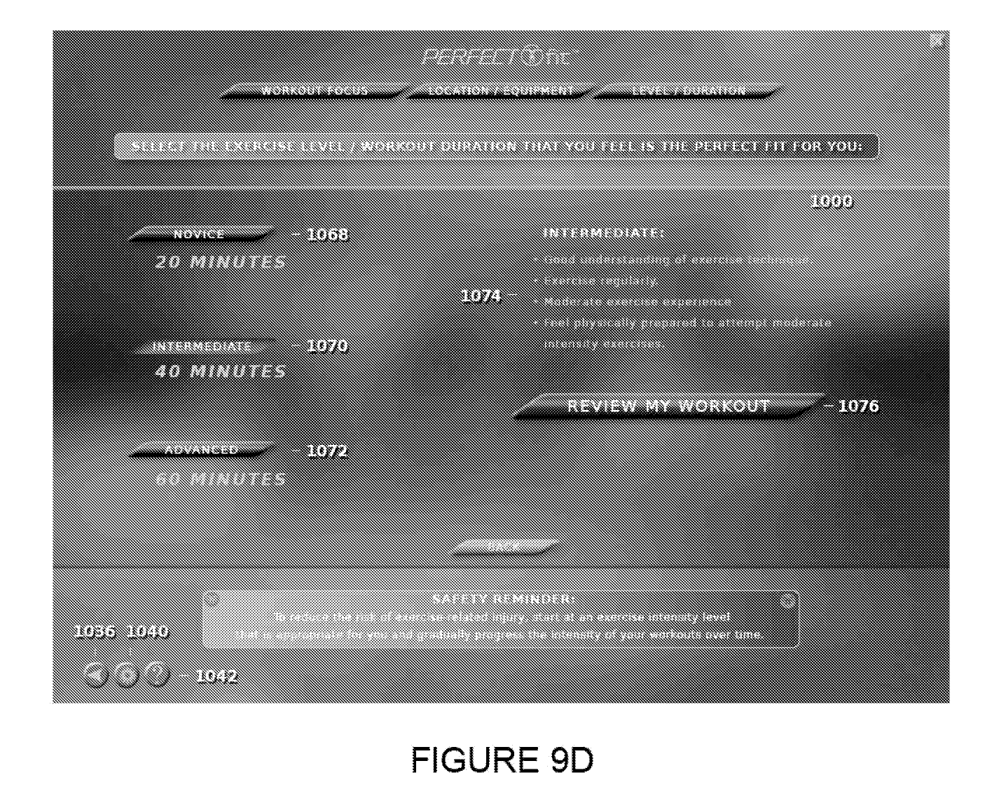

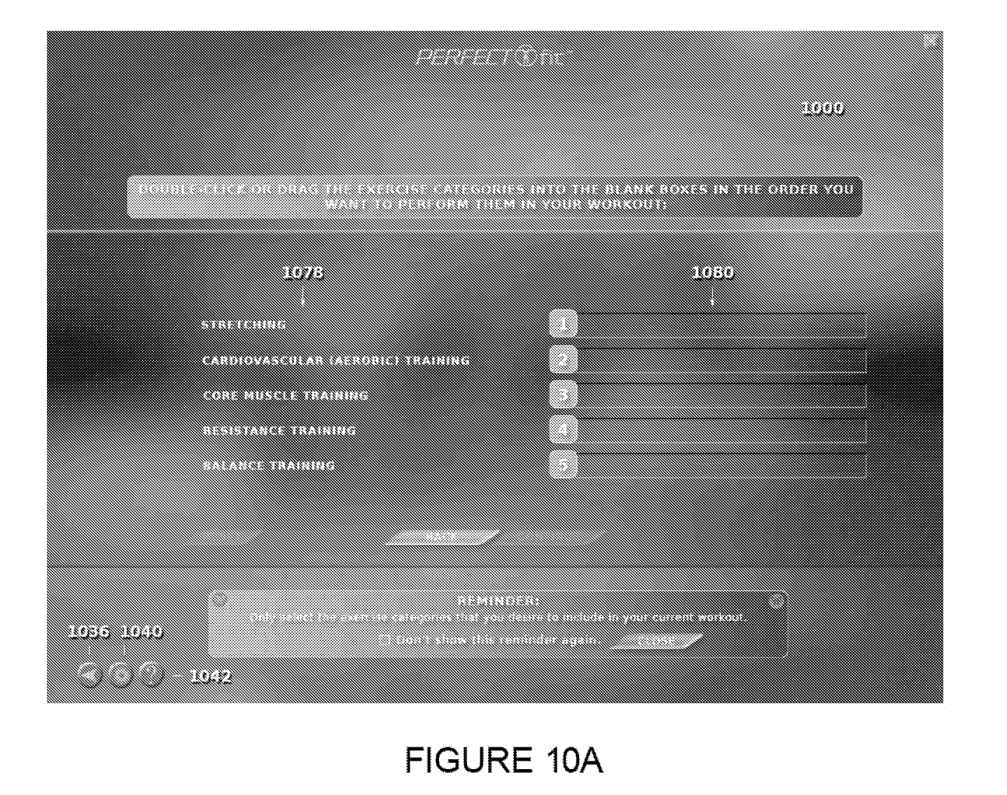

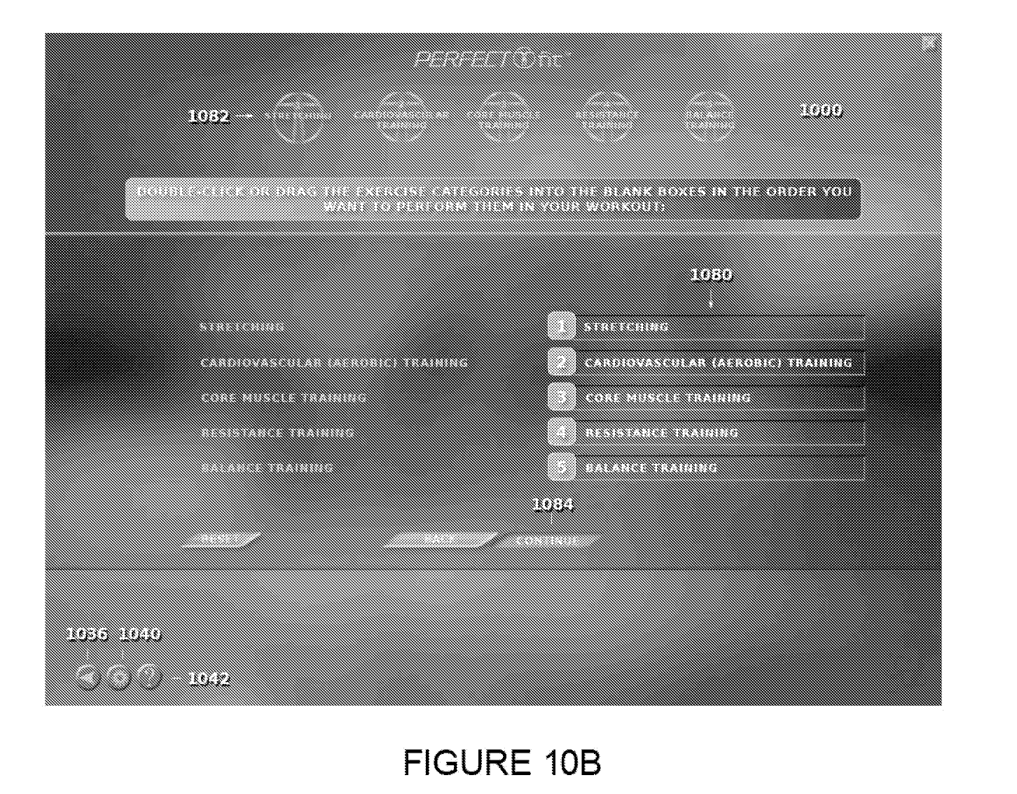

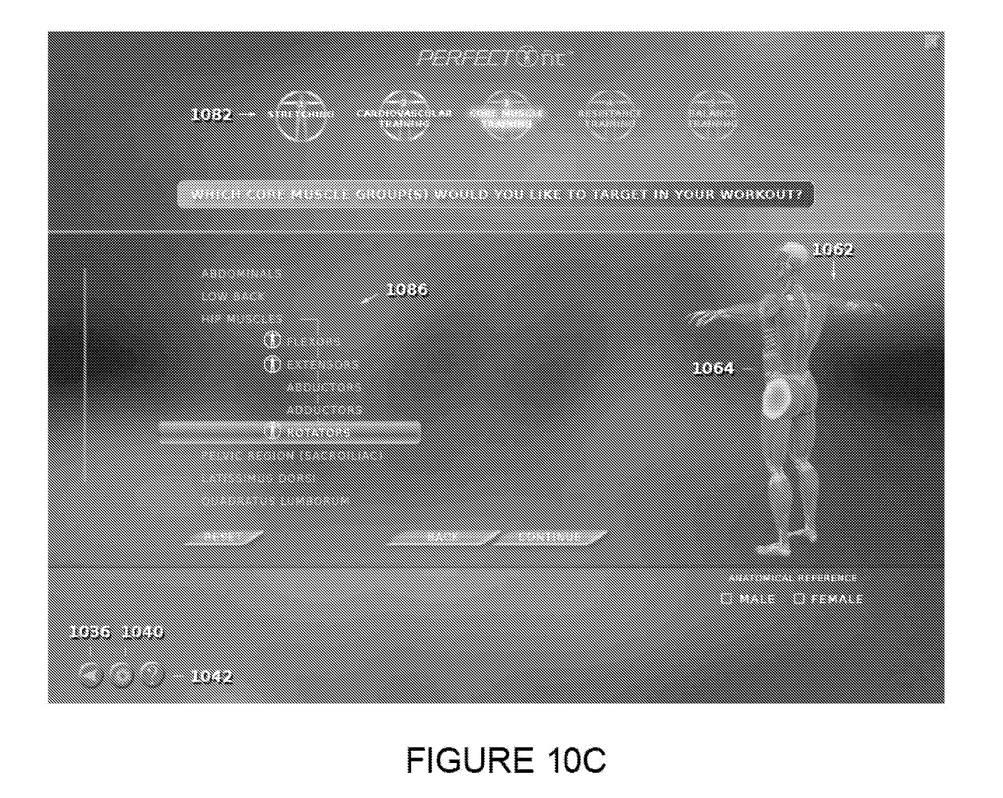

Once the user has selected a desired trainer 1026, the user may select a continue icon button 1044 on the display screen 1000, causing the exercise program 78 to save the settings and display a main menu screen that can be used to access various program functionality, including an interface for finding a particular exercise within the exercise object database 80, an interface for accessing a reference library containing information about the equipment and exercises within the database 80, an interface for opening any previously saved workouts, an interface for opening any messages received and/or stored by the exercise program 78, an interface for learning more about the exercise program 78, and an interface for taking a virtual tour of a health club facility to learn more about how to operate exercise equipment commonly found in a health club or gym. The main menu interface may further include an auto-design interface and a customization interface, which as described in greater detail below with respect to FIGS. 9 and 10, can be used to create a workout either automatically from a number of predetermined exercise routines suggested by the exercise program 78, or manually by the selection of exercise routines and associated exercise parameters within the exercise object database 80.

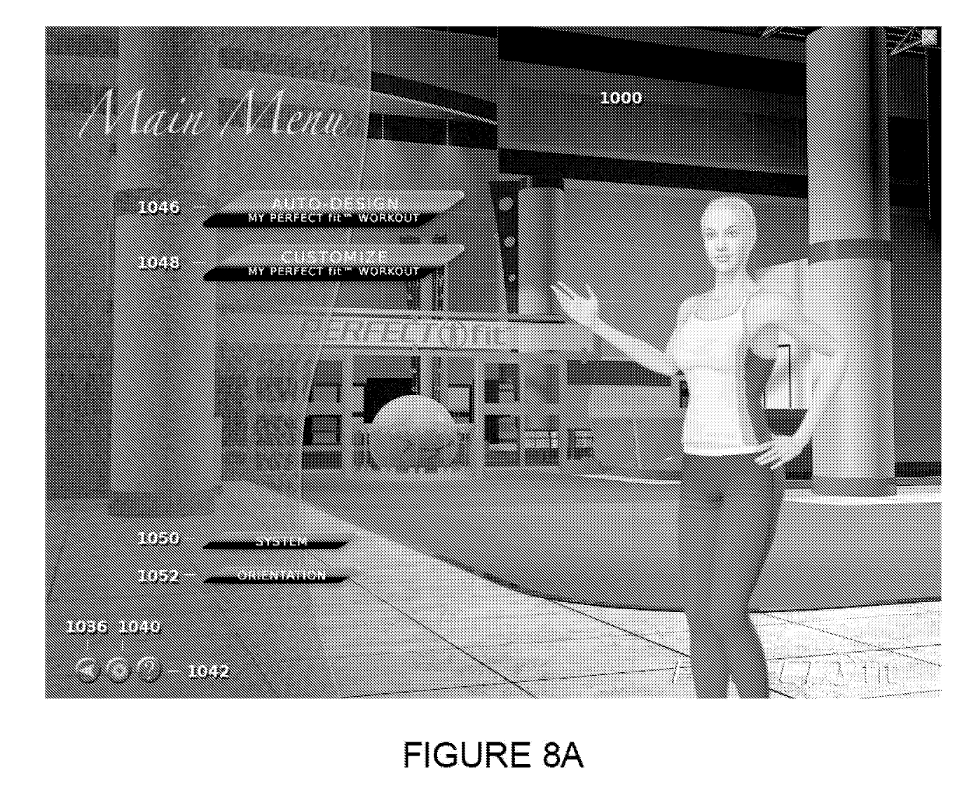

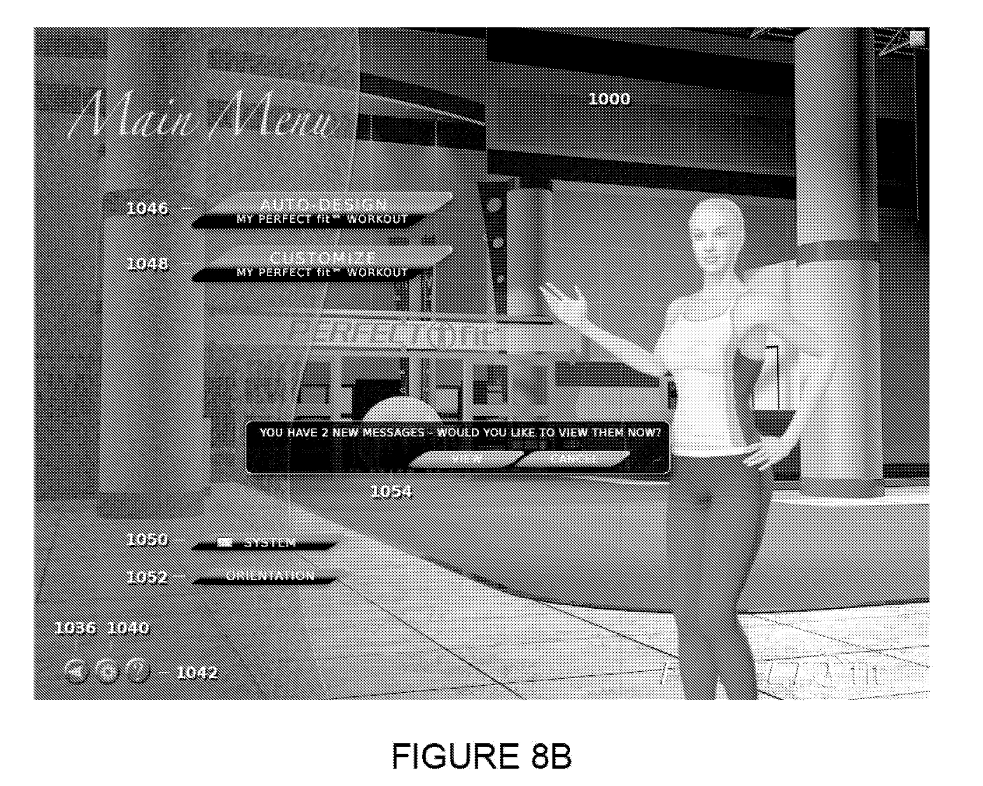

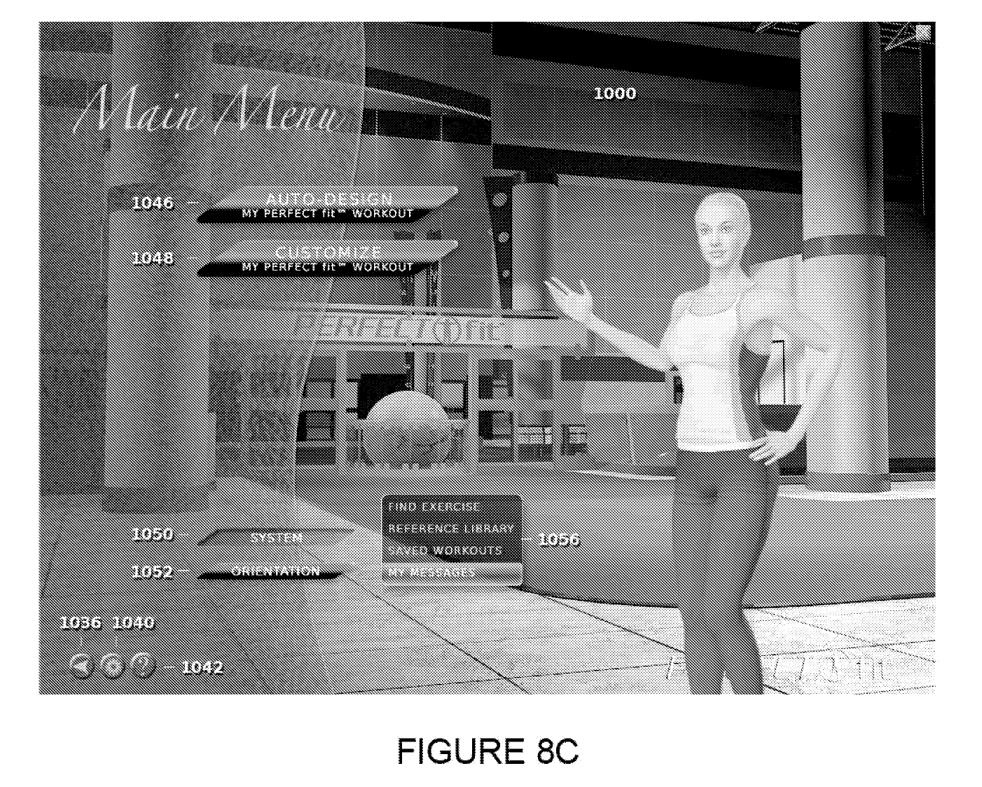

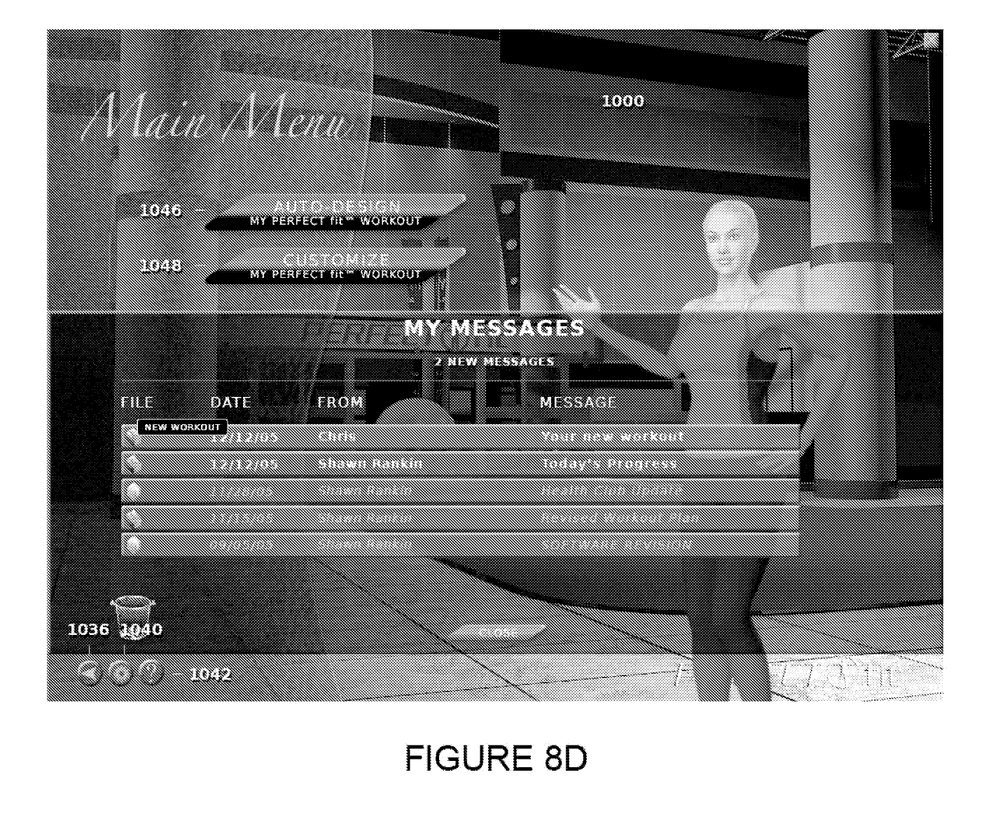

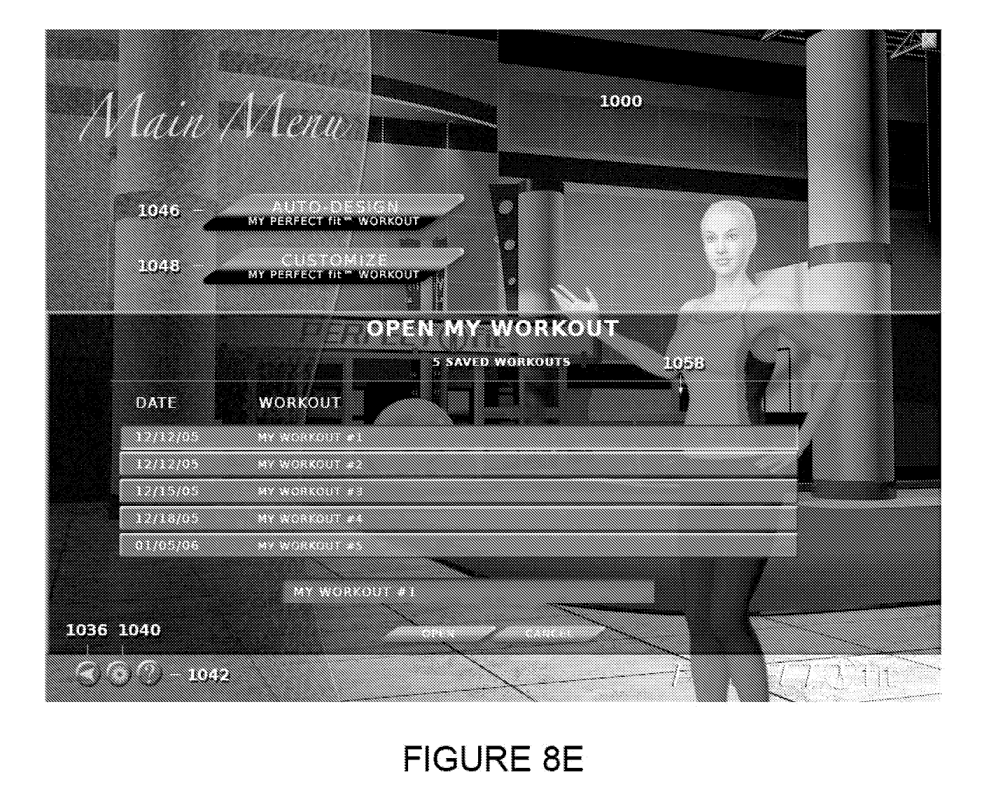

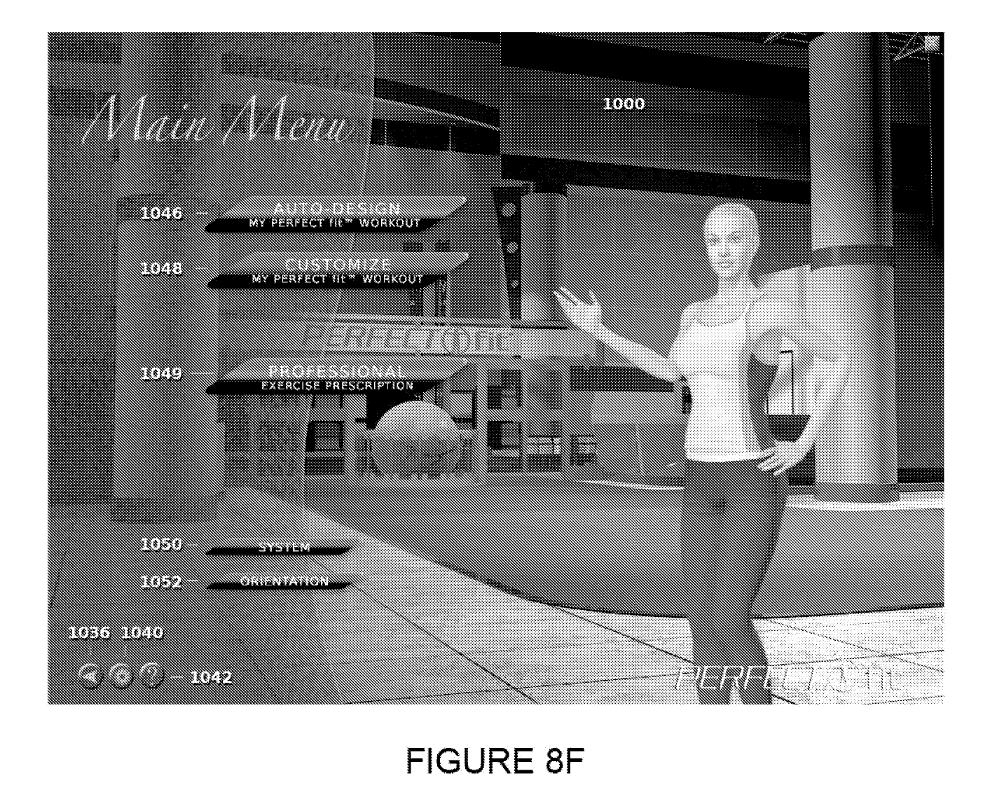

FIGS. 8A-8F are screen shots showing a main menu interface of the exercise program 78. When initiated, and as shown in a first screen shot in FIG. 8A, the exercise program 78 can be configured to display an auto design icon button 1046 that can be used to create an exercise workout automatically from a number of predetermined exercise routines suggested by the exercise program 78, and a customize icon button 1048 that can be used to create a customized workout based on exercise routines contained within the exercise object database 80. A system icon button 1050 on the display screen 1000, in turn, can be selected to gain access to other program features, including the interface for finding a particular exercise within the exercise object database 80, the interface for accessing the reference library, the interface for opening any previously saved workouts, and the interface for opening any messages received and/or stored by the exercise program 78. An orientation icon button 1052, in turn, can be selected to access the orientation interfaces for learning more about the exercise program 78 and to take a virtual tour of a health club facility.

Once the user has identified who they are upon entering the exercise program 78, the system will notify the user if any messages or program updates have been received. For example, and as shown in another screen shot depicted in FIG. 8B, the exercise program 78 can be configured to display a pop-up window 1054 notifying the user if any new messages have been received. If no new messages have been received but the user desires to view any previously stored messages, the user may select the system icon button 1050 on the display screen 1000, causing a another pop-up window 1056 to appear that can be used to access the messages, as shown, for example, in FIG. 8C. The user may then view any new or previously stored messages on the display screen 1000, as further shown, for example, in FIG. 8D.

From the pop-up window 1056 depicted in FIG. 8C, the user may also access any previously saved workout routines. As shown in the screen shot depicted in FIG. 8E, for example, selection of the “Saved Workouts” text from the pop-up menu 1056 causes the exercise program 78 to display a list 1058 of previously stored workouts that can be selected by the user. From this screen, the user can select a desired workout to run, or can revise one or more of the workouts by deleting, substituting or inserting new exercise routines or by changing the order of the exercise routines, as desired.

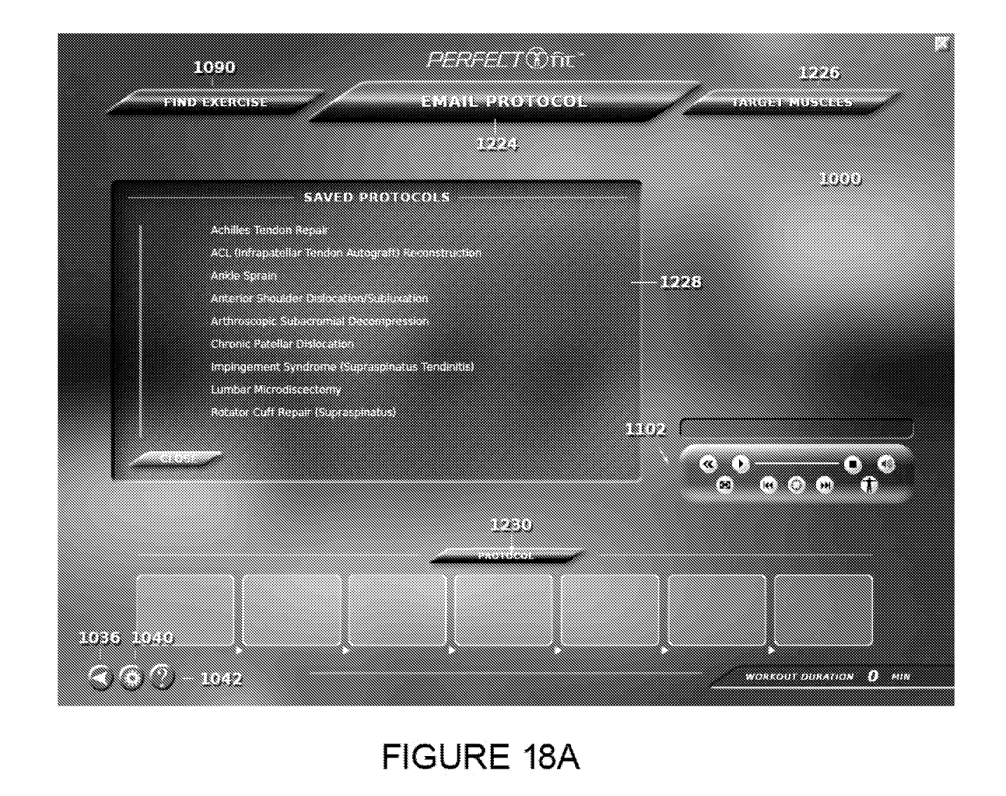

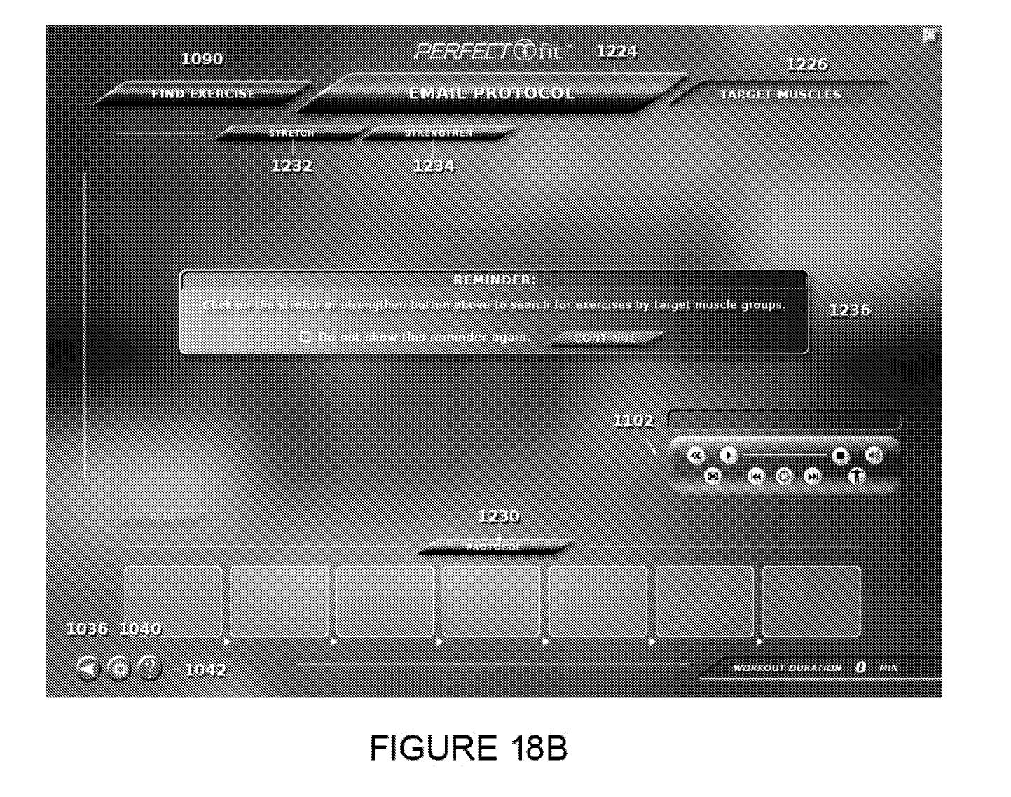

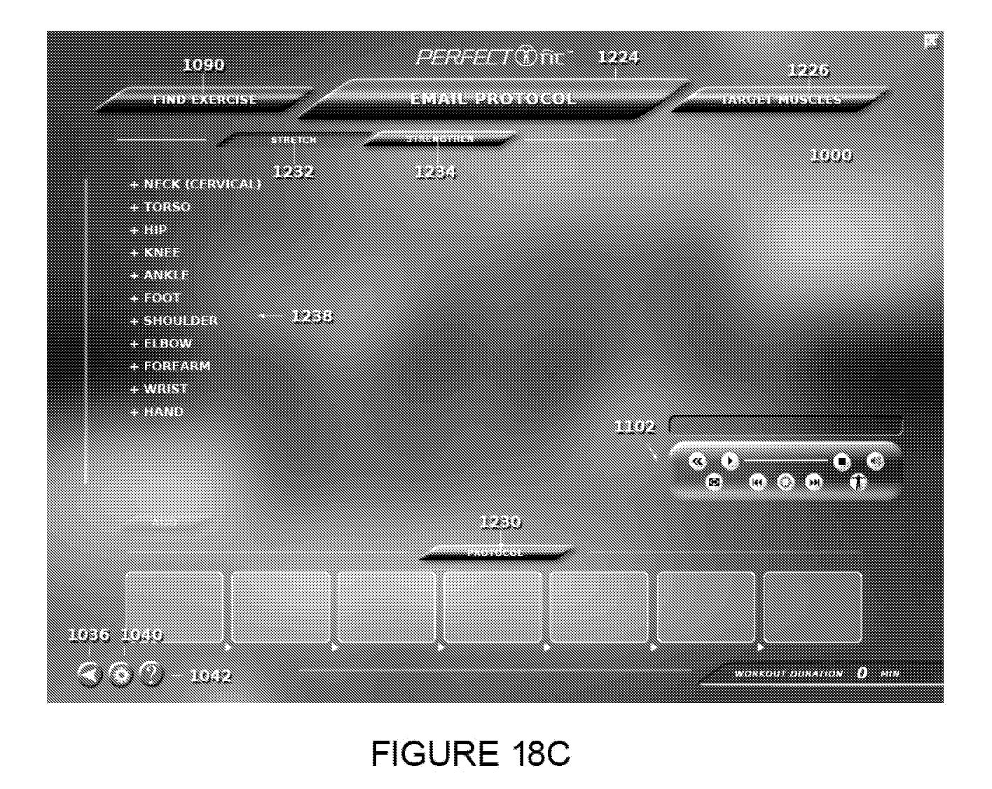

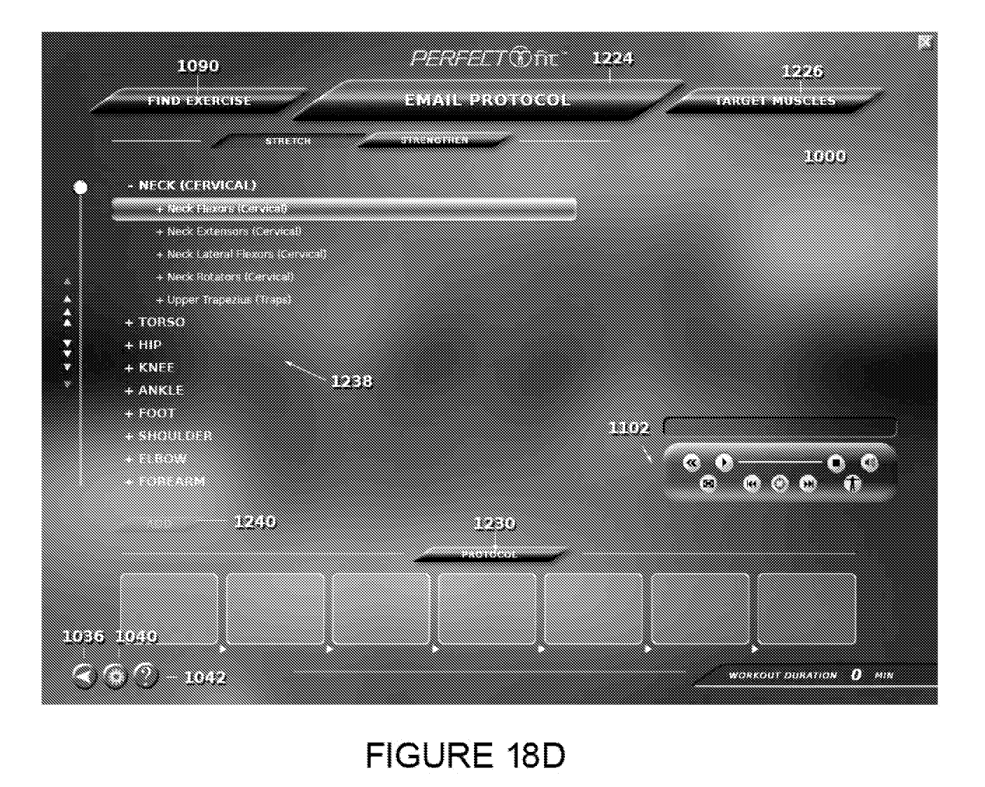

If the user selects icon box 1024 indicating that the user is a healthcare or fitness professional, the exercise program 78 can be configured to display another icon button 1049 that can be used to launch a professional exercise prescription interface. As discussed in greater detail below with respect to FIGS. 18A-18D, for example, the selection of icon button 1049 can cause the exercise program 78 to initiate an interface that can be used to create an exercise prescription that can be sent to one or more clients.

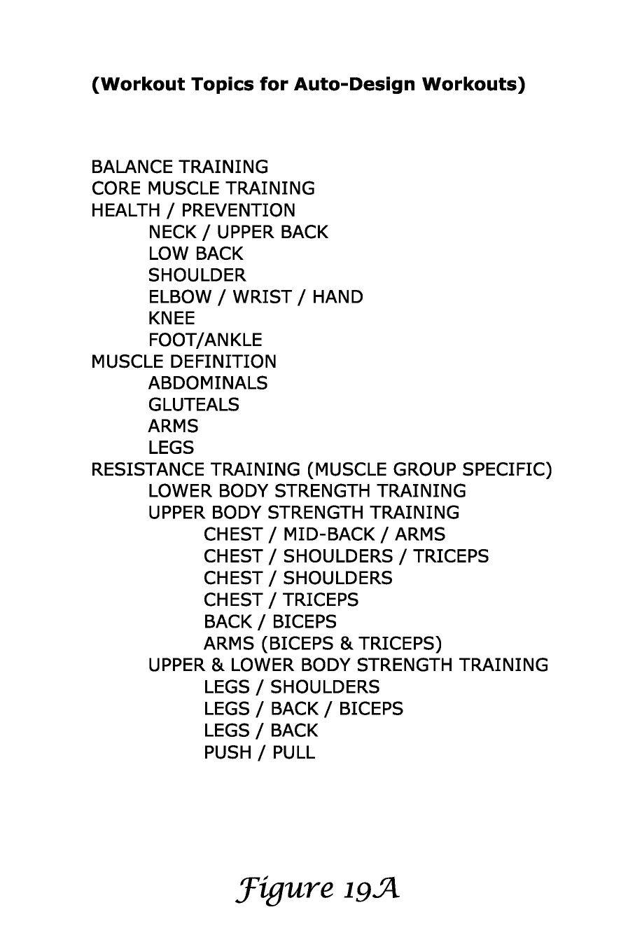

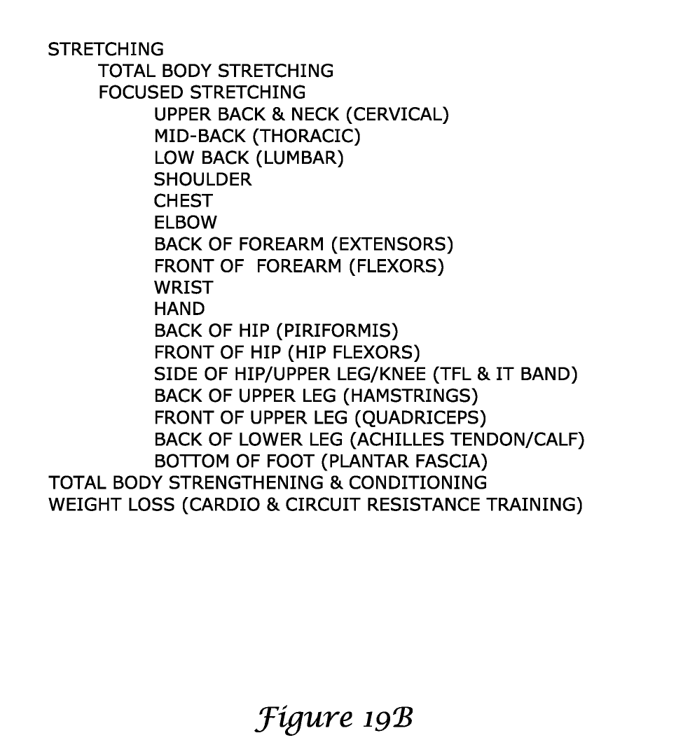

FIGS. 9A-9D are screen shots showing several illustrative steps of auto designing a workout using an auto design interface of the exercise program 78. When initiated, and as shown in a first screen shot in FIG. 9A, the exercise program 78 can be configured to provide a list of workout topics 1060 on the display screen 1000, which can then be selected by the user to focus the workout on a particular topic or topics. Selection of each workout topic by the user may prompt the exercise program 78 to display more information for each workout topic. As shown further in FIG. 9B, for example, selection of a “Muscle Definition” workout topic by the user can cause the exercise program 78 to display a list of subtopics (e.g., abdominals, gluteals, arms, or legs) that can be further selected by the user to further focus the workout on a particular muscle group or groups. An illustrative list of workout topics and subtopics that can be selected for use in creating an auto-design workout is shown in FIGS. 19A-19B.

In some embodiments, an anatomical FIG. 1062 can be provided on the display screen 1000 indicating the current topic and subtopic selected. For example, and as shown in FIG. 9B, selection of the muscle definition, abdominals topic/subtopic may cause the exercise program 78 to display an anatomic FIG. 1062 with the abdominal region 1064 highlighted and/or flashing to indicate the particular muscle group selected. If desired, the user may also use the anatomical FIG. 1062 to learn more about particular muscle groups by moving the pointer over the desired area of the anatomical FIG. 1062.

Once the user has selected the desired topics and subtopics to be associated with the workout, the exercise program 78 may next prompt the user to select the type of equipment to be used during the workout. In some embodiments, and as shown in FIG. 9C, for example, the exercise program 78 can be configured to prompt the user to select from a list 1066 of workout environments and/or equipment options, including a health club, a home gym, or no equipment. Selection of the health club option, for example, may cause the exercise program 78 to select pre-determined workouts that include various types of exercise equipment commonly found in many professional health clubs. Selection of the home gym option, in turn, may cause the exercise program 78 to select pre-determined workouts that include exercise equipment commonly found in a home gym. Selection of these options may also permit the user to view and select their own exercise equipment commonly found in health club and home gym environments using the exercise object database 80.

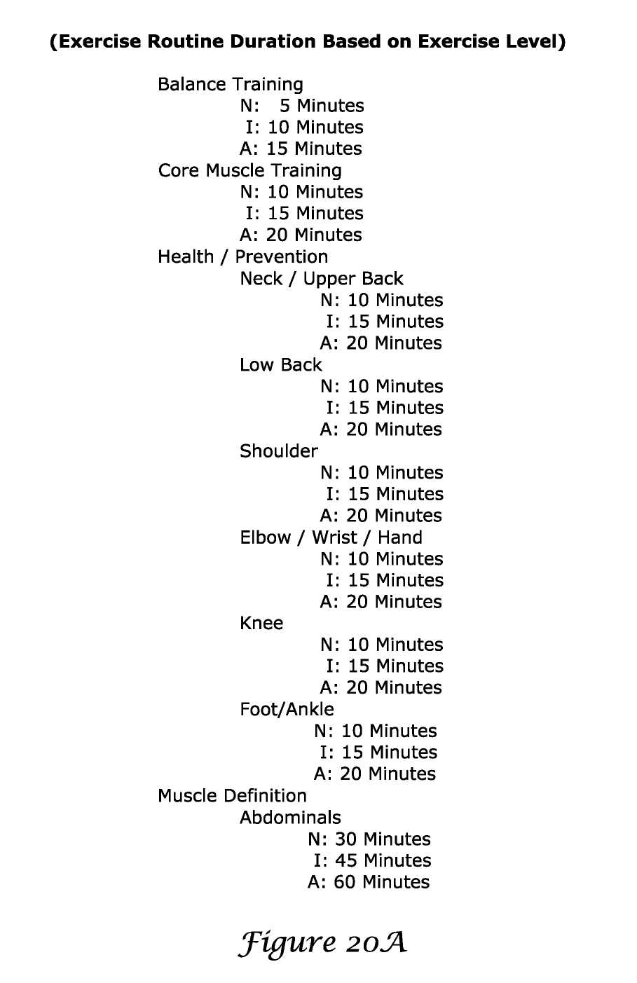

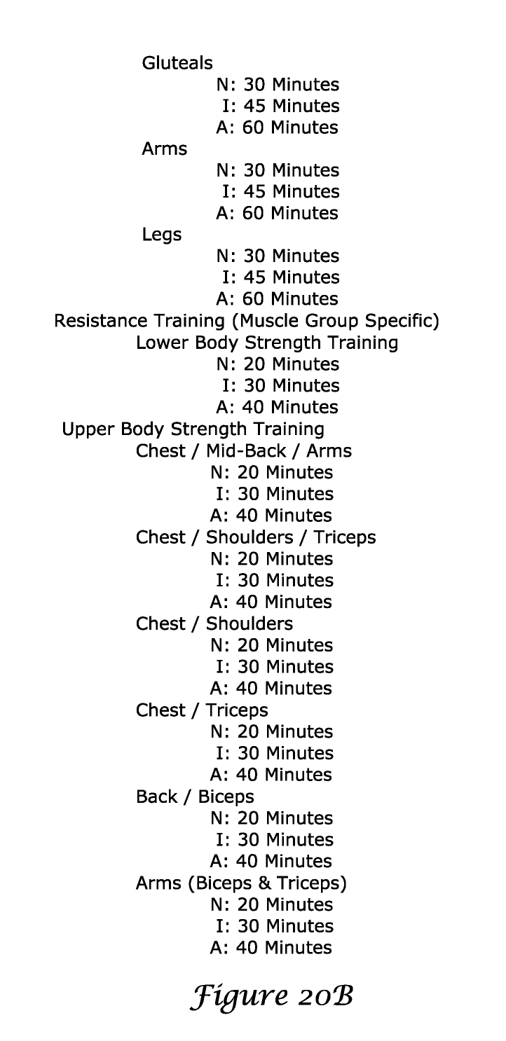

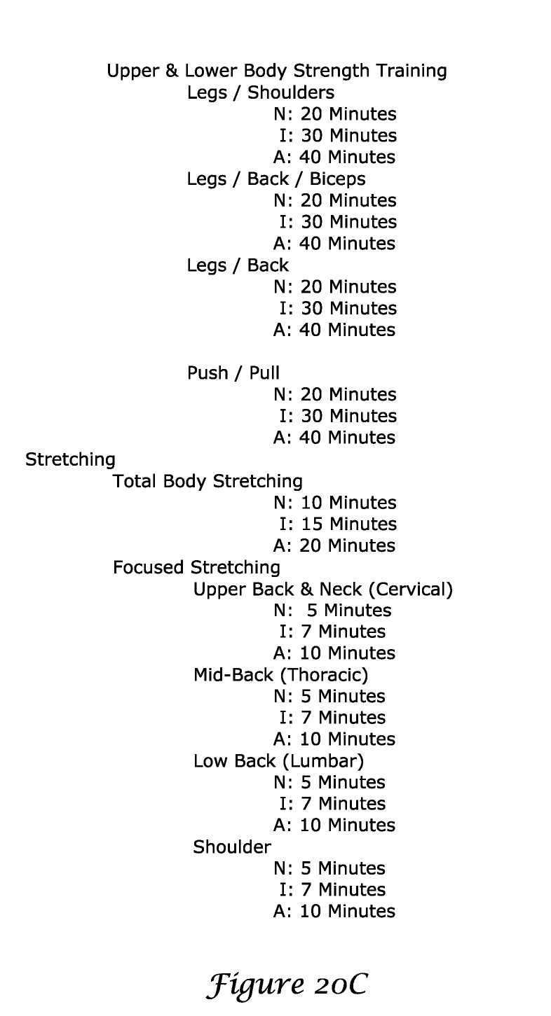

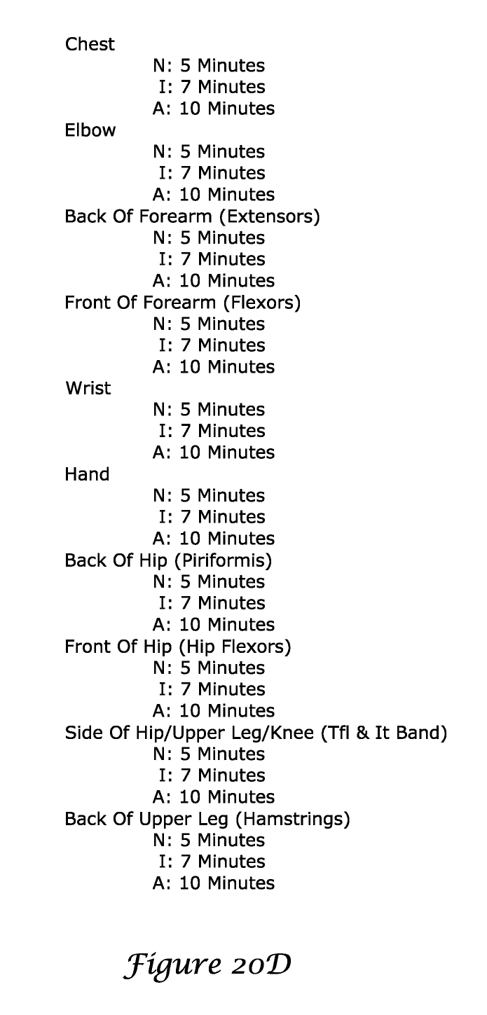

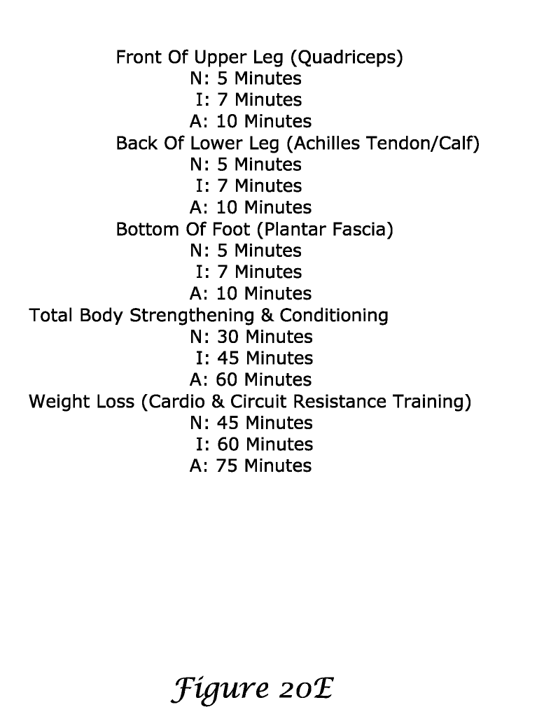

Once the user has selected the workout environment and/or equipment to be used, the exercise program 78 may next prompt the user to select the general exercise level desired. As further shown in FIG. 9D, for example, the exercise program 78 can be configured to provide a novice icon button 1068 for novice users, an intermediate icon button 1070 for intermediate users, and an advanced icon button 1072 for advanced users. A list of conditions 1074 for each level can be provided on the display screen 1000 to facilitate selection of the appropriate workout level. In use, the duration of the exercise routines can be varied by the exercise program 78 based in part on the workout level selected via the icon buttons 1068,1070,1072, allowing the program 78 to adjust for the user's level of fitness. An illustrative list of exercise routine durations based on exercise level and workout focus is shown in FIGS. 20A-20E.

Once the user has selected the desired exercise level on the display screen 1000, the user may then select a review icon button 1076 on the display screen 1000 to review the exercise routines automatically selected by the exercise program 78 based on the user's selection of workout topics and subtopics. Any pre-determined exercise routine that has been formulated using the auto-design interface can then be modified to better suit the user's ability level, equipment needs, and workout duration by deleting exercises, choosing alternative exercises, and/or finding and selecting new exercises using the exercise database.

FIGS. 10A-10C are screen shots showing several illustrative steps of designing a customized workout using a customization interface of the exercise program 78. When initiated, and as shown in a first screen shot in FIG. 10A, the exercise program 78 can be configured to display a list 1078 of exercise categories that can be utilized to build a customized workout. The exercise categories can include, for example, a stretching exercise category, a cardiovascular/aerobic training category, a core muscle training category, a resistance training category, and a balance training category. It should be understood, however, that other exercise categories can be provided.

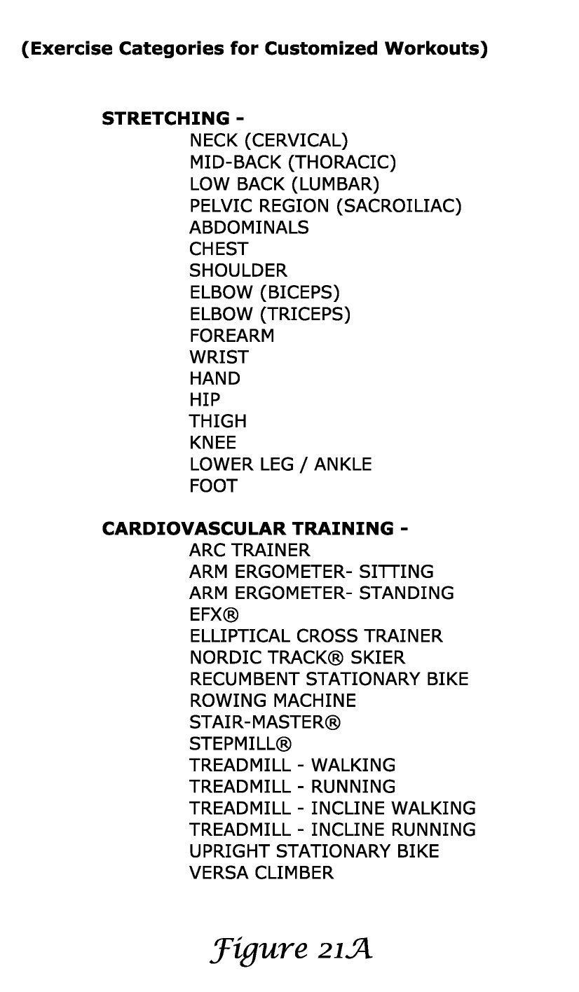

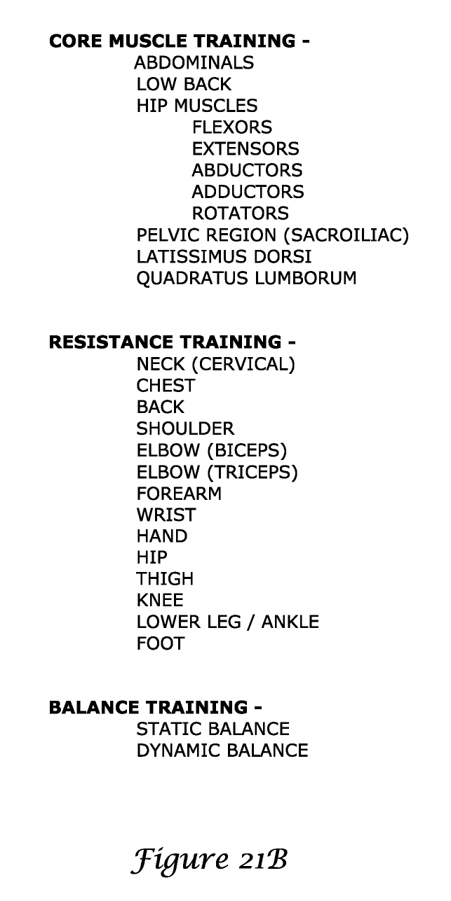

From the list 1078 of exercise categories depicted in FIG. 10A, the user may select the desired category or categories from the display screen 1000 in the general order in which the user desires to perform the exercise routines during the workout. If, for example, the user desires to perform exercises in all of the exercise categories displayed on FIG. 10A, the user may select each exercise category by double-clicking or dragging the exercise category into an exercise selection window 1080 on the display screen 1000. As shown in another screen shot in FIG. 10B, selection of each desired exercise category within the list 1078 causes the exercise program 78 to display a number of corresponding exercise category icons 1082 on the top of the display screen 1000, informing the user that the exercise category has been selected. An illustrative list of exercise categories and subcategories that can be selected for use in creating a customized workout is shown in FIGS. 21A-21B.

Once the user has placed each desired exercise category from the list 1078 of exercise categories into the exercise selection window 1080, the user may next select a continue icon button 1084 on the display screen 1000, causing the exercise program 78 to prompt the user to choose the particular body region(s) and/or exercise equipment to be associated with each exercise category. As shown in another screen shot in FIG. 10C, for example, if the “Core Muscle Training” category is selected from the exercise category icon buttons 1082, the exercise program 78 can be configured to provide a list 1086 of body regions prompting the user to select the particular body region or regions to be associated with the “Core Muscle Training” category. If, for example, the user desires to focus on the hip muscles of the body, the user may select the appropriate text from the list 1086 of body regions, causing the exercise program 78 to display an anatomical FIG. 1062 highlighting the hip region of the body. Depending on the particular muscle group selected, the exercise program 78 may further prompt the user to select from one or more subcategories pertaining to each muscle category, allowing the user to further focus on a particular muscle group or groups within the selected region, as further shown, for example, in FIG. 10C. A similar selection technique can then be used to select the body region(s) and/or or exercise equipment to be associated with the other exercise categories selected, as desired.

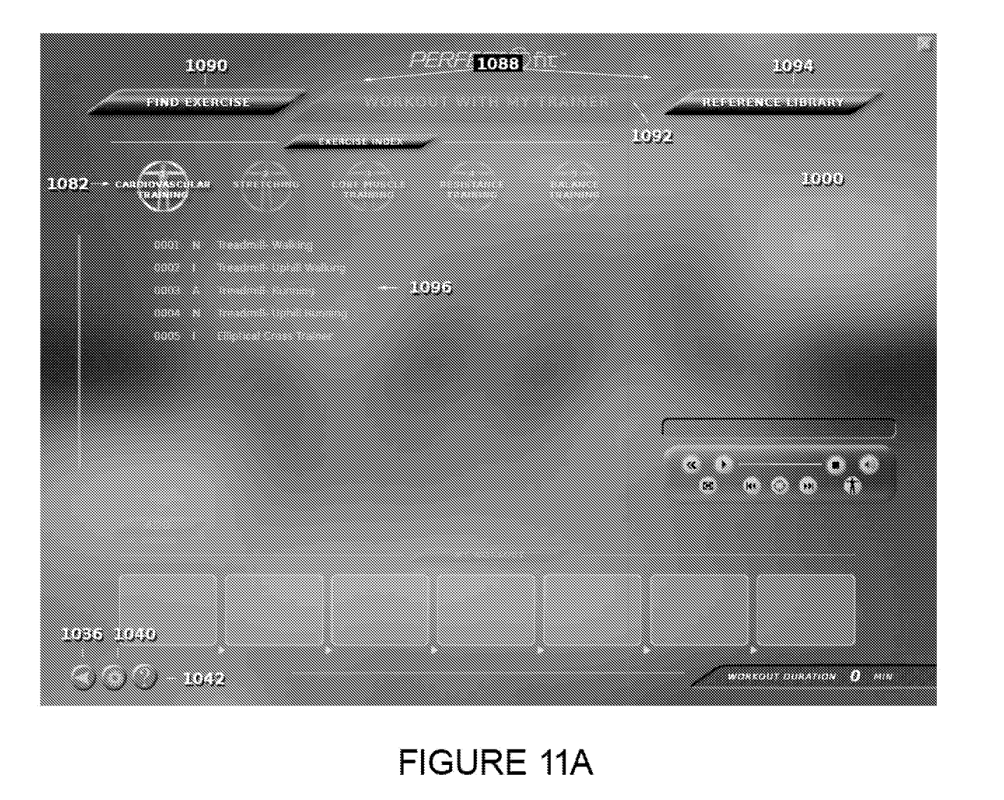

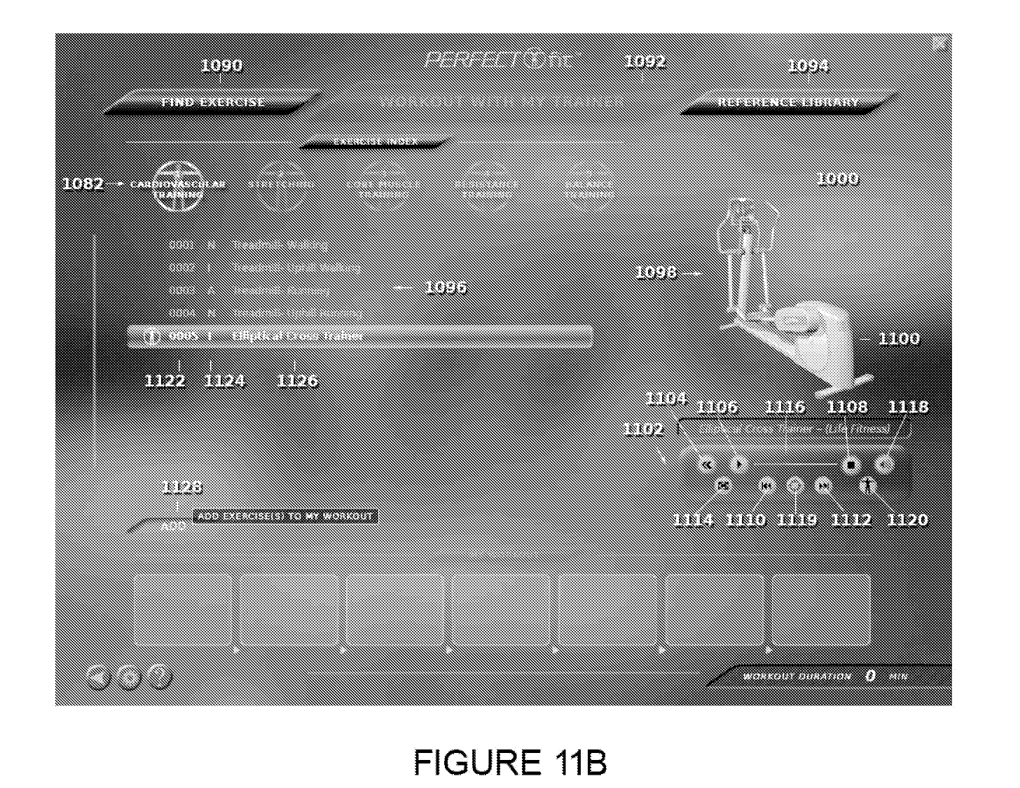

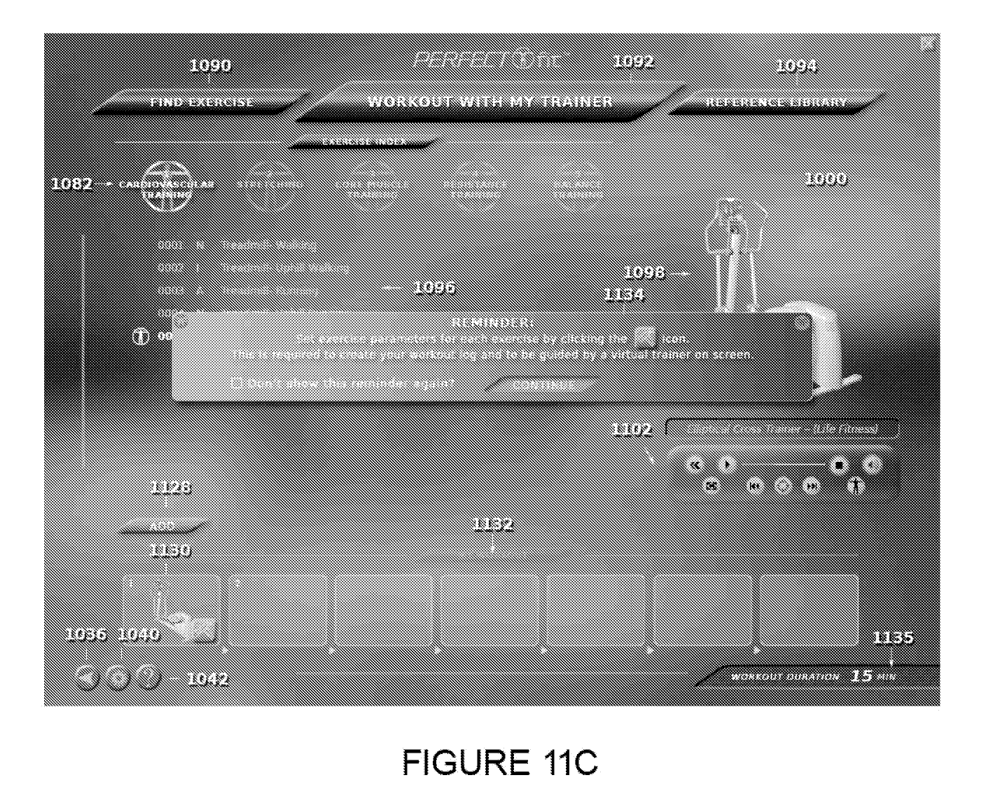

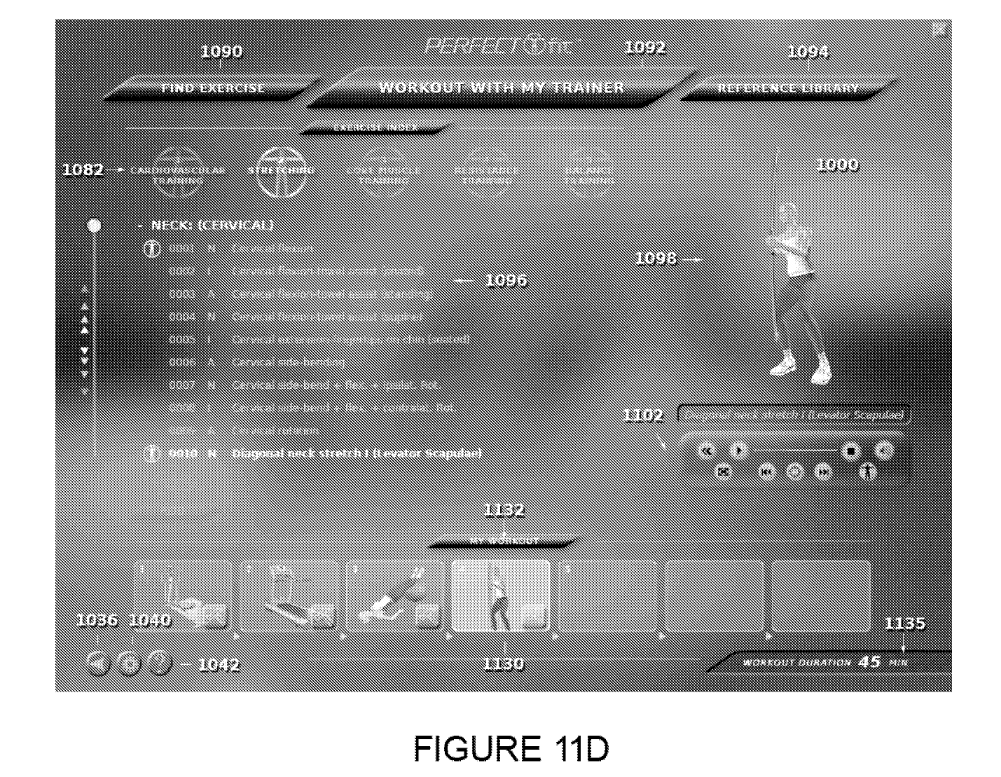

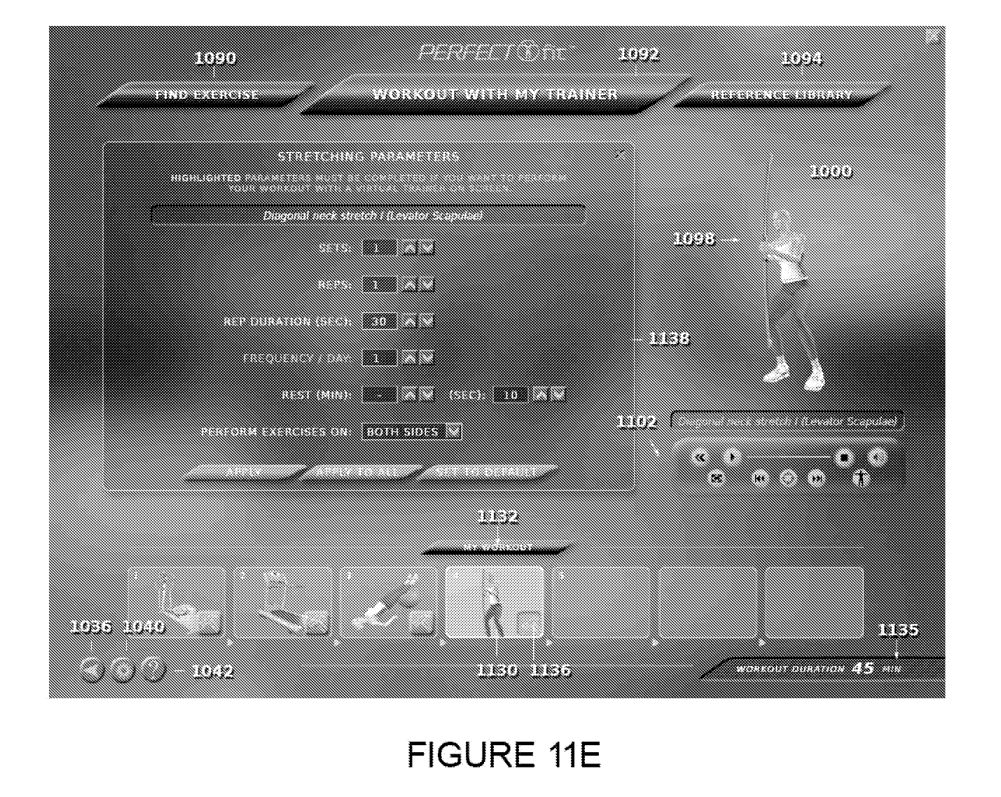

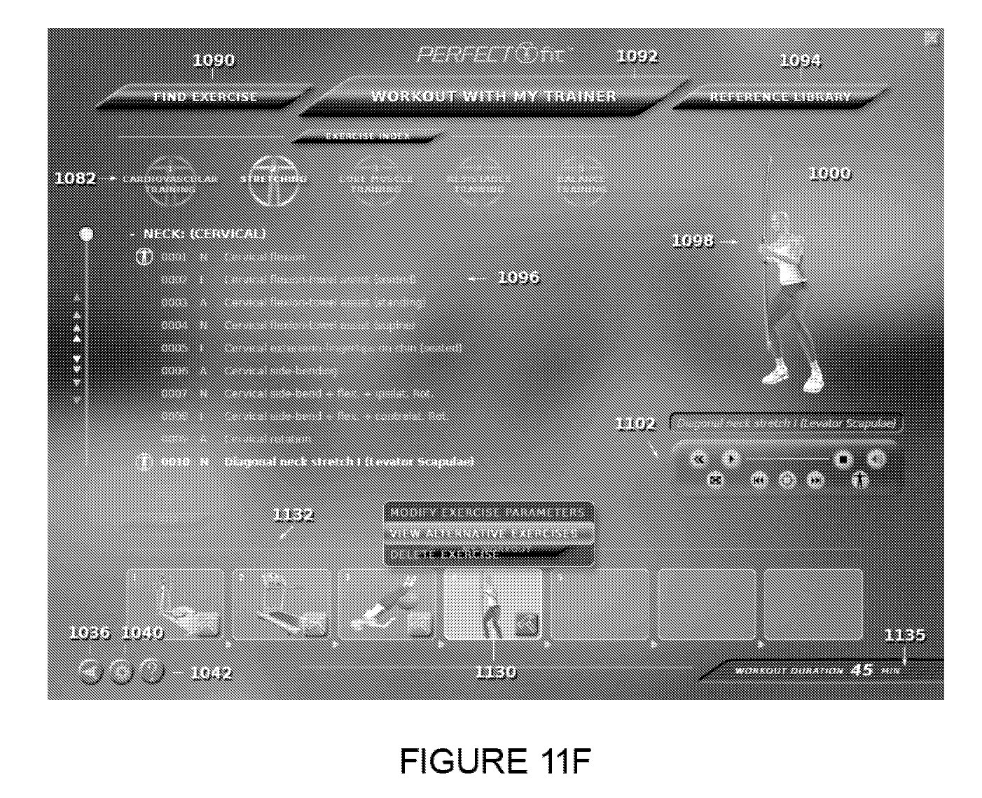

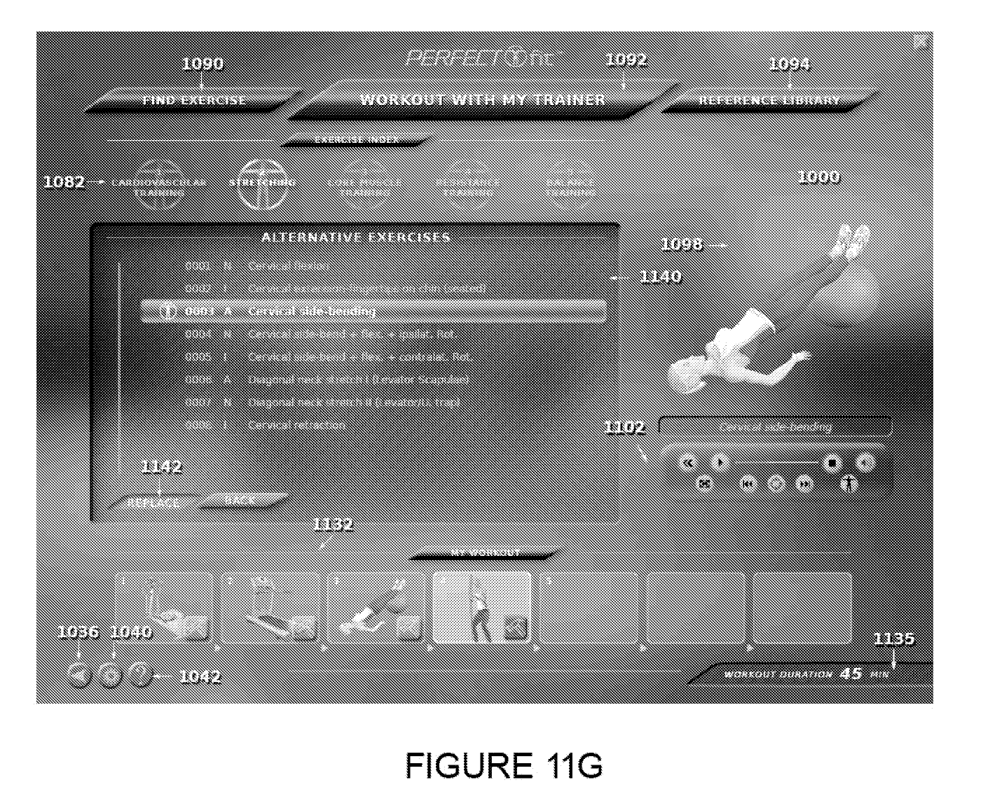

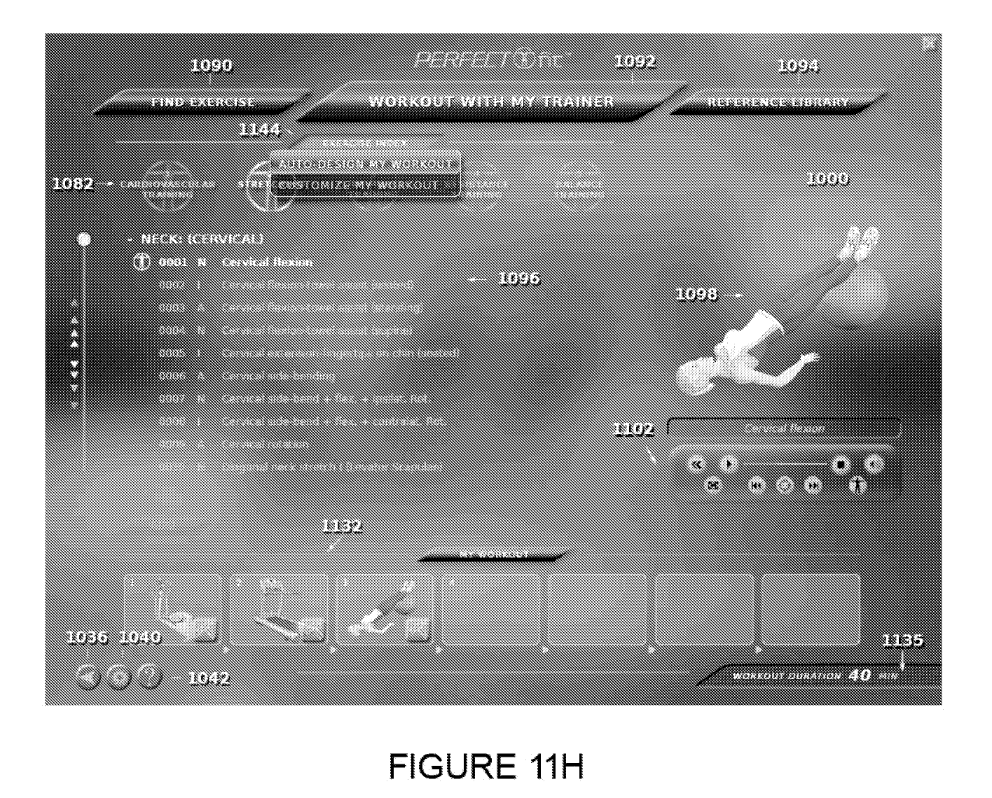

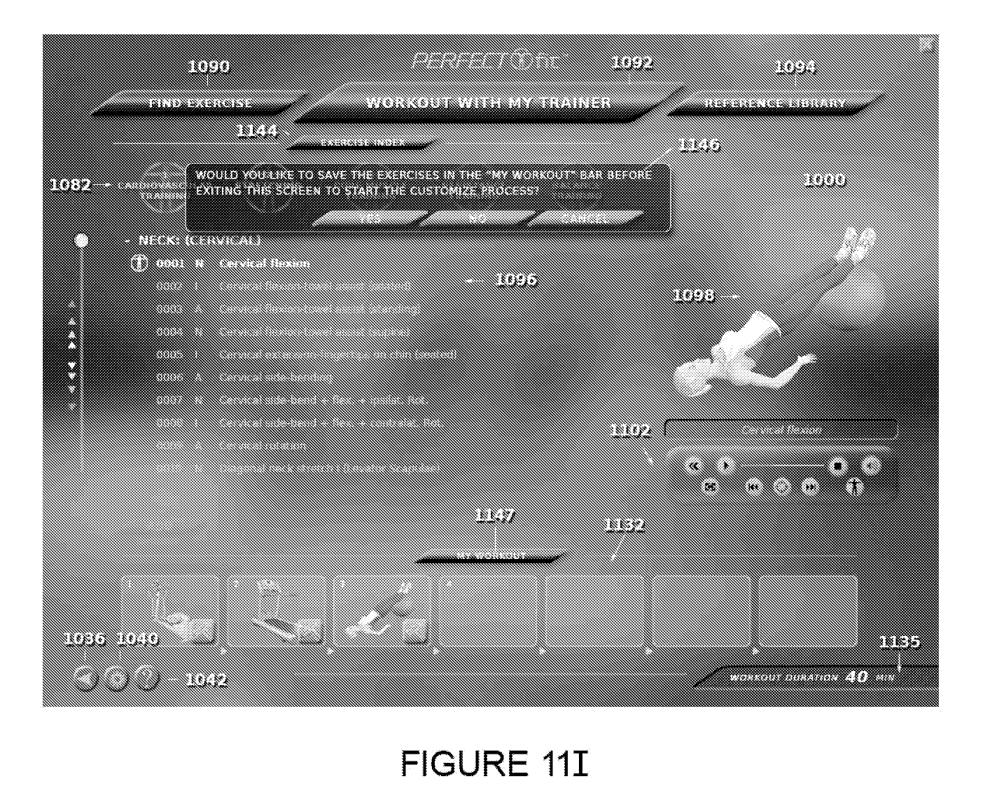

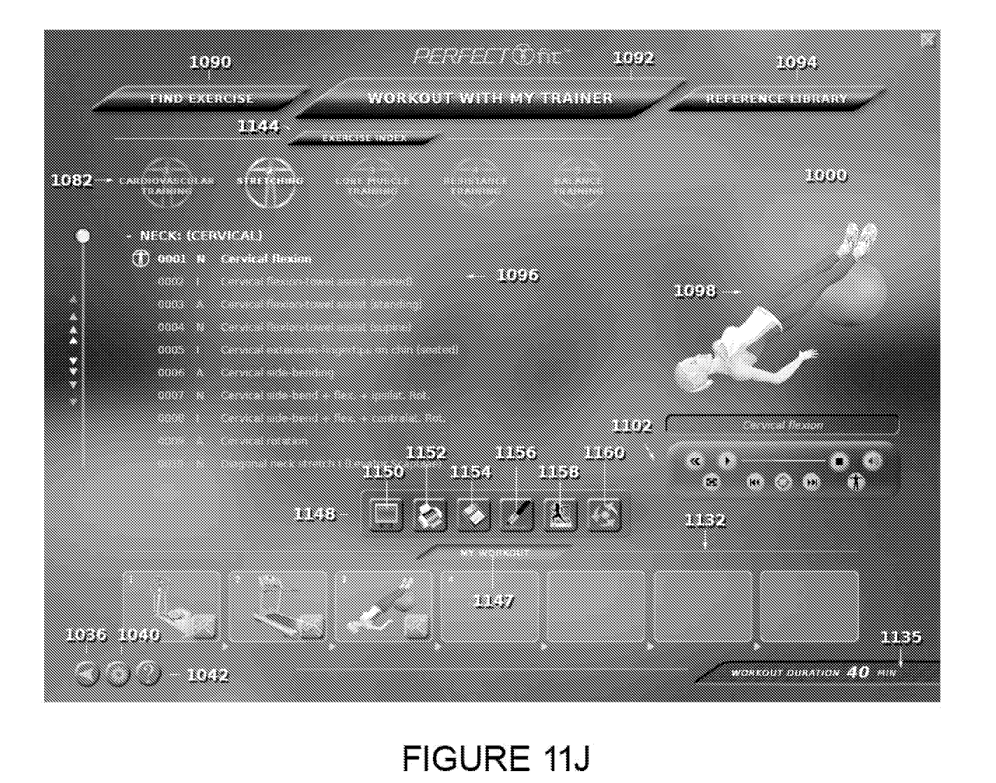

FIGS. 11A-11J are several illustrative screen shots showing the selection of the exercise routines using the exercise object database 80 of FIG. 5. When initiated, and as shown in a first screen shot in FIG. 11A, the exercise program 78 can be configured to display a navigation toolbar 1088 equipped with a find exercise icon button 1090 that can be used to select exercises by name and/or number, a workout icon button 1092 that can be used to perform a workout on-screen with the aid of a virtual trainer, and a reference library icon button 1094 that can be used to access the reference library interface to learn more information about a particular exercise and/or wellness topic.

An exercise index window 1096 on the display screen 1000 can be provided to permit the user to select from a list of exercises based on the exercise categories chosen from the auto-design or customization interfaces. A preview window 1098 on the display screen 1000, in turn, can be provided to permit the user to view or study the exercise before selection as a part of the workout. For example, and as shown in FIG. 11B, the preview window 1098 may display a 3-D graphical representation or model 1100 of the exercise or exercise equipment. With respect to at least some exercises, the 3-D graphical representation or model 1100 can be animated in real-time, showing the user the proper method in which to perform the exercise routine. Animation of the 3-D graphical representation or model 1100 can be accomplished by a gaming engine of the exercise program 78, which can be configured to display the full range of motion of the exercise routine on the display screen 1000.

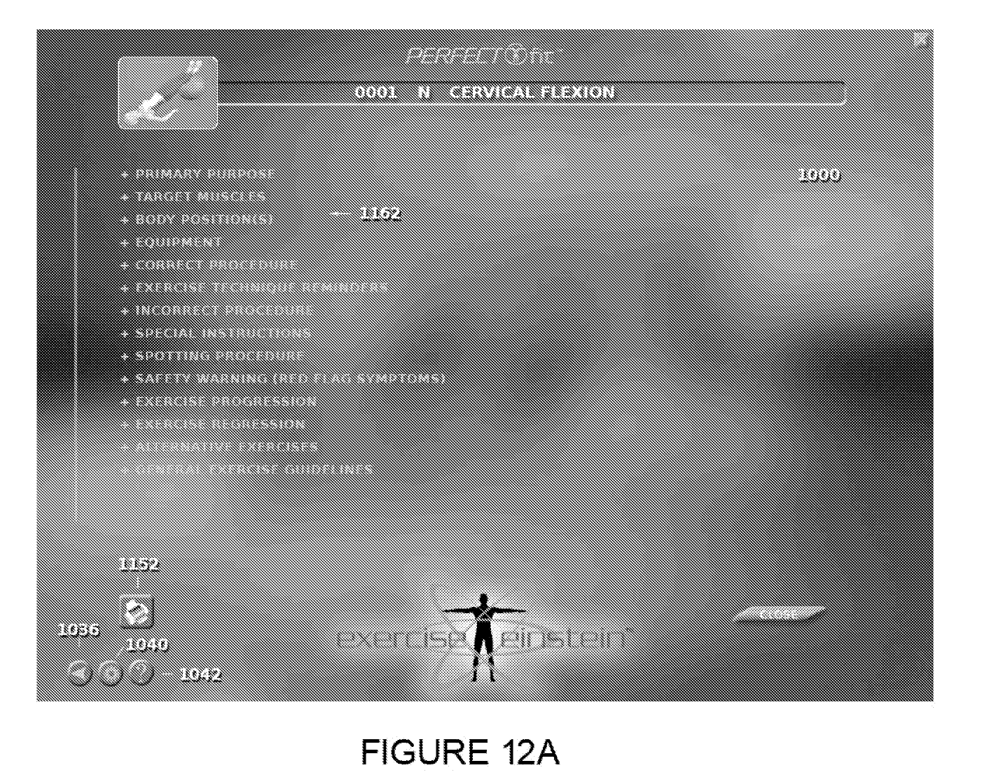

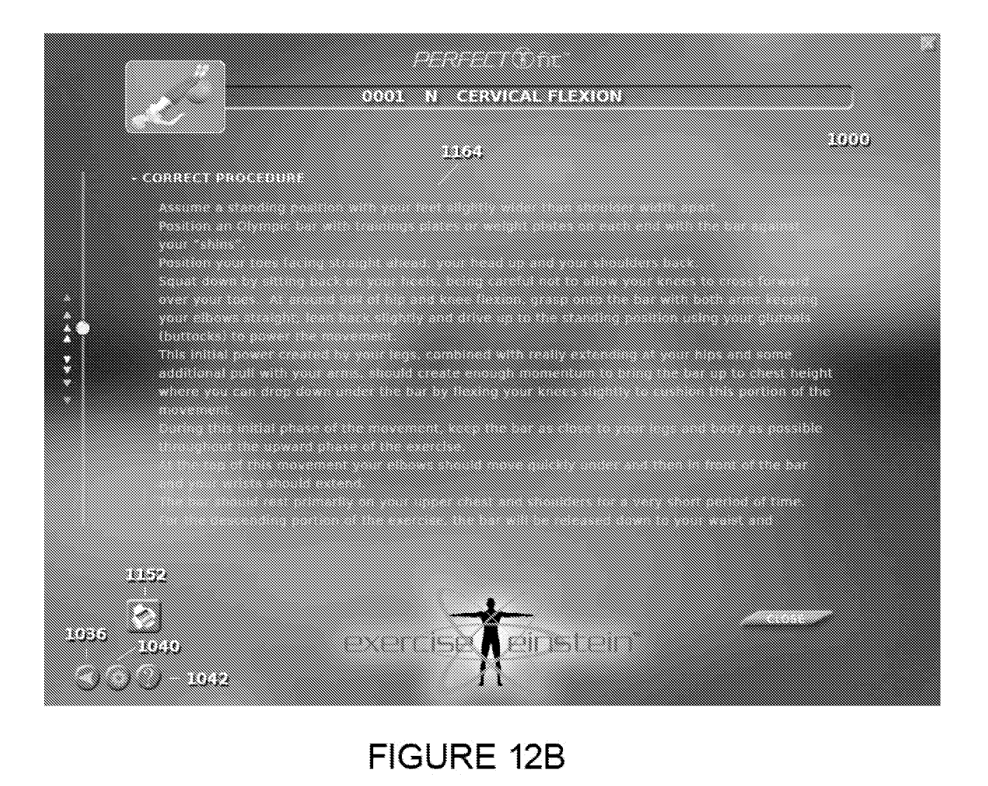

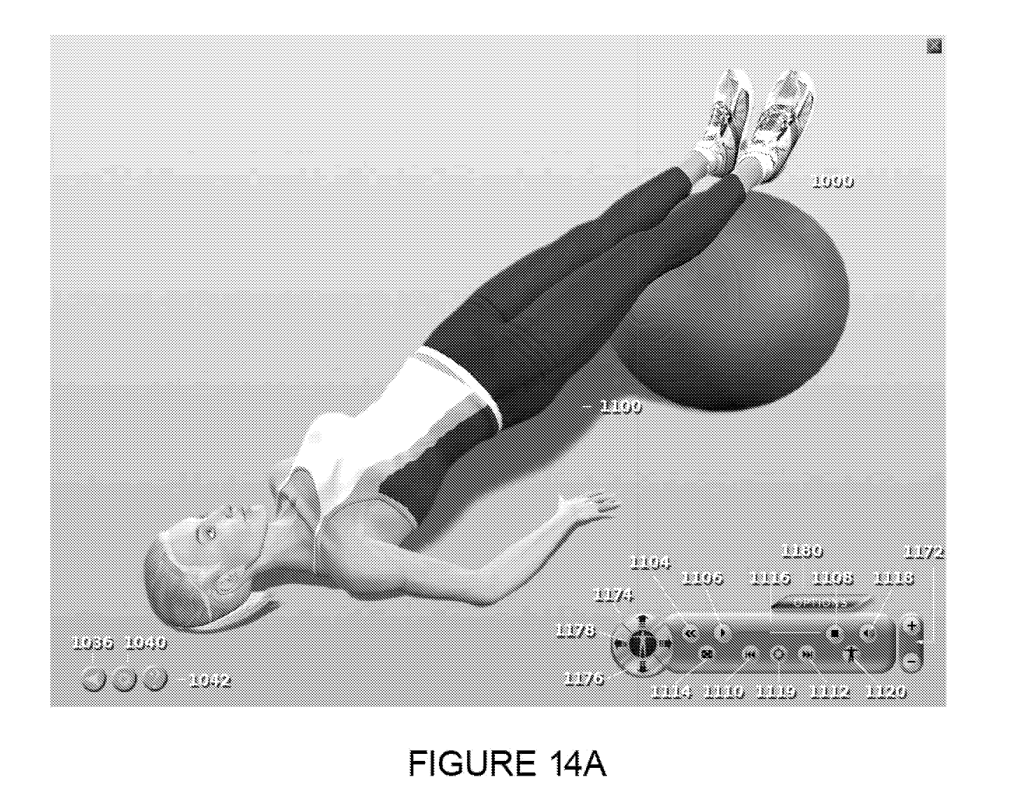

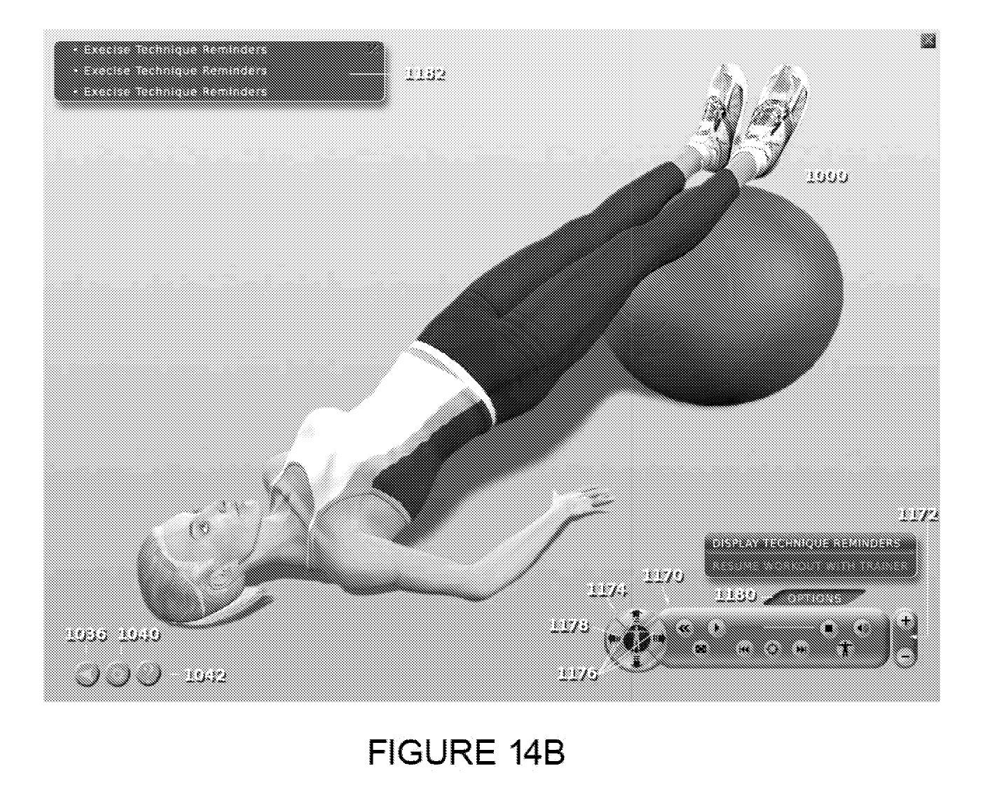

A set of remote control icon buttons 1102 located adjacent to the preview window 1098 can be provided to permit the user to control the exercise routine animation. The remote control icon buttons 1102 can include, for example, a slow motion icon button 1104, a play icon button 1106, and a stop icon button 1108. A rewind icon button 1110 may permit the user to return to the start of the exercise displayed in the preview window 1098 or, if double clicked, to view the previous exercise in the exercise database. A fast-forward icon button 1112 allows the user to advance forward to the next exercise in the exercise database. A full screen icon button 1114 can be utilized to view the animation in a full-screen mode where the exercise can be viewed in real-time, as further discussed below with respect to FIGS. 14A-14B. A timeline viewer 1116 can be provided to show the length of the animation. A sound icon button 1118 can be used to toggle the sound for the animation on or off, as desired. A target muscles icon button 1119 can be used to select targeted muscles in the exercise routine. As discussed below with respect to FIGS. 12A-12B, an information icon button 1120 can be selected to view more specific information about the particular exercise routine, if desired.

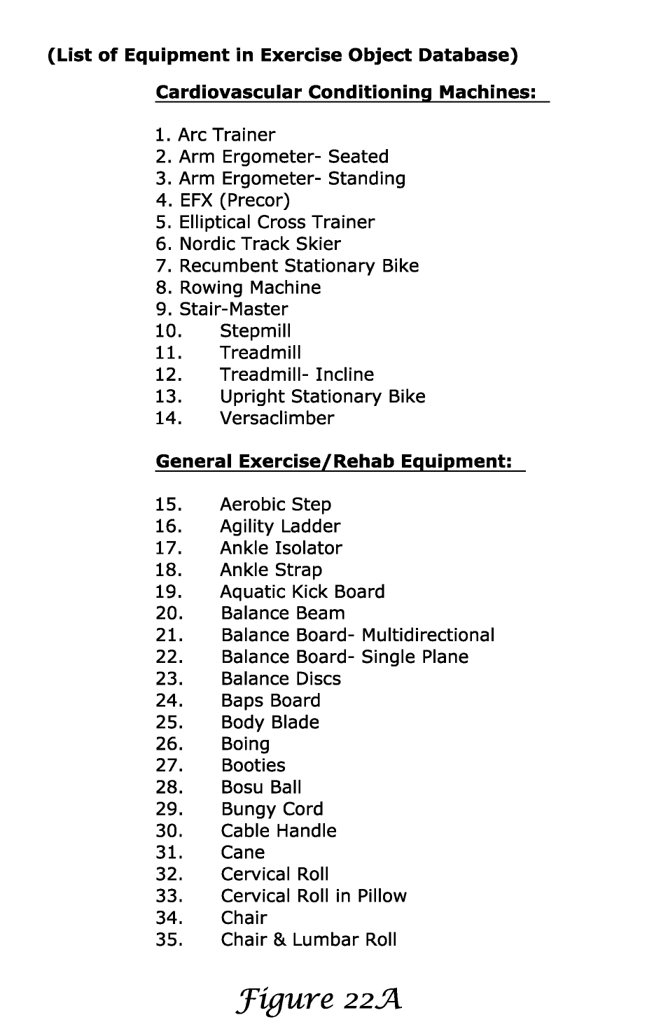

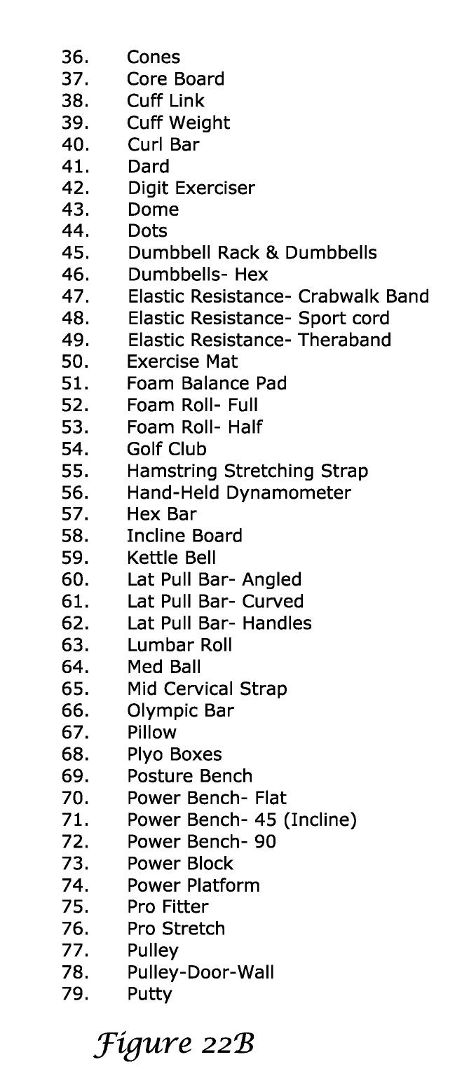

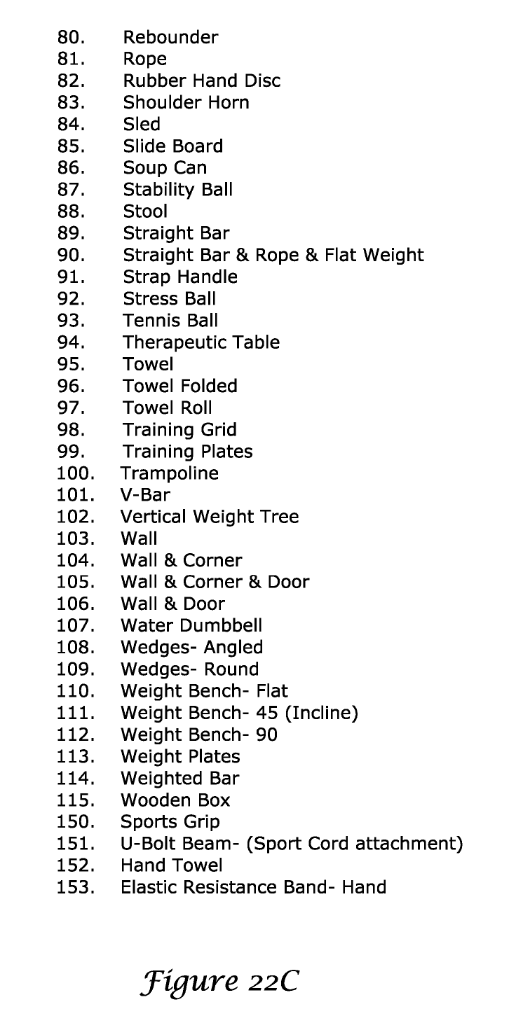

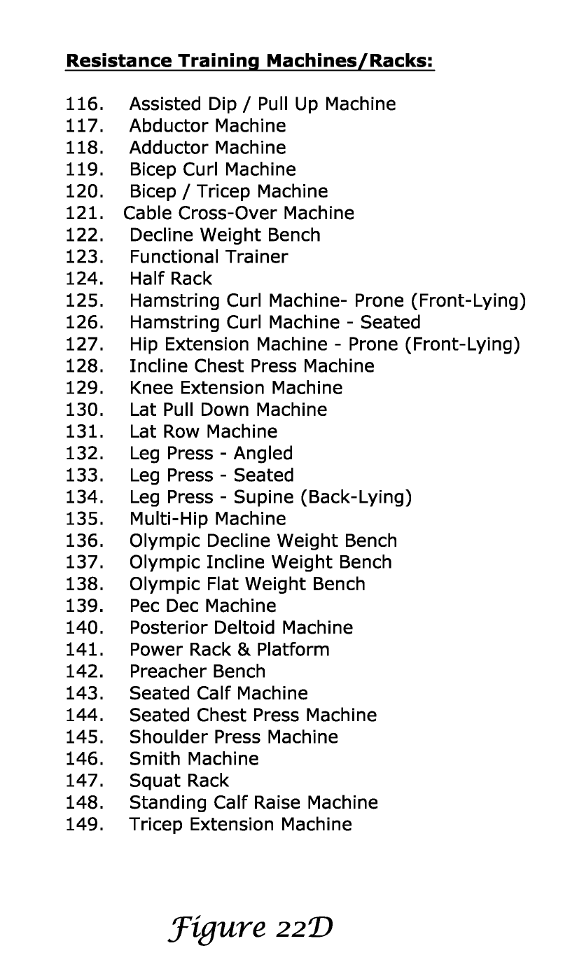

To select exercises within each exercise category, the user may select the desired exercise category icon 1082 on the display screen 1000, causing the exercise program 78 to display a list of possible exercises and/or exercise equipment for that exercise category within the exercise index window 1096. As shown in FIG. 11B, for example, selection of the “Cardiovascular Training” exercise category icon on the display screen 1000 can cause the exercise program 78 to display a list of exercise equipment that can be used for cardiovascular training. For each item listed, an asset number 1122, an exercise level 1124, and a brief description 1126 of the equipment and/or exercise can be displayed. An illustrative list of exercises and equipment that can be selected from each exercise category is shown in FIGS. 22A-22D.

To add exercise routines to the workout, the user may select the desired exercises from the list provided for each exercise category. As shown in FIG. 11B, for example, if the user desires to add an elliptical cross trainer as part of an exercise routine under the “Cardiovascular Training” exercise category, the user may select the appropriate item from the exercise index window 1096, causing the exercise program 78 to display that piece of exercise equipment in the preview window 1098. The user may then review the exercise within the preview window 1098 using the remote control icon buttons 1102, if desired.

Once the user has reviewed the selected exercise, the user may then select an add icon button 1128 on the display screen 1000, causing the exercise program 78 to add that particular exercise routine to the workout. As shown in another screen shot in FIG. 11C, for example, selection of exercise number “0005” (i.e., “Elliptical Cross Trainer-Life Fitness”) can cause the exercise program 78 to add that particular exercise routine as a thumbnail 1130 to a workout section 1132 on the lower portion of the display screen 1000. A dialog box 1134 may also be displayed reminding the user to input the exercise parameters to be associated with that particular exercise routine. The process of selecting exercises from the exercise categories can then be repeated one or more times to select other exercise routines to be performed during the workout. During this process, a workout duration status indicator 1135 can be provided on the display screen 1000 indicating the current duration of the workout based on the selected exercise routines displayed in the workout section 1132. The duration of the workout may depend on a number of factors, including the duration of each exercise routine, the number of repetitions performed for each exercise routine, the number of exercise routines performed, the fitness level selected by the user, as well as other factors.

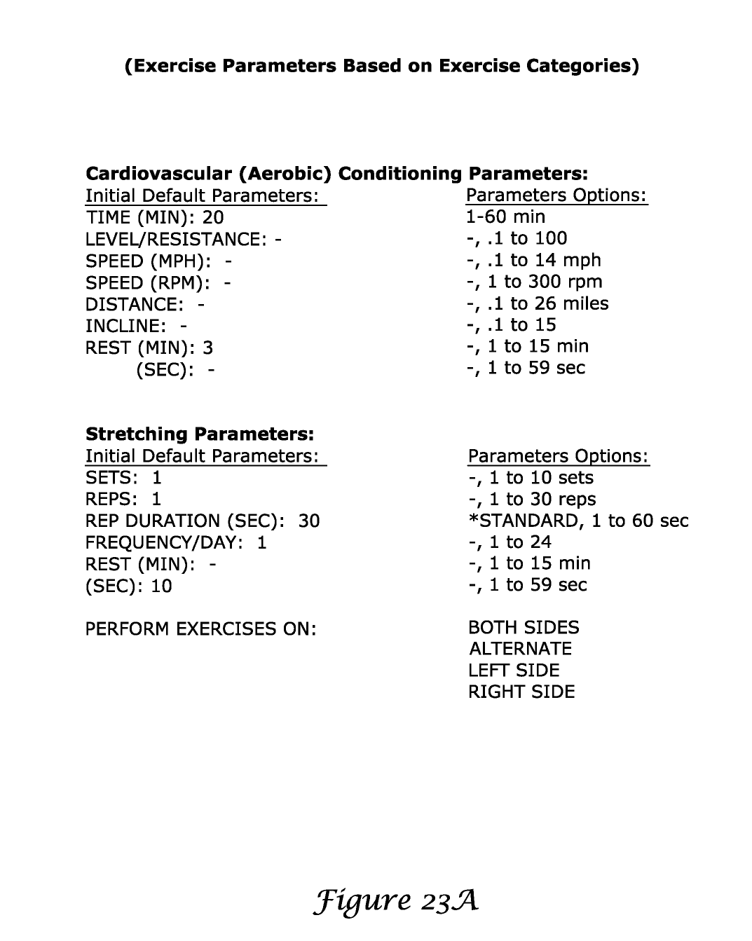

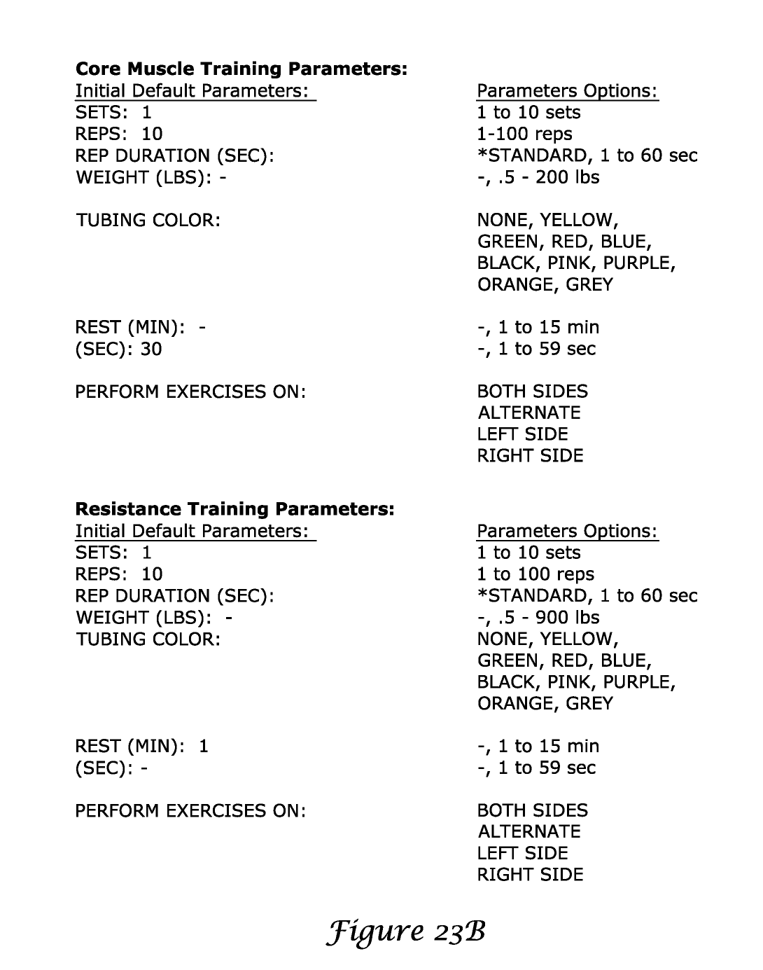

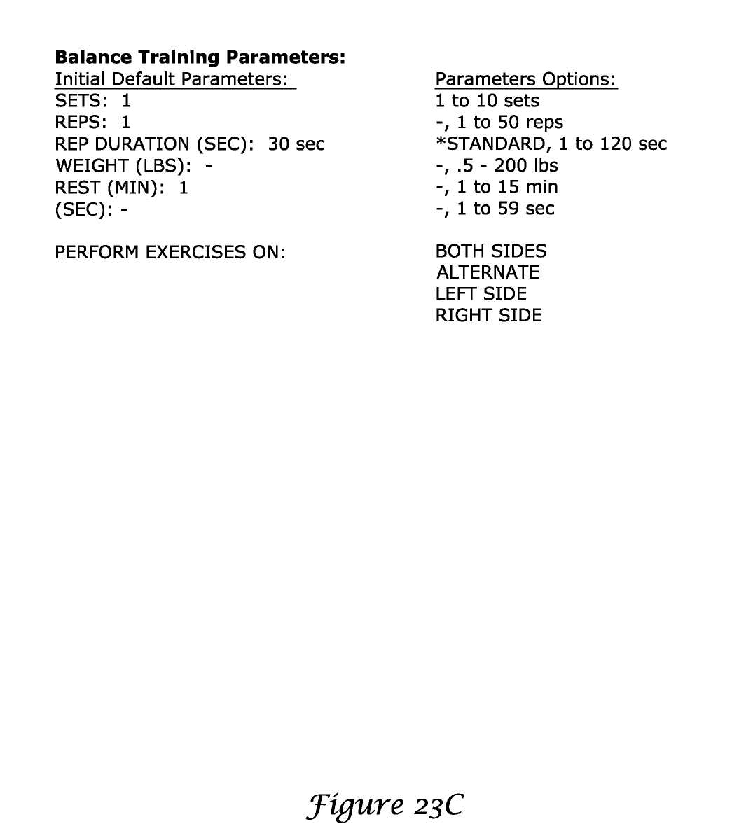

FIG. 11D is a screen shot showing the display screen 1000 after several different exercise routines have been selected from the list of exercises under each exercise category. As shown in FIG. 11D, once the user has added the various exercise routines to the workout, the user may configure the exercise parameters to be associated with each exercise routine. Configuration of the exercise parameters may occur, for example, by right clicking a desired exercise thumbnail 1130 from the workout section 1132 and then selecting the text “Modify Exercise Parameters” on the display screen 1000, causing the exercise program 78 to display a list of parameters to be configured for that particular exercise. Alternatively, or in addition, the exercise parameters may be configured by clicking on a hammer icon 1136 provided on each exercise thumbnail 1130. As shown in another screen shot in FIG. 11E, selection of the fourth exercise thumbnail 1130 in FIG. 11D causes the exercise program 78 to display a pop-up window 1138 containing a default list of stretching parameters that can be either accepted by the user or changed, as desired. An illustrative list of exercise parameters that can be associated with each exercise category is shown in FIGS. 23A-23C.

The exercise program 78 can be configured to provide the user with one or more alternative exercises that may be performed in addition to or in lieu of those exercise routines selected from the exercise index window 1096. The selection of alternative exercises to be performed for each exercise routine can be accomplished, for example, by right clicking the desired exercise thumbnail 1130 in the workout section 1132, and then selecting the text “View Alternative Exercises” on the display screen 1000, as shown, for example, in FIG. 11F. The exercise program 78 can then be configured to provide the user with a pop-up window 1140 containing a list of alternative exercises that can be performed for that exercise, as further shown, for example, in FIG. 11G. The user may then either add one or more alternative exercises to the workout, or replace the currently selected exercise routine with an alternative exercise routine by selecting a replace icon button 1142 on the display screen 1000. The user may also rearrange the ordering of the exercise routines within the workout, or may delete one or more exercise routines from the workout, as desired.

At any point while the user is selecting the desired exercise routines or reviewing a workout, the user may select the exercise index icon button 1144 on the display screen 1000, causing the exercise program 78 to initiate an option to return to the beginning of the auto-design interface or the customization interface, as further shown, for example, in FIG. 11H. Upon selecting either one of these workout development options, the exercise program 78 can be configured to display a pop-up window 1146 prompting the user to save the current exercise routines configured within the workout section 1132, as further shown, for example, in FIG. 11I.

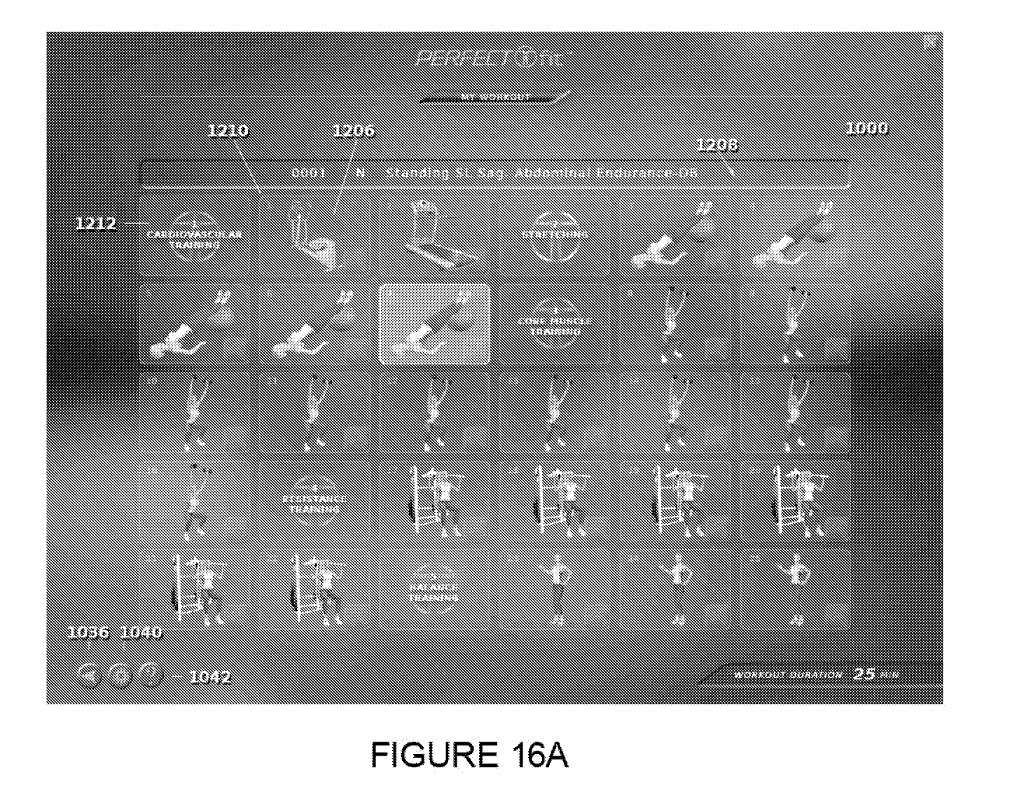

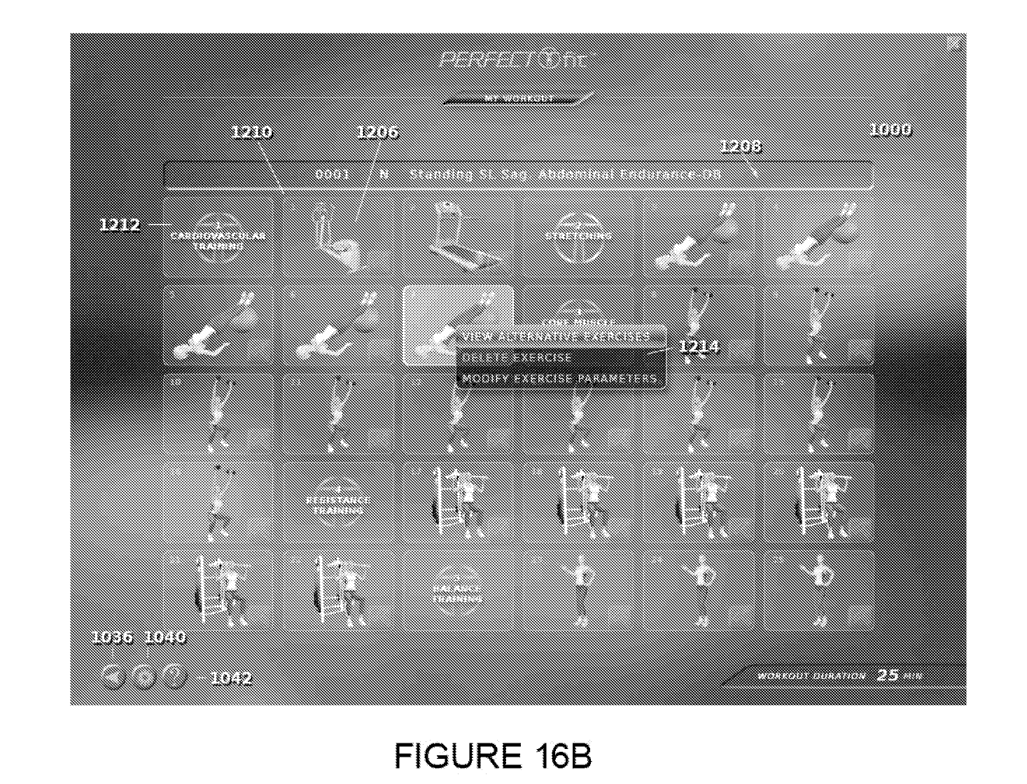

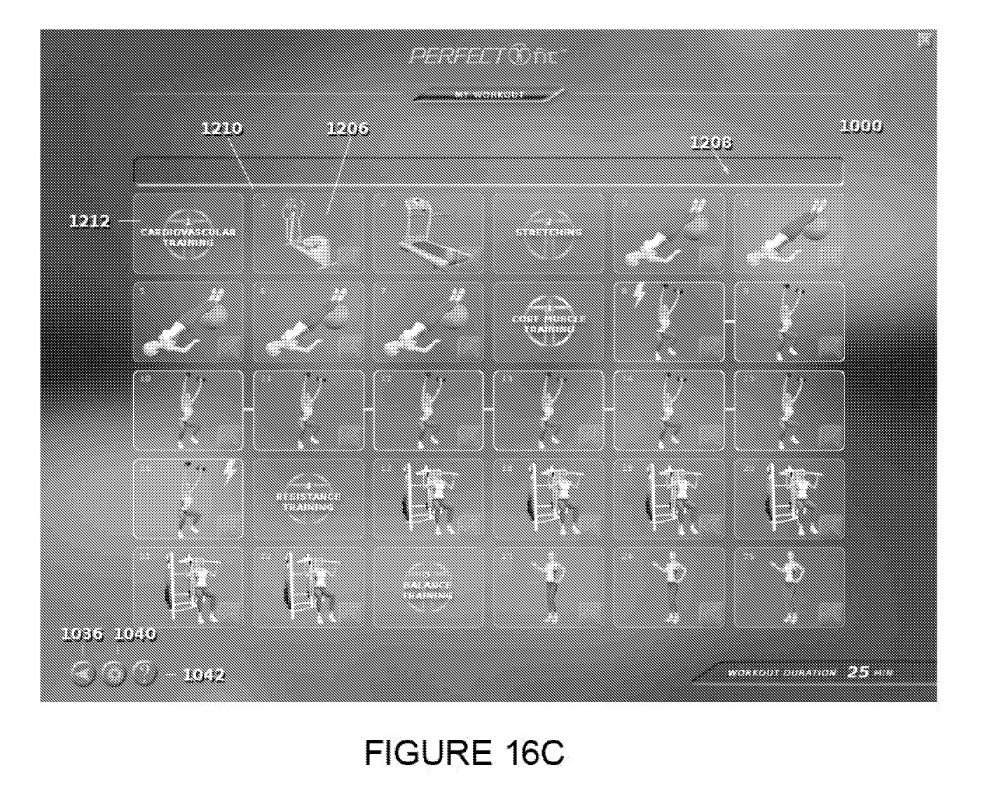

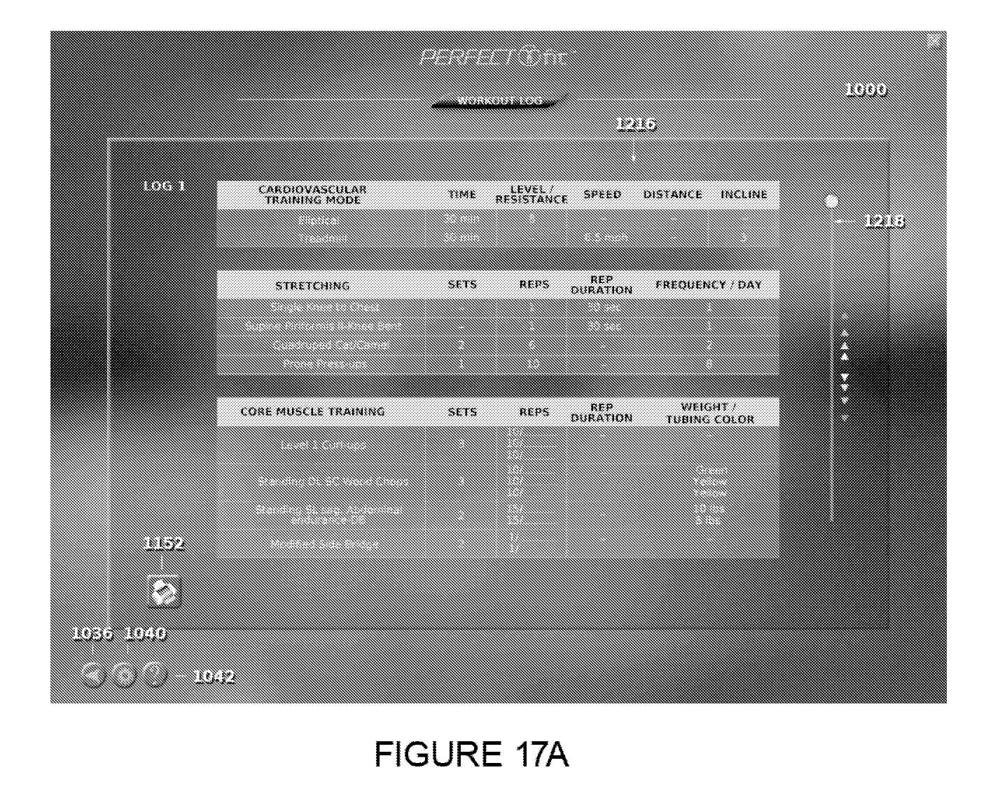

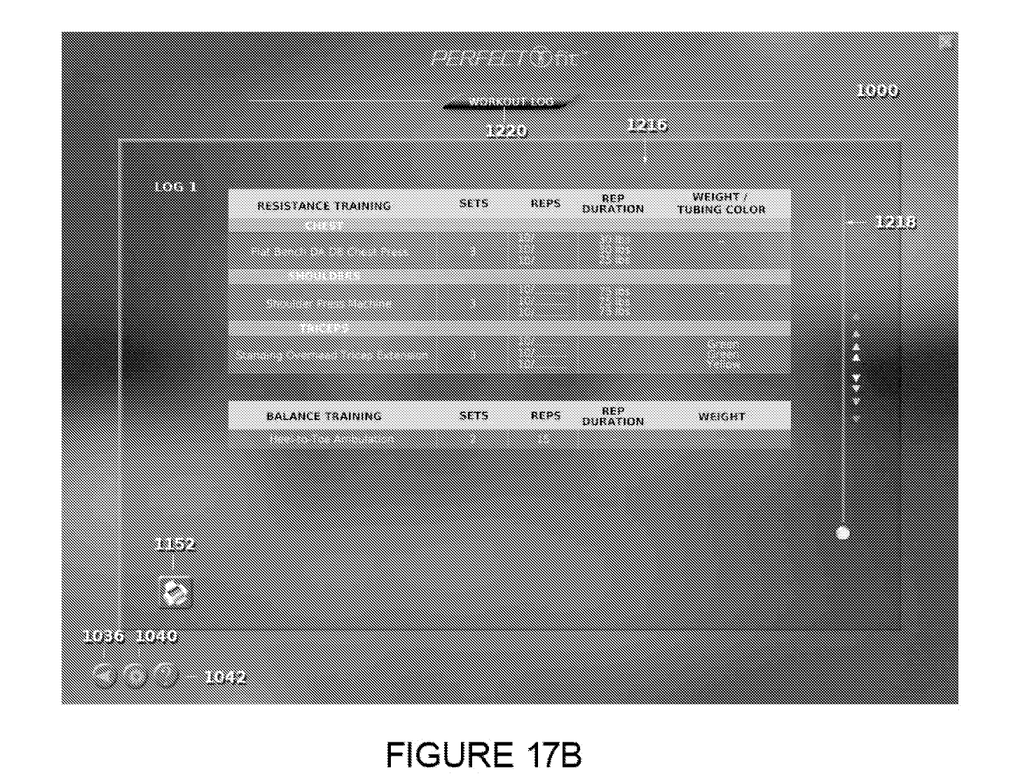

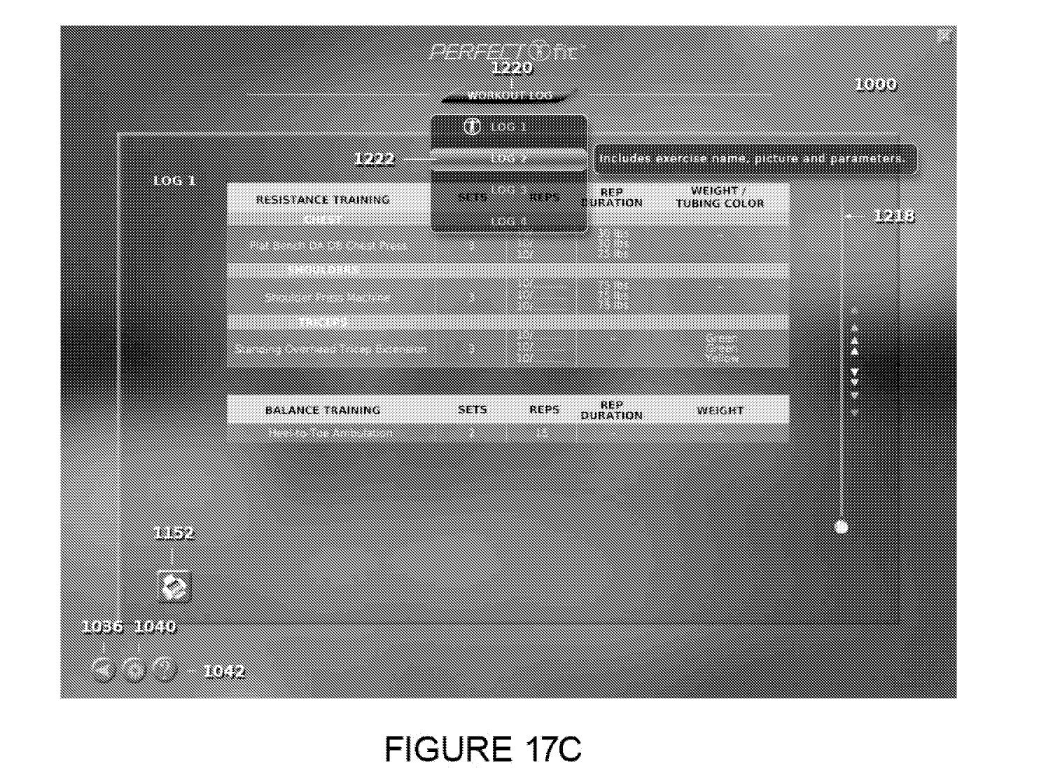

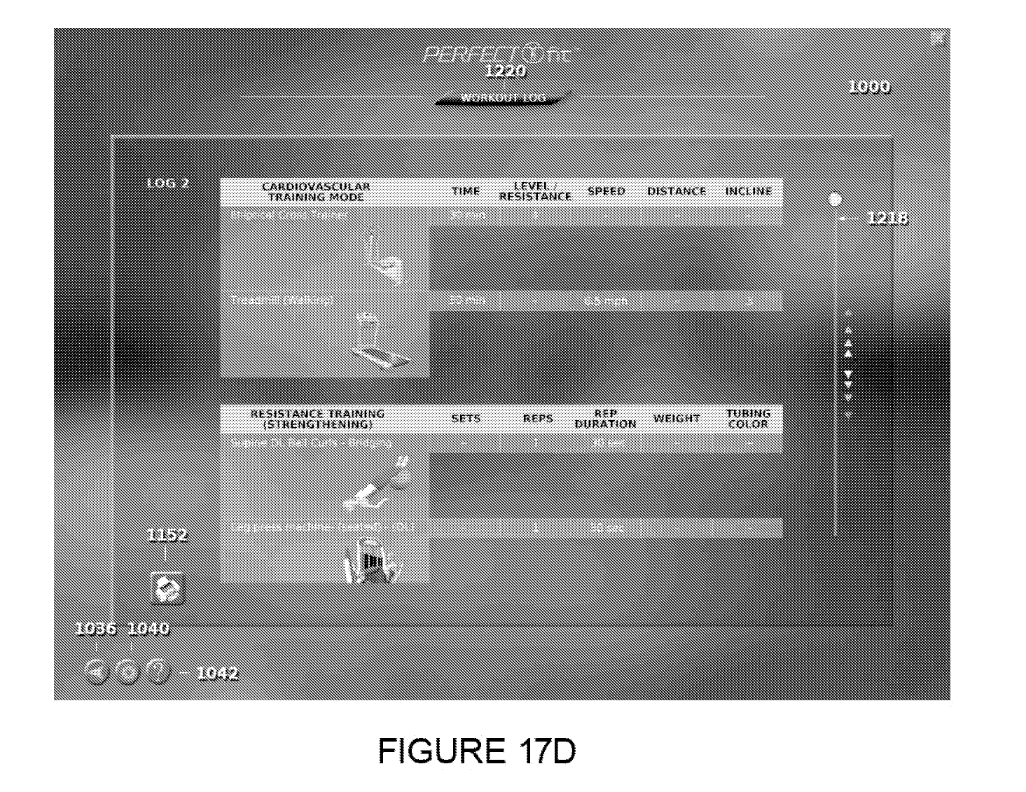

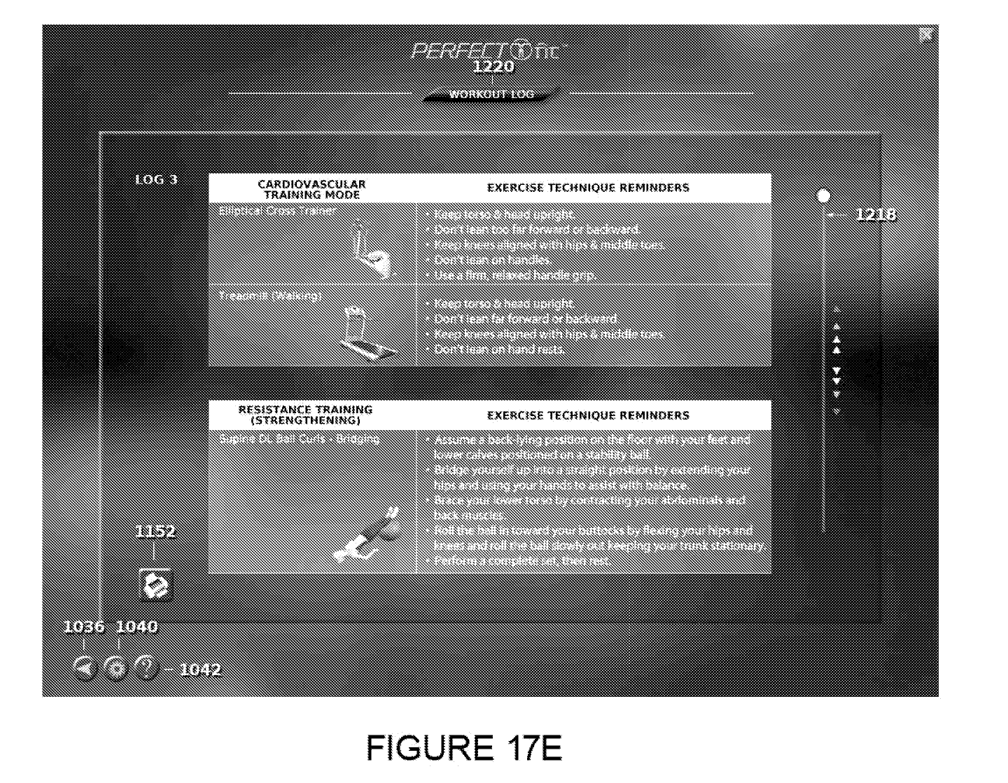

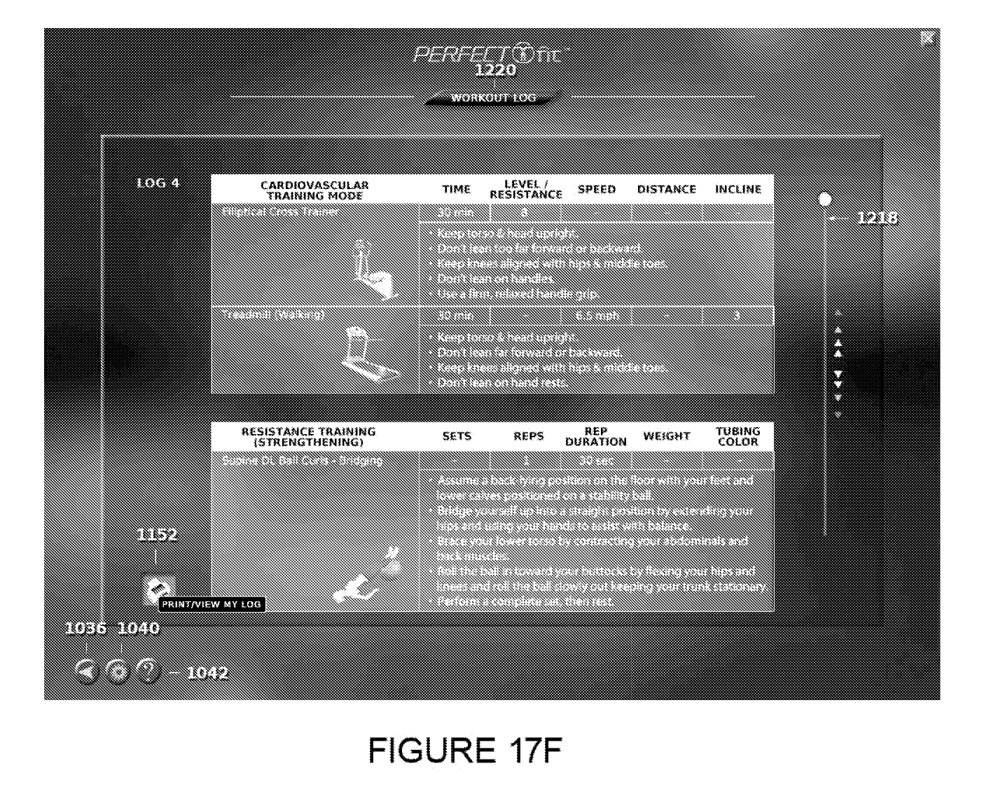

At any point while the user is selecting the desired exercise routines or reviewing a workout, the user may select a workout icon button 1147 on the display screen 1000, which will cause the exercise program 78 to display several workout icon buttons 1148 adjacent to the workout section 1132, as further shown, for example, in FIG. 11J. A view workout full-screen icon button 1150, for example, can be utilized to view the exercise routine in a full-screen mode, as further described below with respect to FIGS. 16A-16C. A print icon button 1152 can be provided to permit the user to view and/or print a copy of a workout log, as further described below with respect to FIGS. 17A-17F. A save icon button 1154 can be provided to permit the user to save the current workout. A clear icon button 1156 can be utilized to clear the exercise routines from the workout section 1132. An open icon button 1158 can be provided to open a previously saved workout for viewing, editing, and/or implementing. Other icon buttons can be provided for performing other functions, if desired. In some embodiments, for example, an export icon button 1160 can be provided to permit the user to export the current workout to an MPEG, MOV, WAV, or other file format for storing the workout on a DVD, CD-ROM, video cellular telephone, or other such device or desired media capable of displaying video playback.

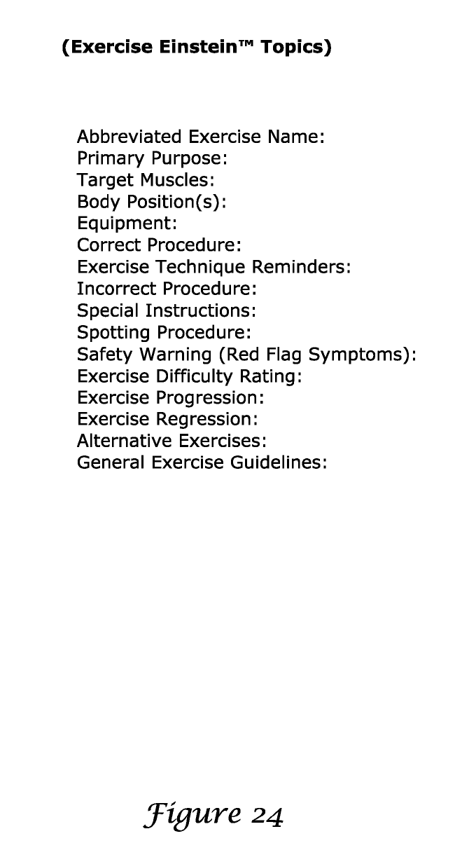

FIGS. 12A-12B are screen shots showing the selection of the information icon button 1120 using the set of remote control icon buttons 1102 located adjacent to the preview window 1098. When initiated, and as shown in a first screen shot in FIG. 12A, the exercise program 78 can be configured to display a list 1162 of exercise topics that can be accessed to learn more information about the specific exercise routine displayed within the preview window 1098. An illustrative list showing several exercise topics that can be viewed in this manner is shown in FIG. 24.

FIG. 12B is a screen shot showing the selection of one of the exercise topics from the list 1162 of exercises depicted in FIG. 12A. As shown in FIG. 12B, selection of an exercise topic from the list 1162 causes the exercise program 78 to display a text box 1164 on the display screen 1000 containing more information about the exercise, its purpose, as well as general guidelines that can be followed during the exercise. From this screen, the user may then print the information contained in the text box 1164, view other exercise topics, or exit the interface.

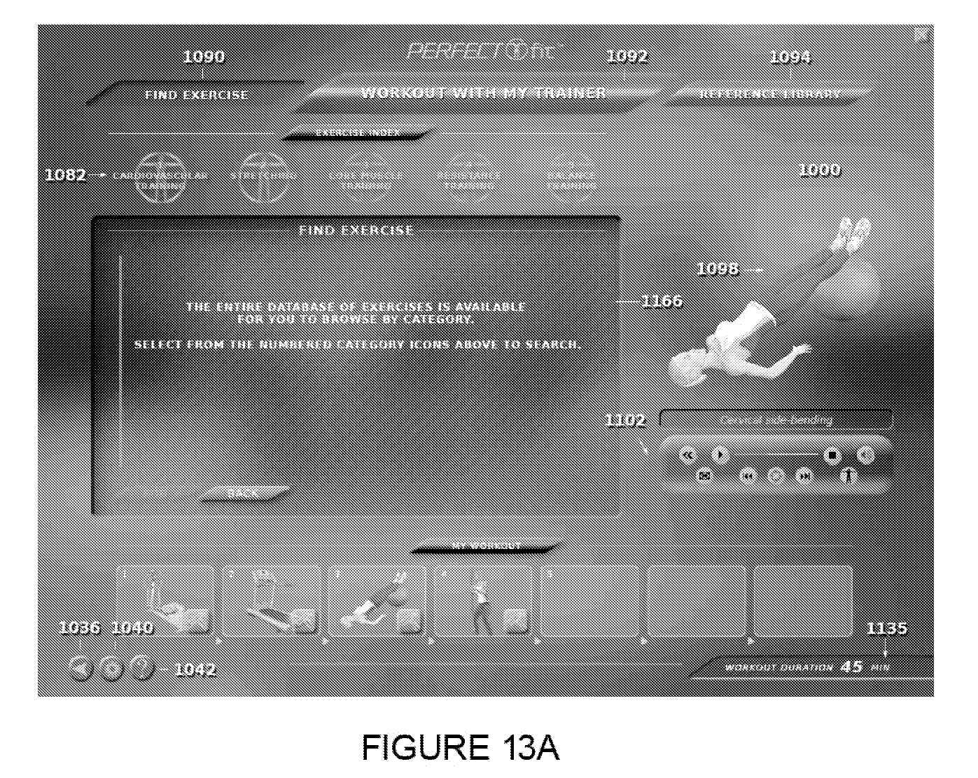

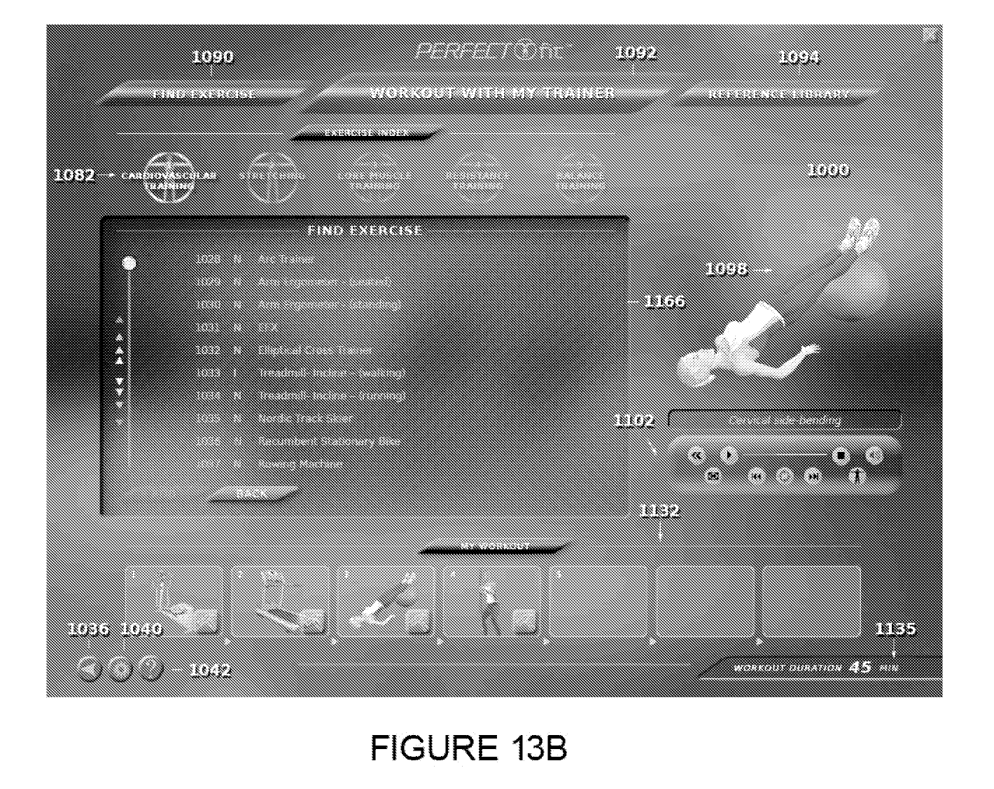

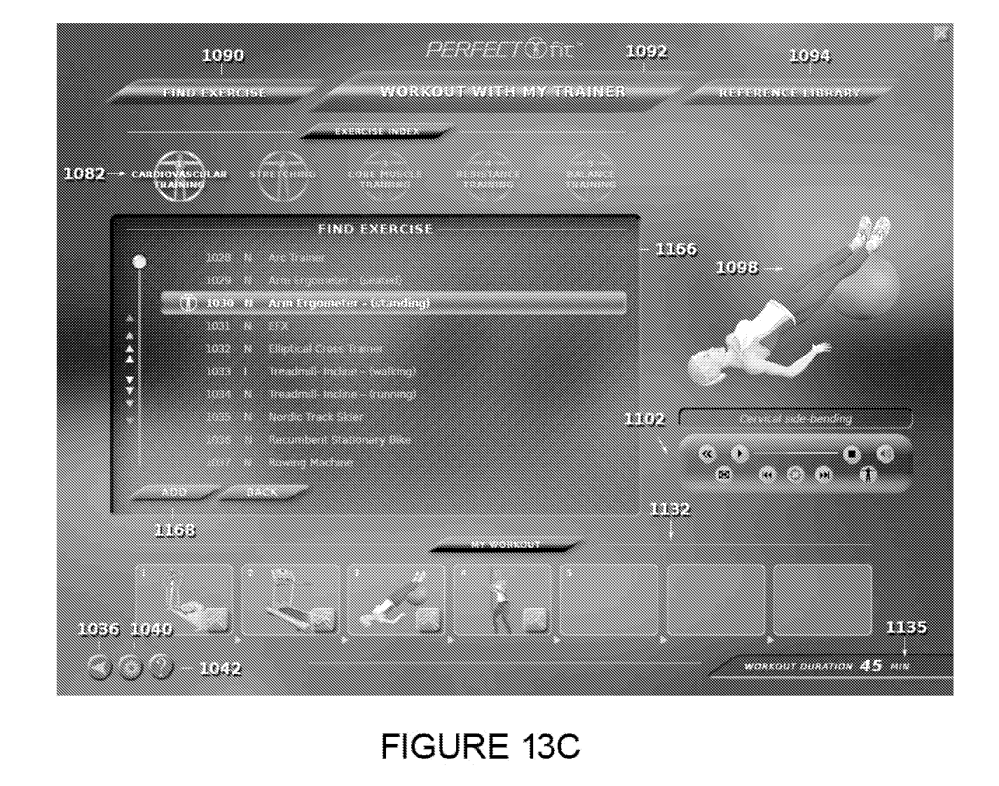

FIGS. 13A-13C are screen shots showing several illustrative steps of finding exercises within the exercise object database 80 by exercise category. To search exercises routines by exercise category, the user may select the find exercise icon button 1090 on the display screen 1000, which as shown in a first screen shot in FIG. 13A, causes the exercise program 78 to prompt the user to browse the exercise object database 80 by exercise category. The user may then select each individual exercise category from the exercise category icons 1082 on the display screen 1000 to search for exercises within each category. As shown in a subsequent screen shot in FIG. 13B, for example, if the user desires to search for exercises within the “Cardiovascular Training” exercise category, the user may select the “Cardiovascular Training” icon button 1082 on the display screen 1000, causing the exercise program 78 to display a pop-up window 1166 containing a list of possible exercises within that exercise category. The user may then select a desired exercise routine from the list of exercise routines within the exercise category, as further shown in FIG. 13C. If desired, the user may then add the selected exercise routine to the workout by selecting an add icon button 1168 on the display screen 1000, causing the exercise program 78 to add the exercise routine to the workout. Selection of exercise routines within the other exercise categories can then be accomplished in a similar manner until the user has created the entire workout.

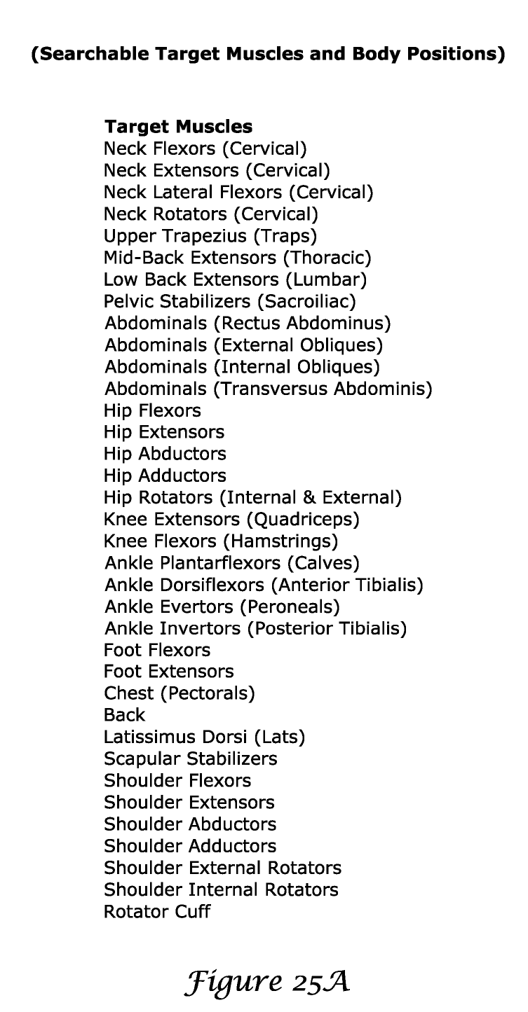

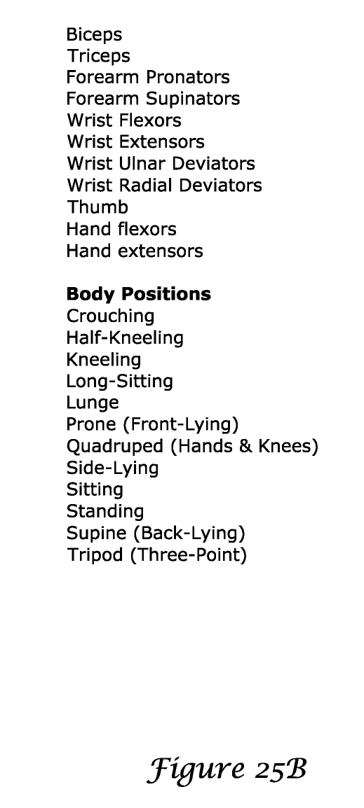

Although FIGS. 13A-13C depict the searching of exercise routines based on exercise category, it should be understood that searching can be accomplished in other ways such as by searching by exercise name, by exercise difficulty level, by target muscle, by body position, by equipment type, and/or by a unique asset number associated with each exercise routine. An illustrative list of target muscles and body positions that can be used to search for exercises is shown in FIGS. 25A-25B.

FIGS. 14A-14B are screen shots showing several illustrative steps of viewing an exercise routine in a full-screen mode. As shown in a first screen shot in FIG. 14A, selection of the view full screen icon button 1114 on the display screen 1000 (see FIG. 11B) causes the exercise program 78 to display a full-screen view of the 3-D graphical representation or model 1100 showing the exercise routine being performed in real time. An enhanced set of control icon buttons 1170 can be provided on the display screen 1000 for manipulating the 3-D graphical representation or model 1100. In addition to the set of remote controls 1102 provided adjacent to the preview window 1098, the enhance set of controls 1170 may further include a set of zoom-in/zoom-out icon buttons 1172 for increasing or decreasing the size of the 3-D graphical representation or model 1100 on the display screen 1000, and a circle wheel 1174 including a set of 3-D arrow buttons 1176 that can be used to rotate, spin and revolve the 3-D graphical representation or model 1100 in space. If desired, a center icon button 1178 on the circle wheel 1174 can be utilized to reset the viewing angle of the 3-D graphical representation or model 1100 to a default view once the user has altered the viewing angle using the set of 3-D arrow buttons 1176.

An options icon button 1180 can be further provided on the display screen 1000 to permit the user to perform other tasks, including the display of exercise technique reminders showing the proper manner in which to perform the exercise routine. As shown in FIG. 14B, for example, selection of the “Display Technique Reminders” text from the options icon button 1180 can cause the exercise program 78 to display a list of exercise technique reminders 1182 on the display screen 1000, which can then be viewed by the user to learn proper technique with respect to that particular exercise.

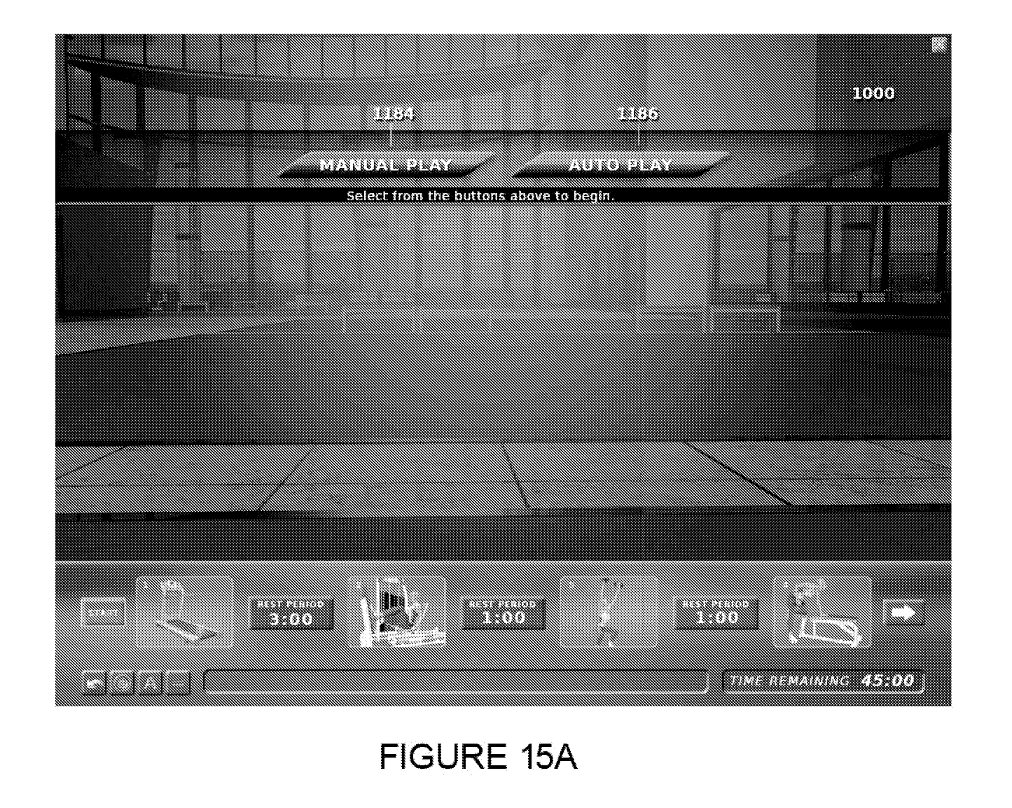

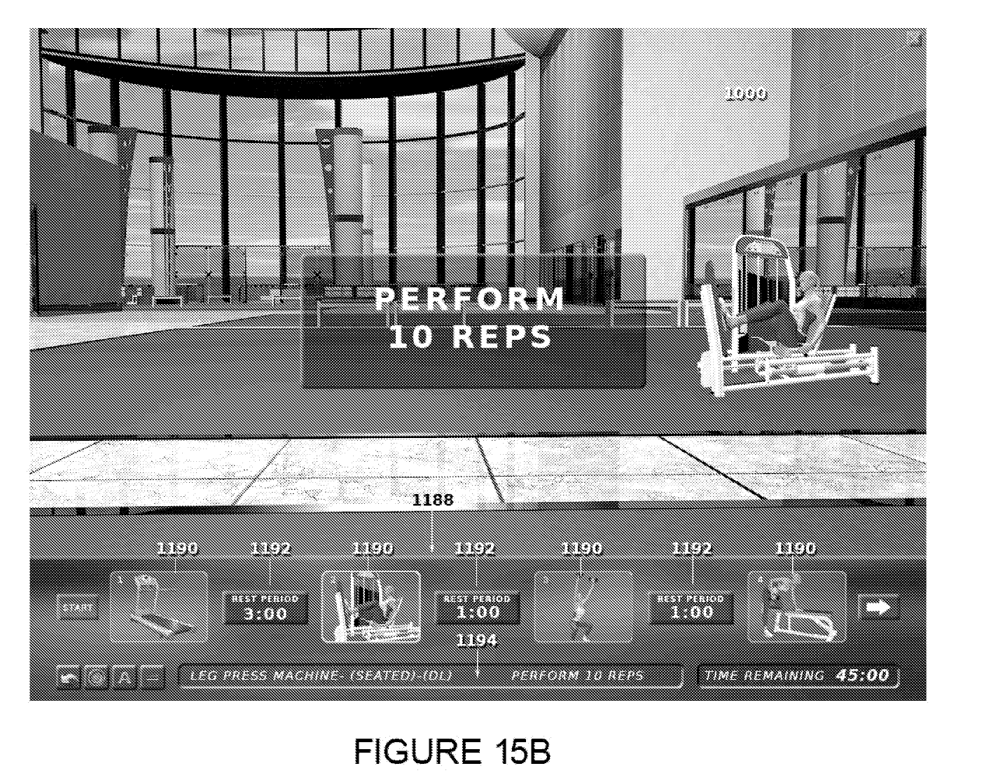

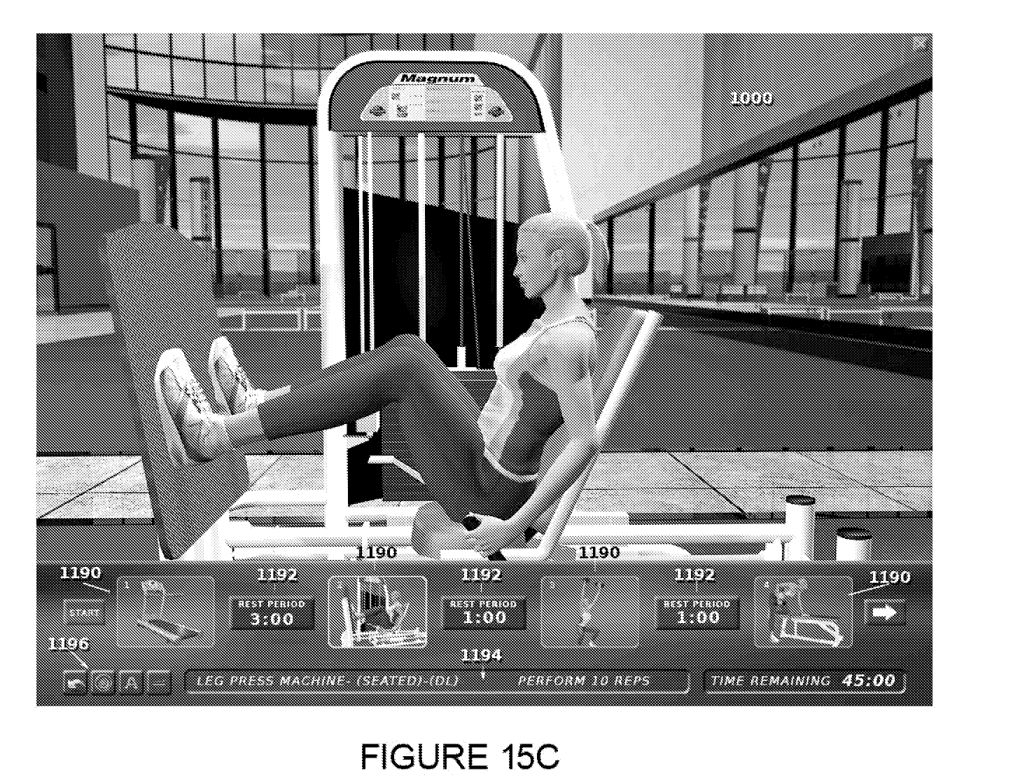

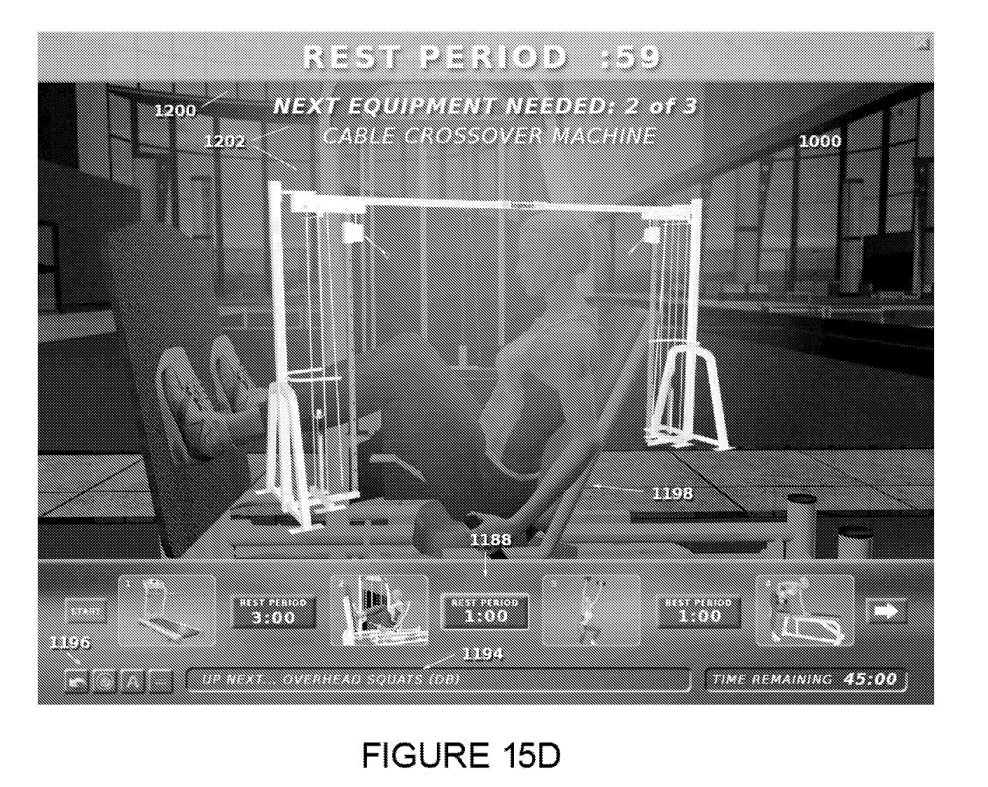

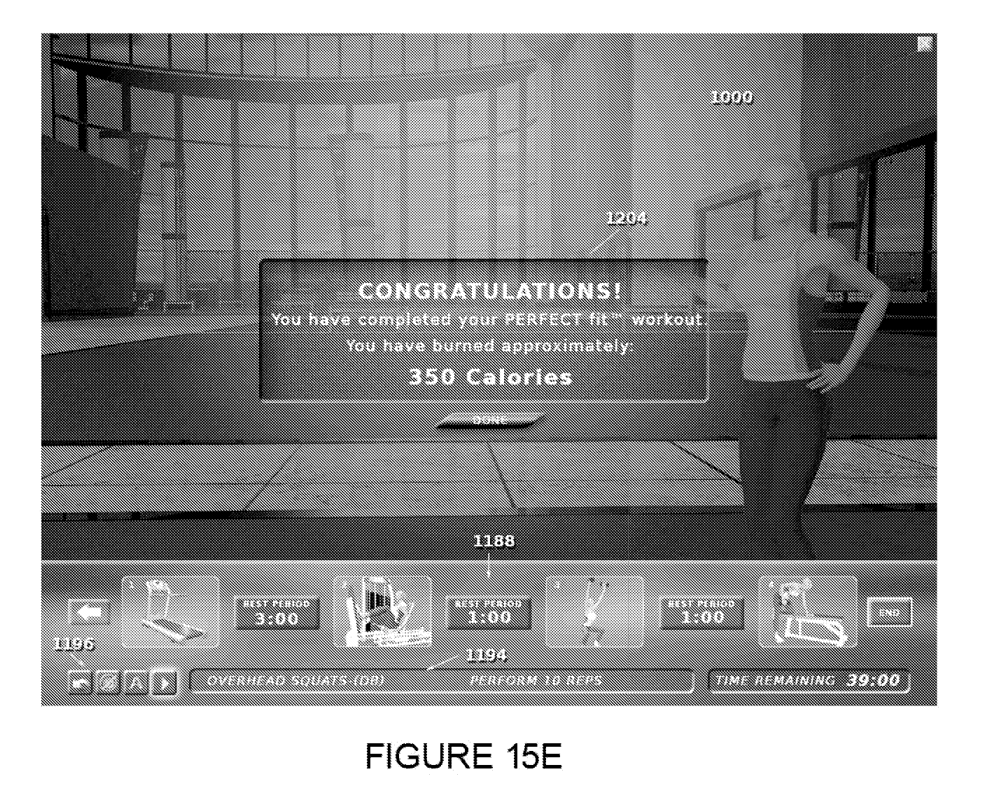

FIGS. 15A-15E are screen shots showing several illustrative steps of performing an on-screen workout using the exercise program 78. As shown in a first screen shot in FIG. 15A, when the user initiates the workout (e.g., by selecting the workout with trainer icon button 1092 in FIG. 11A), the exercise program 78 may prompt the user to select either a manual play icon button 1184 or an auto play icon button 1186, which can be used to select whether advancement through each individual exercise routine within the workout is accomplished manually by the user or automatically by the exercise program 78.

Once the user selects the desired mode of advancement, the exercise program 78 can be configured to display a workout screen guiding the user through each individual exercise routine within the workout. When a workout is initiated, and as shown, for example, in FIGS. 15B-15C, the exercise program 78 can be configured to display a workout bar 1188 on the display screen 1000 indicating the current exercise routine to be performed. The workout bar 1188 may include, for example, a graphical representation or thumbnail 1190 of each individual exercise routine within the workout along with rest status indicators 1192 indicating the rest periods between each individual exercise routine. A workout information bar 1194 can also be provided to display information about the current exercise routine being performed. For example, the workout information bar 1194 can include the name of the current exercise routine, the number of reps to be performed, the time remaining in the exercise routine, and/or the exercise difficulty level of the exercise routine. Other information such as the number of calories burned can also be displayed. A set of control icon buttons 1196 located adjacent to the workout information bar 1194 can be used to perform various functions, including moving back to the previous screen, toggling the auto advancement mode on or off, adjusting the sound settings, and pausing the current workout.

During the workout, a 3-D virtual trainer 1198 can be provided on the display screen 1000 to demonstrate the exercise routines to be performed within the workout. As the user completes each exercise routine within the workout, the exercise program 78 can be configured to display a rest period indicator 1200, as shown, for example, in FIG. 15D, prompting the user to rest in between exercises. During this rest period, the exercise program 78 may display an equipment list 1202 indicating the particular exercise equipment that will be needed for future exercise routines within the workout. Once the rest period has expired, the user is then prompted whether to continue with the exercise routine if set to the manual advancement mode; otherwise the exercise program 78 can be configured to automatically advance to the next exercise routine within the workout. Once the user has finished the entire workout, the exercise program 78 can be configured to display a message 1204 indicating that the routine is complete, as shown, for example, in FIG. 15E.

FIGS. 16A-16C are screen shots showing several illustrative steps of viewing a workout by selecting the view workout icon button 1150 described above with respect to FIG. 11J. When initiated, and as shown in a first screen shot in FIG. 16A, the exercise program 78 can be configured to display a screen showing each individual exercise routine in sequential order within the workout. Each individual exercise routine can be displayed, for example, as exercise thumbnails 1206 within a workout bin 1208 provided on the display screen 1000 graphically showing the exercise routines along with a routine number 1210. An exercise category thumbnail 1212 located prior to each exercise sequence can be used to indicate where a new exercise category begins.

From the workout bin 1208 depicted in FIG. 16A, the user may make changes to the workout by selecting one or more of the exercise thumbnails 1206 on the display screen 1000. If, for example, the user desires to adjust the order in which the exercise routines are performed, the user may select one or more of the exercise thumbnails 1206, or alternatively an entire exercise category, and then move the exercise thumbnails 1206 to the desired location within the workout bin 1208. If the user desires to modify a particular exercise routine within the workout, the user may left-click the appropriate exercise thumbnail 1206 on the display screen 1000, causing the exercise program 78 to display a pop-up window 1214 that can be used for viewing any alternative exercises related to the selected thumbnail 1206. The pop-up window 1214 can also be used to delete the selected exercise routine or modify one or more of the parameters associated with the exercise routine, as desired.

In certain embodiments, one or more of the exercise routines within the workout can be performed as an exercise circuit, allowing the user to repeatedly perform one set of each exercise within the selected exercise circuit in a continuous and sequential manner until all sets are completed. As shown in FIG. 16C, for example, the user may select one or more exercise thumbnails 1206 to be associated with the exercise circuit, causing the exercise program 78 to cycle through one set of each selected exercise routine in a continuous and sequential manner until all sets of each exercise routine have been performed.

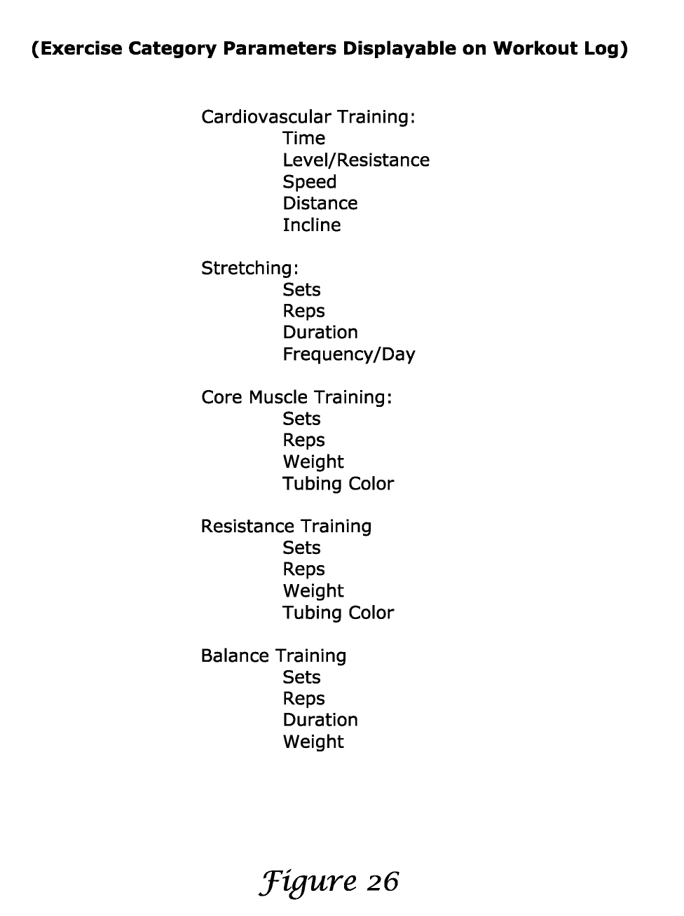

FIGS. 17A-17F are screen shots showing several illustrative steps of viewing a workout log by selecting the view/print workout icon button 1152 described above with respect to FIG. 11J. When initiated, and as shown in a first screen shot in FIG. 17A, the exercise program 78 can be configured to display a default workout log 1216 showing each exercise routine name by exercise category along with the exercise parameters associated with the exercise routine. A scroll bar 1218 on the display screen 1000 can be used to scroll up or down to view all of the exercise routines within the workout log 1216. As shown in another screen shot in FIG. 17B, for example, selection of the down scroll arrow on the scroll bar 1218 can cause the exercise program 78 to display additional exercise routines. An illustrative list of exercise category parameters that can be displayed on a workout log is shown in FIG. 26.

The exercise program 78 can be configured to display the workout log 1216 in a different format from that shown in FIGS. 17A-17B by selecting a workout log icon button 1220 on the display screen 1000. As further shown in FIG. 17C, for example, selection of the workout log icon button 1220 may introduce a pop-up window 1222 on the display screen 1000, allowing the user to toggle between several different log screen formats from the default workout log (i.e., “Log 1”). For example, selection of “Log 2” from the pop-up window 1222 can cause the exercise program 78 to display the exercise routine name, a picture of the exercise routine, and the exercise parameters associated with the exercise routine, as shown, for example, in FIG. 17D. Selection of the text “Log 3” from the pop-up window 1222, in turn, can cause the exercise program 78 to display the exercise routine name, a picture of the exercise routine, and any technique reminders associated with the exercise routine, as shown, for example, in FIG. 17E. Selection of the text “Log 4” from the pop-up window 1222, in turn, can cause the exercise program 78 to display the exercise routine name, a picture of the exercise routine, the exercise parameters for the exercise routine, and any technique reminders associated with the exercise routine, as shown, for example, in FIG. 17F. Other workout log formats are also contemplated.

FIGS. 18A-18D are screen shots showing an illustrative interface for use by a healthcare or fitness professional for creating an exercise prescription that can be used by a client. When initiated, and as shown in a first screen shot in FIG. 18A, the exercise program 78 can be configured to display a number of icon buttons on the display screen 1000, including a find exercise icon button 1090 that can be used for searching exercises within the exercise object database, an E-mail protocol icon button 1224 that can be used to send an E-mail message to a client containing one or more prescribed exercise routines as well as other information, and a target muscles icon button 1226 that can be used to search for exercises based on target muscle. A pop-up window 1228 provided on the display screen 1000 may display those exercise protocols previously saved by the healthcare or fitness professional. An exercise protocol section 1230 on the display screen 1000 may display those exercise protocols that are a part of the current exercise prescription selected.

FIG. 18B is a screen shot showing the selection of the target muscles icon button 1226 on the display screen 1000 depicted in FIG. 18A. As shown in FIG. 18B, selection of the target muscles icon button 1226 can cause the exercise program 78 to display several additional icon buttons 1232,1234 that can be used to build exercise protocols based on target muscle group. A stretch icon button 1232, for example, can be selected for creating an exercise protocol for a client or clients based on several stretching categories. A strengthen icon button 1234, in turn, can be selected for creating an exercise protocol for a client or clients based on several strengthening categories. A pop-up window 1236 may be provided on the display screen 1000 prompting the user to select target muscles using either or both of the icon buttons 1232,1234.

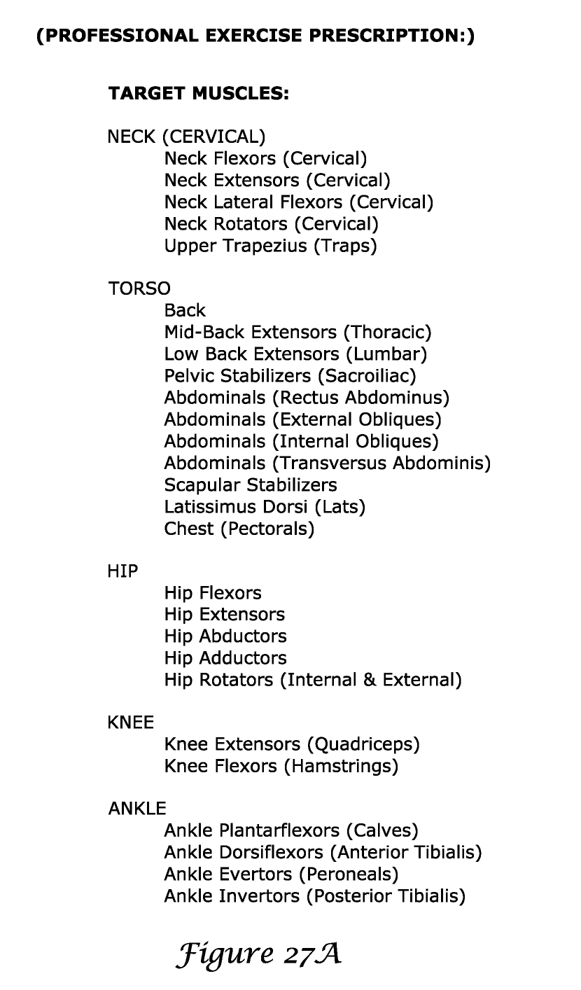

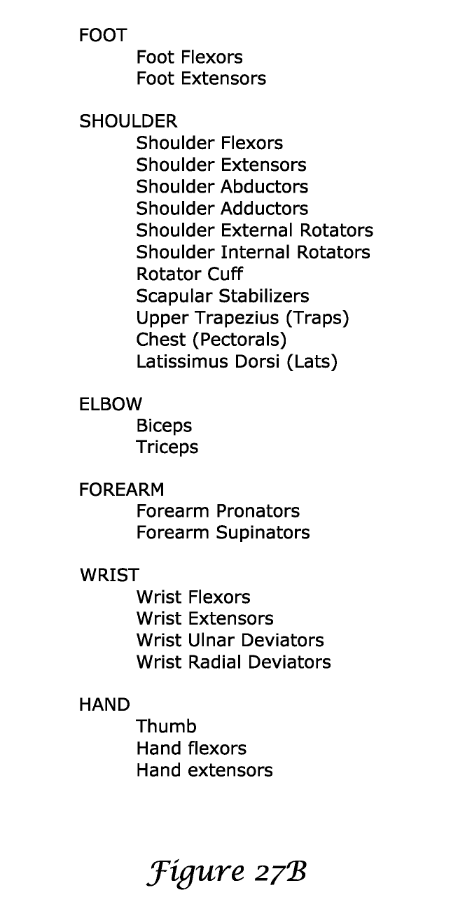

FIG. 18C is a screen shot showing the selection of the stretch icon button 1232 on the display screen 1000 depicted in FIG. 18B. As shown in FIG. 18C, selection of icon button 1232 can cause the exercise program 78 to display a list of target muscle categories or body regions 1238 that can be used to build exercise protocols for the client. From the list of target muscle categories or body regions 1238, the user may select one or more target muscle groups, causing the exercise program 78 to further display a list of sub-topics that can then be selected, as further shown, for example, in FIG. 18D. An illustrative list of target muscles that can be selected for creating an exercise prescription is shown in FIGS. 27A-27B.

Once the user has finished finding exercises through the independent search tools (e.g., find exercise 1090 or target muscles 1226), the user may then select an add icon button 1240 on the display screen 1000, causing the exercise program 78 to add the selected exercise to the exercise protocol along with a tile icon within the exercise protocol section 1230 showing the protocol. The healthcare or fitness professional may then send the created exercise routine to one or more clients by selecting the E-mail icon button 1224 on the display screen 1000.

Having thus described the several embodiments of the present invention, those of skill in the art will readily appreciate that other embodiments may be made and used which fall within the scope of the claims attached hereto. It will be understood that this disclosure is, in many respects, only illustrative. Changes can be made with respect to various elements described herein without exceeding the scope of the invention.

What is claimed is:

1. A method for promoting health and wellness of individuals within a population, the method comprising the steps of:
targeting one or more individuals within the population based at least in part on a risk assessment factor associated with each individual;
formulating a behavior modification program for each targeted individual based at least in part on said risk assessment factor;
providing one or more targeted individuals with a computer exercise program for achieving one or more health related objectives related to the behavior modification program, the exercise program including a number of customizable exercise routines; and
monitoring the progress of one or more participating individuals in achieving said one or more health related objectives.

2. The method of claim 1, wherein said step of targeting one or more individuals within the population based at least in part on a risk assessment factor associated with each individual includes the step of performing a claims data analysis on the population.

3. The method of claim 1, wherein said step of targeting one or more individuals within the population based at least in part on a risk assessment factor associated with each individual includes the step of segmenting individuals within the population into one or more groups based on health status.

4. The method of claim 3, wherein said step of segmenting individuals within the population based on health status is accomplished by categorizing individuals within a well category, an at-risk category, and a chronic category.

5. The method of claim 4, wherein the categorization of individuals within each health category is accomplished by self-assessment questionnaires.

6. The method of claim 4, wherein the categorization of individuals into each health category is accomplished by clinical evaluations provided by a healthcare professional.

7. The method of claim 1, wherein said step of targeting one or more individuals within the population based at least in part on a risk assessment factor associated with each individual includes the step of segmenting individuals within the population into one or more groups based on activity level.

8. The method of claim 7, wherein said step of segmenting individuals within the population based on activity level includes categorizing individuals within an exercise enthusiast category, an active lifestyle category, an occasional activity category, a sedentary activity category, and a rehabilitation category.

9. The method of claim 8, wherein the categorization of individuals within each activity category is accomplished by self-assessment questionnaires.

10. The method of claim 8, wherein the categorization of individuals into each activity category is accomplished by clinical evaluations provided by a healthcare professional.

11. The method of claim 1, wherein said step of targeting one or more individuals within the population based at least in part on a risk assessment factor associated with each individual includes the step of segmenting individuals within the population into one or more groups based on a cost benefit analysis.

12. The method of claim 1, wherein said one or more health related objectives includes weight loss management.

13. The method of claim 1, wherein said one or more health related objectives includes exercise promotion.

14. The method of claim 1, further including the step of providing at least one incentive to each participating individual upon the enrollment and/or participation within the behavior modification program.

15. The method of claim 14, wherein said step of proving at least one incentive to each participating individual includes the step of providing a discount for the cost of the exercise program.

16. The method of claim 1, further comprising the step of adjusting one or more exercise parameters of said exercise routines based at least in part on the one or more health related objects of the behavior modification program.

17. The method of claim 1, wherein said step of monitoring the progress of each participating individual in achieving said one or more health related objectives is accomplished by a communications module of the exercise program.

18. The method of claim 17, wherein the exercise program further includes a compliance module adapted to monitor the individual's usage of the exercise program.

19. The method of claim 1, wherein the exercise program is a computer software program.

20. The method of claim 1, wherein the exercise program is a web-based computer program.

21. A system for managing the health and wellness of plan members within a health plan, the system comprising:
a plan sponsor adapted to administer a health plan to a number of plan members;
a behavior modification program targeted to one or more plan members within the health plan, the behavior modification program including a customizable computer exercise program for promoting one or more health related objectives of the behavior modification program; and
a plan administrator adapted to monitor the progress of each plan member participating in the behavior modification program.

22. The system of claim 21, wherein the plan sponsor is an insurance company or self-insured business.

23. The system of claim 21, wherein the plan sponsor is a governmental agency.

24. The system of claim 21, wherein the computer exercise program includes a compliance module adapted to monitor the plan member's usage of the exercise program.

25. The system of claim 21, wherein the computer exercise program includes a communications module adapted to transmit data back and forth between each participating plan member and the plan administrator.

26. The system of claim 21, wherein the exercise program is a computer software program.

27. The system of claim 21, wherein the exercise program is a web-based computer program.

28. A computer-based exercise program for use in performing a workout in a virtual environment, the exercise program comprising:
a graphical user interface displayable on a display screen;
an exercise object database including a number of customizable exercise routines each having a number of adjustable exercise parameters;
an engine adapted to display a 3-D exercise animation of one or more of said exercise routines on the display screen;
a compliance module for monitoring usage of the exercise program; and
a communications module for remotely transmitting data back and forth between the exercise program and an administrator.

29. The exercise program of claim 28, wherein said data includes monitoring data collected by said compliance module.

30. The exercise program of claim 28, wherein said data includes one or more exercise routines received from said administrator

31. The exercise program of claim 28, wherein the 3-D exercise animations displayed by the engine are adapted to demonstrate the full range of motion of the exercise routine on the display screen.

32. The exercise program of claim 28, further comprising an export module for exporting a workout for playback on another device.

33. The exercise program of claim 28, wherein the exercise program further includes a searching routine for searching exercise routines within the exercise object database.

34. The exercise program of claim 33, wherein said searching routine includes a means for searching exercise routines based on exercise category.

35. The exercise program of claim 33, wherein said searching routine includes a means for searching exercise routines based on exercise name.

36. The exercise program of claim 33, wherein said searching routine includes a means for searching exercise routines based on an asset number associated with each exercise routine.

37. The exercise program of claim 33, wherein said searching routine includes a means for searching exercise routines based on target muscles and/or body sections.

38. The exercise program of claim 28, wherein the computer-based exercise program is a computer software program.

39. The exercise program of claim 28, wherein the computer-based exercise program is a web-based computer program.

40. The exercise program of claim 28, wherein the exercise program includes a means for outputting a portable workout log.

41. The exercise program of claim 28, further comprising a means for rendering the 3-D exercise animation in a full-screen mode on the display screen.

42. The exercise program of claim 28, further comprising a means for manipulating the 3-D exercise animation on the display screen.
